(19) United States
(12) Patent Application Publication
(10) Pub. No.: US 2025/0296803 A1
(43) Pub. Date: Sep. 25, 2025

(54) MEDIUM PROCESSING APPARATUS AND IMAGE FORMING SYSTEM

(71) Applicants: Sachika TAMAKI, Kanagawa (JP); Kei SASAKI, Kanagawa (JP); Keisuke SUGIYAMA, Kanagawa (JP); Kazuki SETO, Kanagawa (JP); Shohei SAITO, Kanagawa (JP); Kohta ABE, Kanagawa (JP); Takashi YAMAMOTO, Kanagawa (JP); Mitsuhiro SUGAWARA, Kanagawa (JP); Nobuyoshi SUZUKI, Kanagawa (JP)

(72) Inventors: Sachika TAMAKI, Kanagawa (JP); Kei SASAKI, Kanagawa (JP); Keisuke SUGIYAMA, Kanagawa (JP); Kazuki SETO, Kanagawa (JP); Shohei SAITO, Kanagawa (JP); Kohta ABE, Kanagawa (JP); Takashi YAMAMOTO, Kanagawa (JP); Mitsuhiro SUGAWARA, Kanagawa (JP); Nobuyoshi SUZUKI, Kanagawa (JP)

(73) Assignee: Ricoh Company, Ltd., Tokyo (JP)

(21) Appl. No.: 19/083,519

(22) Filed: Mar. 19, 2025

(30) Foreign Application Priority Data
Mar. 21, 2024 (JP) 2024-045535
Oct. 25, 2024 (JP) 2024-188628

(51) Int. Cl. B65H 37/04; B41J 3/44; G03G 15/00

(52) U.S. Cl. CPC B65H 37/04; B41J 3/44; B65H 2301/5161; B65H 2301/5162; B65H 2515/20; B65H 2801/27; G03G 15/6544

(57) ABSTRACT

A medium processing apparatus includes a liquid applier to apply liquid to a part of a medium to perform liquid application, a first liquid storage to store the liquid used for the liquid application of the liquid applier, a second liquid storage to store the liquid to be supplied to the first liquid storage, and a liquid supplier to perform a liquid supply operation to supply the liquid from the second liquid storage to the first liquid storage. The second liquid storage includes a liquid storage tray connected to the liquid supplier, a liquid storage tank to store the liquid and is attachable to and detachable from the liquid storage tray, and a locking mechanism to restrict a position of the liquid storage tank attached to the liquid storage tray.

### CROSS-REFERENCE TO RELATED APPLICATION

This patent application is based on and claims priority pursuant to 35 U.S.C. § 119 (a) to Japanese Patent Application Nos. 2024-045535, filed on Mar. 21, 2024, and 2024-188628, filed on Oct. 25, 2024, in the Japan Patent Office, the entire disclosure of each of which is hereby incorporated by reference herein.

### BACKGROUND

### Technical Field

The present disclosure relates to a medium processing apparatus and an image forming system.

### Related Art

Various types of medium processing apparatuses have been proposed that bind a sheet bundle of stacked sheet media. Examples of binding processes performed by such medium processing apparatuses include a “stapling process” to penetrate a staple (a binding member) through a bundle of sheets to bind the bundle of sheets and a “crimp binding process” to press and deform a part of a bundle of sheets to bind the bundle of sheets. Further, a water-added crimp binding process has been proposed in which liquid is applied to sheets of paper as sheet-shaped media when the crimp binding process is performed, and a water-added crimp binding apparatus that can perform such a process has also been proposed.

For example, a water-added crimp binding apparatus includes a water supply tank that replenishes liquid to a water storage tank having a liquid application mechanism when the remaining amount of liquid in the water storage tank is reduced, and the water supply tank is attachable to and detachable from the apparatus.

For the purpose of providing a small humidifier in which a water supply tank for supplying water can be easily attached and detached even in a narrow place, for example, a configuration has been proposed in which a flat surface of a water supply container is abutted against a flat surface of the housing of a main body and is detachably held on a lateral side of the housing of the main body by first and second engagement portions.

### SUMMARY

In order to solve the problem described above, the present disclosure described herein provides a medium processing apparatus that includes a liquid applier to apply liquid to a part of a medium to perform liquid application, a first liquid storage to store the liquid used for the liquid application of the liquid applier, a second liquid storage to store the liquid to be supplied to the first liquid storage, and a liquid supplier to perform a liquid supply operation to supply the liquid from the second liquid storage to the first liquid storage. The second liquid storage includes a liquid storage tray connected to the liquid supplier, a liquid storage tank to store the liquid and is attachable to and detachable from the liquid storage tray, and a locking mechanism to restrict a position of the liquid storage tank attached to the liquid storage tray.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming system;

FIG. 2 is a diagram illustrating an internal structure of a post-processing apparatus according to a first embodiment;

FIG. 3 is a schematic view of an edge binder viewed from an upstream side in a conveyance direction;

FIG. 4 is a schematic view of an edge binder viewed from a liquid applier in a main scanning direction;

FIGS. 5A and 5B are schematic diagrams illustrating a configuration of a crimper of an edge binder;

FIG. 6 is a diagram illustrating an edge binder according to a modification;

FIGS. 7A, 7B, and 7C are diagrams illustrating a liquid application crimper of an edge binder according to a modification;

FIGS. 8A, 8B, and 8C are diagrams illustrating a liquid applying operation and a crimp binding operation performed by the liquid application crimper of FIGS. 7A, 7B, and 7C:

FIG. 9 is a schematic view of a staple binder viewed from an upstream side in a conveyance direction;

FIG. 10 is a schematic view of a staple binder according to a modification, viewed from an upstream side in a conveyance direction;

FIG. 11 is a block diagram illustrating a hardware configuration of control blocks that control the post-processing apparatus according to the first embodiment;

FIG. 12 is a flowchart of a binding process performed by an edge binder;

FIGS. 13A, 13B, and 13C are diagrams illustrating the positions of a liquid applier and a crimper during a binding process performed by an edge binder;

FIGS. 14A and 14B are diagrams illustrating a location and configuration of a second liquid storage tank in a post-processing apparatus;

FIG. 15 is a diagram illustrating a configuration of attachment and detachment of a second liquid storage tank in a post-processing apparatus;

FIG. 16 is a flowchart of a liquid supply determination process according to the first embodiment;

FIG. 17 is a diagram illustrating a liquid supply/discharge mode according to the first embodiment;

FIGS. 18A, 18B, 18C, and 18D are diagrams illustrating replenishment of liquid to a first liquid storage tank according to the first embodiment;

FIGS. 19A and 19B are flowcharts of a liquid supply determination process according to the first embodiment;

FIGS. 20A and 20B are diagrams illustrating replenishment of liquid to the first liquid storage tank according to the first embodiment;

FIG. 21 is a flowchart of a liquid supply determination process according to the first embodiment;

FIG. 22 is a flowchart of a liquid supply determination process according to the first embodiment;

FIGS. 23A and 23B are diagrams illustrating an outline of a liquid discharge operation which one of liquid supply/discharge modes;

FIG. 24 is a flowchart of a liquid supply determination process according to the first embodiment;

FIG. 25 is a diagram illustrating an example of a selection input screen for a liquid supply/discharge mode according to the first embodiment.

FIG. 26 is a diagram illustrating another configuration of attachment and detachment of a second liquid storage tank in a post-processing apparatus;

FIGS. 27A and 27B is diagrams illustrating a configuration of a second liquid storage tank;

FIGS. 28A, 28B, 28C, and 28D are diagrams illustrating a configuration of a locking mechanism of the second liquid storage tank;

FIGS. 29A, 29B, and 29C are diagrams illustrating examples of a locking tab of a locking mechanism;

FIGS. 30A, 30B, and 30C are diagrams illustrating a correlation between parts of a locking mechanism;

FIGS. 31A, 31B, 31C, and 31D are diagrams illustrating a configuration of a locking mechanism in a second liquid storage tank according to a modification;

FIG. 32 is a diagram illustrating a modification of a configuration of a locking mechanism disposed in the second liquid storage tank;

FIGS. 33A and 33B are diagrams illustrating a configuration of a locking mechanism of a second liquid storage tank according to a modification;

FIG. 34 is a diagram illustrating an example of a liquid supplier connected to a second liquid storage tank;

FIG. 35 is a diagram illustrating an arrangement of a liquid-level sensor of a second liquid storage tank;

FIGS. 36A, 36B, 36C, 36D, and 36E are diagrams illustrating a parallel binding operation of a crimper and a liquid applier;

FIG. 37 is a diagram illustrating an internal structure of a post-processing apparatus according to a second embodiment;

FIGS. 38A, 38B, and 38C are schematic views of an internal tray according to the second embodiment, viewed from a thickness direction of a sheet;

FIG. 39 is a schematic view of a crimper of the post-processing apparatus according to the second embodiment, viewed from a downstream side in a conveyance direction;

FIGS. 40A and 40B are schematic views of a liquid applier according to the second embodiment, viewed from a thickness direction of a sheet;

FIGS. 41A, 41B, and 41C are cross-sectional views of a liquid application unit of the liquid applier taken through XXV-XXV of FIG. 40A;

FIGS. 42A, 42B, and 42C are cross-sectional views of the liquid application unit of the liquid applier taken through XXVI-XXVI of FIG. 40A;

FIG. 43 is a block diagram illustrating a hardware configuration of control blocks of the post-processing apparatus according to the second embodiment;

FIG. 44 is a flowchart of post-processing of the post-processing apparatus according to the second embodiment;

FIG. 45 is a diagram illustrating an overall configuration of an image forming system according to a modification;

FIGS. 46A and 46B are diagrams each illustrating a post-processing apparatus including a controller according to a modification; and

FIGS. 47A and 47B are diagrams each illustrating a post-processing apparatus including a controller according to a modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the accompanying drawings. Note that identical parts are given identical reference signs and redundant descriptions are summarized or omitted accordingly.

A description is given below of an image forming system 1 according to an embodiment of the present disclosure, with reference to the drawings.

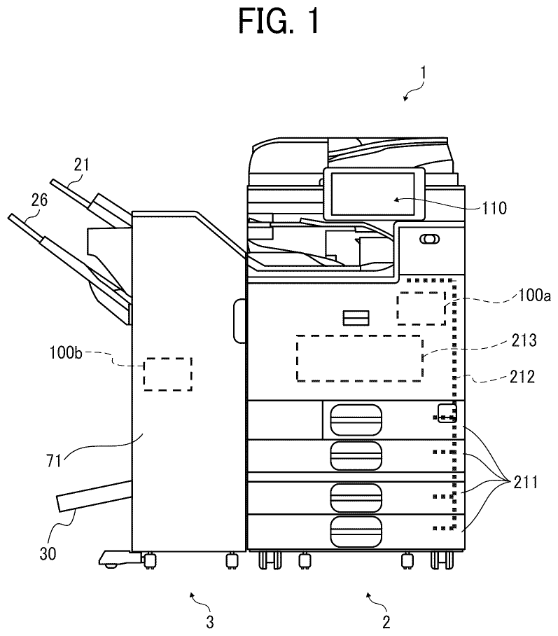

FIG. 1 is a diagram illustrating an overall configuration of the image forming system 1. The image forming system 1 has, for example, an image forming function of forming an image on a sheet P as an example of a sheet-shaped medium and a post-processing function of performing post-processing on the sheet P on which the image has been formed. As illustrated in FIG. 1, the image forming system 1 includes an image forming apparatus 2 having the image forming function and a post-processing apparatus 3 serving as a media processing apparatus having the post-processing function according to an embodiment of the present disclosure. In the image forming system 1, the image forming apparatus 2 and the post-processing apparatus 3 operate in conjunction with each other.

In the present embodiment, the sheet-shaped medium to be processed in the image forming system 1 is assumed to be a sheet of “paper.” However, the object to be processed according to the present embodiment is not limited to a sheet of paper. For example, any type of medium can be used as long as an image can be formed on the medium according to an image forming process. Examples of the medium include any medium that can be an object of a folding process or a binding process, and the material or specification of the medium is not limited to any particular material or specification.

The image forming apparatus 2 forms an image on the sheet P and ejects the sheet P having the image to the post-processing apparatus 3. The image forming apparatus 2 includes an accommodation tray 211 that accommodates sheets P, a conveyor 212 that conveys a sheet P from the accommodation tray 211, and an image forming device 213 that forms an image on the sheet P conveyed by the conveyor 212. The image forming device 213 may be an inkjet system that forms an image using an inkjet system or an electrophotographic system that forms an image with toner. The image forming apparatus 2 also includes a controller 100a that controls various operations of the conveyor 212 and the image forming device 213. Since the image forming apparatus 2 has a typical configuration, a detailed description of the configuration is omitted.

Sheets of paper are widely known as an example of sheet-shaped media. In the following description, a sheet-shaped medium as a medium to be processed is referred to as a “sheet P.” Further, in the following description, a stack of sheets of paper as a plurality of media is an example of a “sheet stack Pb.”

A description is given below of a post-processing apparatus 3 according to a first embodiment.

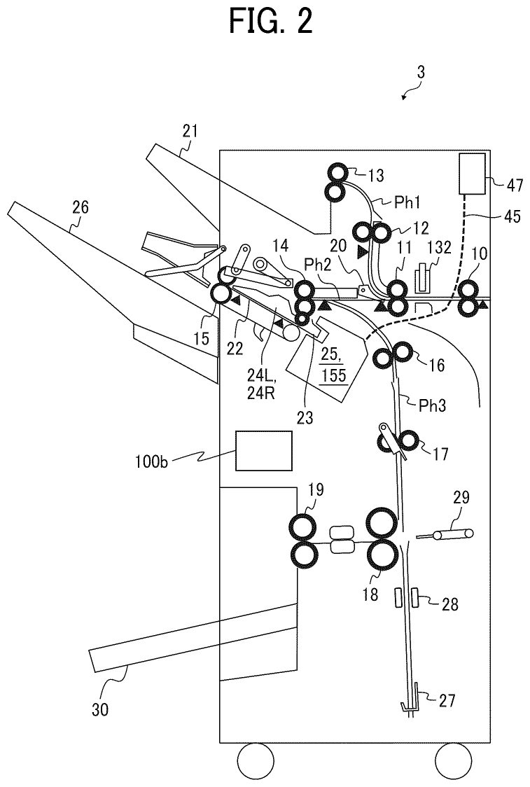

FIG. 2 is a diagram illustrating an internal configuration of the post-processing apparatus 3 according to the first embodiment. The post-processing apparatus 3 has a function that performs post-processing on the sheet P on which an image has been formed by the image forming apparatus 2. An example of the post-processing according to the present embodiment is a binding process as a “crimp binding process” that binds, without staples, a plurality of sheets P on each of which an image is formed as a bundle of sheets, which may be referred to as a sheet bundle. Another example of the post-processing according to the present embodiment is a binding process as a “stapling process” that binds, with staples, a plurality of the sheets P on each of which an image is formed as a bundle of sheets P (i.e., sheet bundle). In the following description, the bundle of sheets may be referred to as a “sheet stack Pb” as a bundle of media.

In the present embodiment, a description is typically given of liquid application in a crimp binding process. However, liquid application performed in a stapling process is similar to the liquid application in the crimp binding process. In the following description, the term “binding process” indicates both the “crimp binding process” and the “stapling process”, and is not limited to any particular binding method (whether a staple is used or pressing deformation is performed).

More specifically, the “crimp binding process” according to the present embodiment is a process called “crimp binding” to apply pressure to the binding position corresponding to a part of a sheet stack Pb to deform (pressure-deform) the binding position and bind the sheet stack Pb. The binding that can be executed by the post-processing apparatus 3 includes edge binding and saddle binding. The edge binding is a process to bind an end (including an edge) of the sheet stack Pb. The saddle binding is a process to bind the center of the sheet stack Pb.

The post-processing apparatus 3 includes conveyance roller pairs 10 to 19 (an example of conveyors), a switching member 20, and a controller 100b (an example of a control device). The controller 100b controls the operations of, for example, the conveyance roller pairs 10 to 19 (an example of conveyors), and the switching member 20. Details of the controller 100b will be described below. The conveyance roller pairs 10 to 19 convey, inside the post-processing apparatus 3, a sheet P supplied from the image forming apparatus 2. Specifically, the conveyance roller pairs 10 to 13 convey the sheet P along a first conveyance passage Ph1. The conveyance roller pairs 14 and 15 convey the sheet P along a second conveyance passage Ph2. The conveyance roller pairs 16 to 19 convey the sheet P along a third conveyance passage Ph3. A hole punch 132 is disposed between the conveyance roller pairs 10 and 11. The hole punch 132 performs punching on the sheet P conveyed by the conveyance roller pairs 10 and 11.

The first conveyance passage Ph1 is a passage extending to a first ejection tray 21 from a supply port through which the sheet P is supplied from the image forming apparatus 2. The second conveyance passage Ph2 is a passage branching from the first conveyance passage Ph1 between the conveyance roller pairs 11 and 14 in the conveyance direction of the sheet and extending to a second ejection tray 26 via the internal tray 22. The third conveyance passage Ph3 is a passage branching from the second conveyance passage Ph2 between the conveyance roller pairs 11 and 14 in the conveyance direction of the sheet and extending to a third ejection tray 30.

The switching member 20 is disposed at a branching position of the first conveyance passage Ph1 and the second conveyance passage Ph2. The switching member 20 can be switched between a first position and a second position. The switching member 20 in the first position guides the sheet P to be ejected to the first ejection tray 21 through the first conveyance passage Ph1. The switching member 20 in the second position guides the sheet P conveyed through the first conveyance passage Ph1 to the second conveyance passage Ph2. The conveying roller pair 14 is rotated in reverse at the timing when the trailing edge of the sheet P that has entered the second conveyance passage Ph2 passes through the branching position of the second conveyance passage Ph2 and the third conveyance passage Ph3. Thus, the sheet P is guided to the third conveyance passage Ph3. The post-processing apparatus 3 further includes a plurality of sensors that detects the positions of the sheet P in the first conveyance passage Ph1, the second conveyance passage Ph2, and the third conveyance passage Ph3. Each of the sensors is indicated by a black triangle in FIG. 2.

The post-processing apparatus 3 includes a first ejection tray 21. The sheet P that is output through the first conveyance passage Ph1 is placed on the first ejection tray 21. Among the sheet P supplied from the image forming apparatus 2, the sheet P on which the binding operation is not performed is ejected to the first ejection tray 21.

The post-processing apparatus 3 further includes the internal tray 22 serving as a placement tray, an end fence 23, side fences 24L and 24R, an edge binder 25, a staple binder 155, and a second ejection tray 26. The internal tray 22, the end fence 23, the side fences 24L and 24R, the edge binder 25, and the staple binder 155 perform edge binding on the sheet stack Pb including multiple sheets P conveyed from the second conveyance passage Ph2 to the internal tray 22. Among the sheets P supplied from the image forming apparatus 2, the sheet bundle Pb subjected to the edge binding is ejected to the second ejection tray 26.

Examples of the “edge binding process” include, but not limited to, “parallel binding process,” “oblique binding process,” and “vertical binding process.” The “parallel binding process” is a process of binding the sheet bundle Pb along one side of the sheet bundle Pb parallel to the main scanning direction. The “oblique binding process” is a process of binding a corner of the sheet bundle Pb. The “vertical binding process” is a process of binding the sheet bundle Pb along one side of the sheet bundle Pb parallel to the conveyance direction.

In the following description, a direction in which the sheet P is conveyed from the conveyance roller pair 15 toward the end fence 23 is defined as a “conveyance direction.” In other words, the “conveyance direction” herein corresponds to a direction in which the sheet P that has been output from the image forming apparatus 2 is moved toward the second ejection tray 26 by, for example, the conveyance roller pair 10, is changed to move toward the end fence 23 by the conveyance roller pair 15 in a direction different from the above-described direction. The direction that is orthogonal to both the conveyance direction and a thickness direction of the sheet P is defined as a “main scanning direction” or a “width direction of the sheet P.”

The sheets P that are sequentially conveyed through the second conveyance passage Ph2 are temporarily placed on the internal tray 22 serving as a placement tray. The end fence 23 aligns the position, in the conveyance direction, of the sheet P or the sheet stack Pb placed on the internal tray 22. The side fences 24L and 24R align the position, in the main scanning direction, of the sheet P or the sheet stack Pb placed on the internal tray 22. The edge binder 25 and the staple binder 155 perform edge binding on the sheet stack Pb aligned by the end fence 23 and the side fences 24L and 24R. The conveyance roller pair 15 ejects the sheet bundle Pb subjected to the edge binding to the second ejection tray 26.

The post-processing apparatus 3 further includes an end fence 27, a saddle binder 28, a sheet folding blade 29, and the third ejection tray 30. The end fence 27, the saddle binder 28, and the sheet folding blade 29 perform the saddle binding on the sheet bundle Pb of the sheets P that are conveyed through the third conveyance passage Ph3. Among the sheets P supplied from the image forming apparatus 2, the sheet bundle Pb subjected to the saddle binding is ejected to the third ejection tray 30.

The end fence 27 aligns the positions of the sheets P, which are sequentially conveyed to the third conveyance passage Ph3, in a direction in which the sheets P are conveyed. The end fence 27 is movable in a direction (vertical direction in FIG. 2) in which the sheet P is conveyed toward the end fence 27 and in a direction opposite thereto so as to locate the center of the sheet bundle Pb at a binding position where the saddle binder 28 faces the center of the sheet bundle Pb and a folding position where the sheet folding blade 29 faces the center of the sheet bundle Pb. The saddle binder 28 binds the center of the sheet stack Pb aligned by the end fence 27 at the binding position. The sheet folding blade 29 folds, in half, the sheet stack Pb placed on the end fence 27 at the folding position and causes the conveyance roller pair 18 to nip the sheet stack Pb. The conveyance roller pairs 18 and 19 eject the sheet bundle Pb subjected to the saddle binding to the third ejection tray 30.

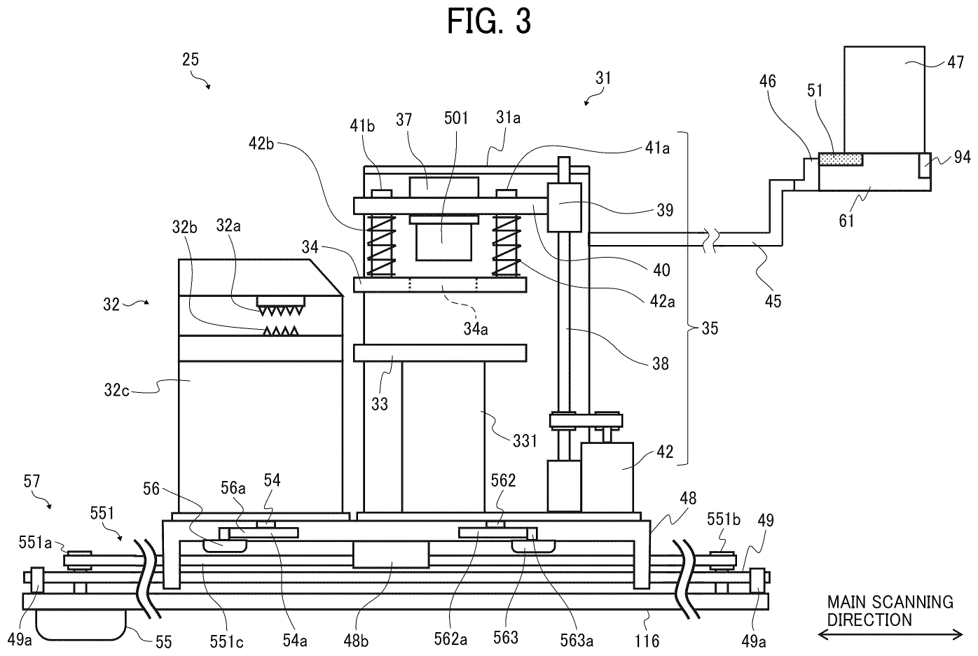

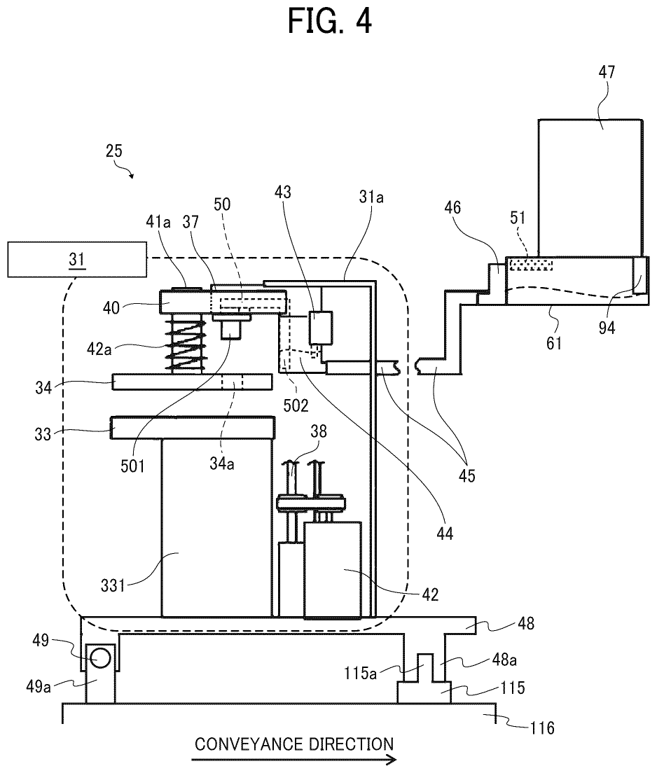

In addition, as illustrated in FIGS. 3 and 4, the post-processing apparatus 3 includes a liquid application member 501 (a part of the liquid applier), a liquid supply member 50 (a part of the liquid supplier), and a first liquid storage tank 44 (a first liquid storage) in the edge binder 25. The post-processing apparatus 3 includes a liquid supply passage 45 (a part of a liquid supplier), a liquid supply pump 46 (a part of the liquid supplier), a second liquid storage tank 47 (a part of a second liquid storage), and a second-liquid-storage-tank fixer 61 (a part of the second liquid storage) as a configuration for replenishing the first liquid storage tank 44 with the liquid. The liquid that is stored in the second liquid storage tank 47 is supplied to the first liquid storage tank 44 through the second-liquid-storage-tank fixer 61, the liquid supply pump 46, and the liquid supply passage 45.

A detailed description is given below of the edge binder 25.

FIG. 3 is a schematic diagram illustrating an upstream side of the edge binder 25 in the conveyance direction. The edge binder 25 performs liquid application and crimp binding illustrated in FIG. 2. FIG. 4 is a schematic view of a liquid applier 31 of the edge binder 25 in the main scanning direction. As illustrated in FIG. 3, the edge binder 25 includes a liquid applier 31 that applies liquid to the sheets P, and a crimper 32 that is an example of a post-processing device and performs crimping binding on the sheet bundle Pb. The liquid applier 31 and the crimper 32 are disposed adjacent to each other in the main scanning direction downstream from the internal tray 22 in the conveyance direction.

As illustrated in FIG. 4, the liquid applier 31 applies the liquid stored in the first liquid storage tank 44 to the sheet P or the sheet bundle Pb placed on the internal tray 22. In the following description, applying liquid to a sheet P or a sheet bundle Pb by the liquid applier 31 and the operation of the liquid applier 31 when applying liquid are referred to as “liquid application.” The liquid application operation of the liquid applier 31 accompanied by the control process is referred to as a “liquid application process.”

More specifically, the liquid that is stored in the first liquid storage tank 44 for the liquid application includes, as a main component, the liquid state of a compound of hydrogen and oxygen compound represented by the chemical formula H₂O. The temperature condition is not limited, and the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid that is stored in the first liquid storage tank 44 may include an additive in addition to the main component. The liquid that is stored in the first liquid storage tank 44 may include residual chlorine used as tap water. Preferably, for example, the liquid that is stored in the first liquid storage tank 44 may include, as an additive, a colorant, a penetrant, a pH adjuster, a preservative such as phenoxyethanol, a drying inhibitor such as glycerin, or a combination thereof. Furthermore, because water is used as a component of ink used for inkjet printers or ink used for water-based pens, such water or ink may be used for the “liquid application”.

The water is not limited to the specific examples described above. The water may be water in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above enhances the binding strength of the sheet stack Pb, in comparison with a liquid of which the main component is not water (liquid).

As illustrated in FIGS. 3 and 4, the liquid applier 31 can be moved in the main scanning direction together with the crimper 32 by the driving force transmitted from the edge-binder movement motor 55. The liquid applier 31 includes a lower pressure plate 33 as a sheet stacking table of the sheet P or the sheet bundle Pb, an upper pressure plate 34, and a liquid-applier movement assembly 35. The components of the liquid applier 31 (the lower pressure plate 33, the upper pressure plate 34, the liquid-applier movement assembly 35, and a liquid-applier movement motor 42) are held by at least one of a liquid application frame 31a and a base 48.

A liquid applier shaft 562 provided with a drive transmission gear 562a is fixed to a bottom face of the liquid application frame 31a that holds the components of the liquid applier 31. The liquid applier shaft 562 and the drive transmission gear 562a are held by the base 48 on which the liquid application frame 31a is disposed, so as to be rotatable in the forward and reverse directions. The drive transmission gear 562a meshes with an output gear 563a of the liquid-applier pivot motor 563. The liquid applier 31 can be rotated in the forward and reverse directions about the liquid applier shaft 562 on the base 48 by a driving force transmitted from the liquid-applier pivot motor 563 to the liquid applier shaft 562 via the output gear 563a and the drive transmission gear 562a.

The lower pressure plate 33 and the upper pressure plate 34 are disposed downstream from the internal tray 22 in the conveyance direction. The sheets P or the sheet bundle Pb that is placed on the internal tray 22 is also placed on the lower pressure plate 33. The lower pressure plate 33 is disposed on a lower pressure plate holder 331. The upper pressure plate 34 is movable in the thickness direction of the sheet P or the sheet stack Pb at a position where the upper pressure plate 34 faces the sheet P or the sheet stack Pb placed on the internal tray 22.

In other words, the lower pressure plate 33 and the upper pressure plate 34 are disposed to face each other in the thickness direction of the sheet P or the sheet stack Pb with the sheet P or the sheet stack Pb placed on the internal tray 22 and interposed between the lower pressure plate 33 and the upper pressure plate 34. In the following description, the thickness direction of the sheet P or the sheet stack Pb may be referred to simply as “thickness direction.” Further, the upper pressure plate 34 is provided with a through hole 34a passing through the upper pressure plate 34 in the thickness direction at a position opposite to the liquid application member 501 held via a holder 37 attached to a base plate 40. The liquid application member 501 is one end portion of a liquid supply member 50 (liquid absorber) described below and corresponds to a tip portion of the liquid supply member 50.

The liquid-applier movement assembly 35 moves the upper pressure plate 34, the base plate 40, the holder 37, the liquid application member 501, the liquid supply member 50, and the first liquid storage tank 44 in the thickness direction of the sheet P or the sheet stack Pb. The liquid-applier movement assembly 35 according to the embodiment moves the upper pressure plate 34, the base plate 40, the holder 37, the liquid application member 501, the liquid supply member 50, and the first liquid storage tank 44 together by the single liquid-applier movement motor 42. The liquid-applier movement assembly 35 includes, for example, the liquid-applier movement motor 42, a trapezoidal screw 38, a nut 39, the base plate 40, columns 41a and 41b, and coil springs 42a and 42b.

The liquid-applier movement motor 42 generates a driving force to move the upper pressure plate 34, the base plate 40, the holder 37, the liquid application member 501, the liquid supply member 50, and the first liquid storage tank 44. The trapezoidal screw 38 extends in the thickness direction of the sheet P or the sheet stack Pb and is provided with the liquid application frame 31a such that the trapezoidal screw 38 is rotatable in the forward and reverse directions. The trapezoidal screw 38 is coupled to an output shaft of the liquid-applier movement motor 42 via, for example, a pulley and a belt. The nut 39 is screwed to the trapezoidal screw 38. The trapezoidal screw 38 is rotated in the forward and reverse directions by the driving force transmitted from the liquid-applier movement motor 42. The rotation of the trapezoidal screw 38 causes the nut 39 to reciprocate on the trapezoidal screw 38.

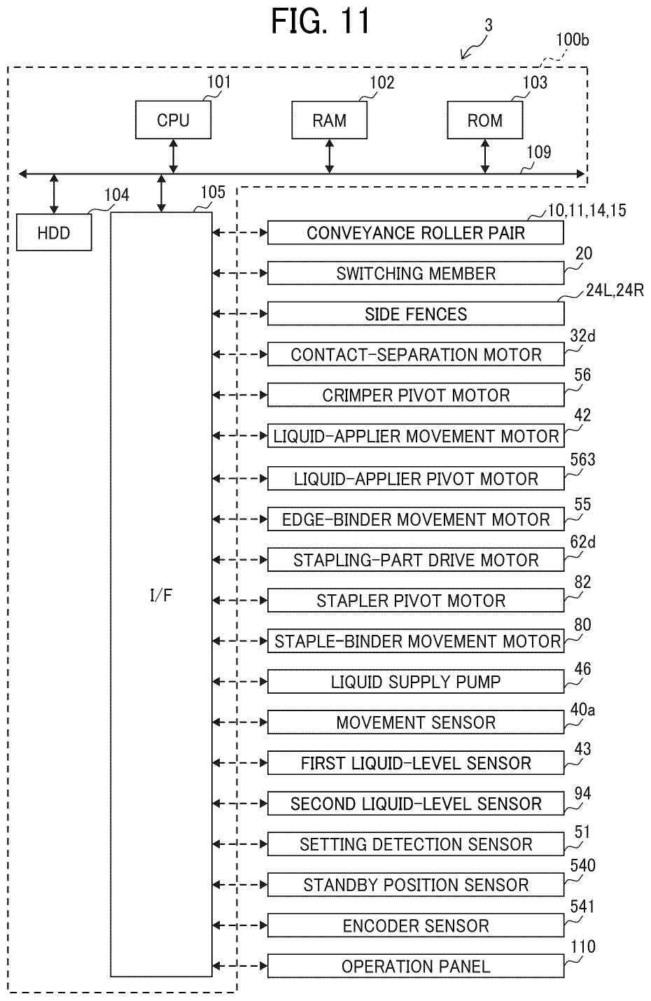

The base plate 40 is positioned apart from the upper pressure plate 34. The base plate 40 holds the liquid application member 501 with the tip portion of the liquid application member 501 protruding from the base plate 40 toward the upper pressure plate 34. The base plate 40 is coupled to the trapezoidal screw 38 via the nut 39 such that base plate 40 can reciprocate along the trapezoidal screw 38 as the trapezoidal screw 38 rotates in the forward and reverse directions. The position of the base plate 40 in the vertical direction is detected by a movement sensor 40a (see FIG. 11).

The columns 41a and 41b project from the base plate 40 toward the upper pressure plate 34 around the tip portion of the liquid application member 501. The columns 41a and 41b can relatively move with respect to the base plate 40 in the thickness direction. The columns 41a and 41b hold the upper pressure plate 34 with the respective ends closer to the lower pressure plate 33 than the other ends of the columns 41a and 41b. The other ends of the columns 41a and 41b opposite the ends closer to the lower pressure plate 33 are provided with stoppers that prevent the columns 41a and 41b from being removed from the base plate 40.

The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid applier 31 applies liquid to the sheet P or the sheet bundle Pb placed on the internal tray 22. More specifically, the liquid applier 31 brings the liquid application member 501 into contact with the sheet P or the sheet bundle Pb to apply the liquid to at least one sheet P of the sheet bundle Pb.

The liquid applier 31 includes a first liquid-level sensor 43 (a first liquid detector), the first liquid storage tank 44, the liquid application member 501, the liquid supply member 50, and the holder 37. The first liquid storage tank 44 stores the liquid for performing liquid application on the sheet P or the sheet bundle Pb. The liquid level (stored liquid amount) of the liquid stored in the first liquid storage tank 44 is detected by the first liquid-level sensor 43. The first liquid storage tank 44 is coupled to the base plate 40 via the holder 37.

The liquid application member 501, the liquid supply member 50 (liquid absorber) disposed in close contact with the liquid application member 501, and the first liquid storage tank 44 are held by the holder 37. The holder 37 is held by the base plate 40. The liquid supply member 50 has a first end in close contact with the liquid application member 501 and a second end immersed in the liquid stored in the first liquid storage tank 44. In other words, the second end of the liquid supply member 50 corresponds to a liquid immersion portion 502 that draws up the liquid and supplies the liquid to the liquid application member 501. The liquid application member 501 and the liquid supply member 50 are made of a material (e.g., sponge or fiber) having a high liquid absorption rate, such as an elastic resin formed of open cells. However, at least one of the liquid application member 501 or the liquid supply member 50 is not limited to a particular type as long as the at least one of the liquid application member 501 or the liquid supply member 50 is made of a material having properties of absorbing and holding the liquid and has a property of being crushable in accordance with a pressing force applied when the at least one of the liquid application member 501 or the liquid supply member 50 is in contact with the sheet P. In other words, the material may be any material as long as the material can absorb or draw up liquid by capillary action.

Accordingly, when the second end (the liquid immersion portion 502) of the liquid supply member 50 is immersed in the liquid stored in the first liquid storage tank 44, the liquid supply member 50 sucks up the liquid by capillary action. In other words, the liquid stored in the first liquid storage tank 44 is sucked up from the liquid immersion portion 502 of the liquid supply member 50, and the sucked liquid is supplied to the liquid application member 501 that is coupled to the tip portion via the liquid supply member 50. Then, the liquid stored in the first liquid storage tank 44 is sucked up to the liquid application member 501 in close contact with one end portion of the liquid supply member 50, and thus the liquid level (stored liquid amount) of the liquid stored in the first liquid storage tank 44 detected by the first liquid-level sensor 43 is lowered. As a result, the liquid is supplied from the second liquid storage tank 47 to the first liquid storage tank 44 by the liquid supply pump 46.

Although the case where the liquid supply member 50 and the liquid application member 501 are separate bodies has been described above, the liquid supply member 50 and the liquid application member 501 may be integrally formed of a material having the same properties (for example, a material having a high liquid absorption rate). In other words, the liquid application member 501 may be part of the liquid supply member 50. In such a case, liquid can be supplied from the liquid supply member 50 to the liquid application member 501 more smoothly by the capillary action and a reduction in cost can be achieved.

At this time, the liquid application member 501 draws up the liquid stored in the first liquid storage tank 44. Accordingly, the amount of liquid (liquid level) in the first liquid storage tank 44 temporarily decreases to a level below the reference liquid level described below. In response to this decrease of liquid in the first liquid storage tank 44, a series of liquid supply operations for feeding liquid from the second liquid storage tank 47 to the first liquid storage tank 44 is performed. This series of liquid supply operations is mainly performed at the time of activation of the post-processing apparatus 3 or at the time of start of execution of the binding process involving liquid application in the post-processing apparatus 3, and corresponds to the liquid supply operations for bringing the liquid application using the liquid application member 501 to be executable. In the following description, the liquid supply operation is referred to as a “filling supply operation.” Details of the filling supply operation will be described later.

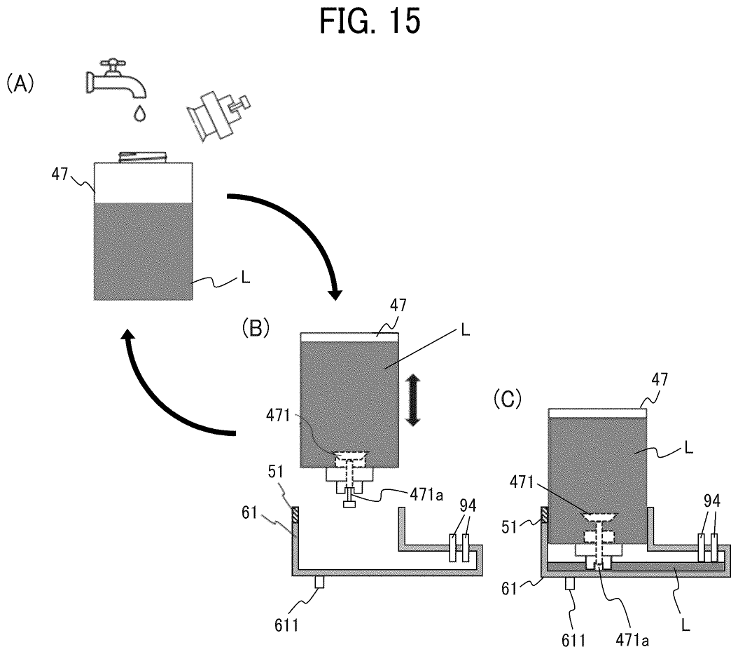

The post-processing apparatus 3 is provided with the second liquid storage tank 47. The second liquid storage tank 47 is detachably attached to the post-processing apparatus 3 (see FIG. 15). When the second liquid storage tank 47 is fixed (set) to the second-liquid-storage-tank fixer 61 (a part of the second liquid storage) in a given position, the liquid already stored in the second liquid storage tank 47 can be supplied to the first liquid storage tank 44.

The operation to supply liquid from the second liquid storage tank 47 to the first liquid storage tank 44 by the liquid supply pump 46 is executed in response to a decrease in the stored liquid amount (liquid level) in the first liquid storage tank 44. The stored liquid amount (liquid level) of the first liquid storage tank 44 is reduced by the liquid being consumed by the liquid application by the liquid applier 31. In other words, the operation of supplying liquid from the second liquid storage tank 47 to the first liquid storage tank 44 corresponds to the liquid supply operation needed with the execution of the job including the liquid application by the liquid applier 31.

This liquid supply operation corresponds to an operation of supplying liquid to the first liquid storage tank 44 so as to add liquid each time the stored liquid amount (liquid level) of the first liquid storage tank 44 falls below the reference liquid level, which is described below. In the following description, the liquid supply operation is referred to as a “additional supply operation.” Details of the additional supply operation will be described later.

When the second liquid storage tank 47 is set in the second-liquid-storage-tank fixer 61, the second-liquid-storage-tank fixer 61 is filled with a certain amount of the liquid in the second liquid storage tank 47. The second-liquid-storage-tank fixer 61 includes a setting detection sensor 51 (serving as a set detector) (see FIG. 15). When the setting detection sensor 51 detects the set state of the second liquid storage tank 47 to the second-liquid-storage-tank fixer 61 (see part (C) of FIG. 15), a signal indicating the set state is transmitted to the controller 100b, which is described below. Thus, the controller 100b detects whether the second liquid storage tank 47 is set on the second-liquid-storage-tank fixer 61. Details of the second liquid storage tank 47 are described later.

The first liquid storage tank 44 and the second liquid storage tank 47 are connected to each other by the liquid supply passage 45. The liquid supply pump 46 is disposed near the second-liquid-storage-tank fixer 61. As the liquid supply pump 46 is driven, the liquid stored in the second liquid storage tank 47 is supplied (replenished) from the second liquid storage tank 47 to the first liquid storage tank 44 via the liquid supply passage 45. Accordingly, the second-liquid-storage-tank fixer 61 is a component of the liquid supplier that executes a liquid supply operation to supply liquid from the second liquid storage tank 47 to the first liquid storage tank 44. The liquid supply passage 45 includes a flexible material. According to such a configuration, even if the first liquid storage tank 44 is moved by the liquid-applier movement assembly 35, liquid can be supplied from the second liquid storage tank 47 to the first liquid storage tank 44.

The amount of liquid supplied from the second liquid storage tank 47 to the first liquid storage tank 44 can be controlled in accordance with the detection result of the first liquid-level sensor 43. In other words, the controller 100b, which is described below, determines whether the stored liquid amount (liquid level) in the first liquid storage tank 44 based on the detection result of the first liquid-level sensor 43. In accordance with the determined stored liquid amount (liquid level) of the first liquid storage tank 44, the controller 100b controls the operation speed and time of the liquid supply pump 46. Thus, the controller 100b can adjust the amount of liquid to be replenished to the first liquid storage tank 44 to maintain the stored liquid amount (liquid level) in the first liquid storage tank 44 at a predetermined level of liquid.

A description is given below of the configuration of the crimper 32.

The crimper 32 serving as a post-processing device presses and deforms a portion of the sheet bundle Pb by serrated upper crimping teeth 32a and lower crimping teeth 32b, and crimps the sheets P of the portion to bind the sheet bundle Pb. In short, the crimper 32 binds the sheet bundle Pb without staples. The components of the crimper 32 such as the upper crimping teeth 32a and the lower crimping teeth 32b are disposed on a crimping frame 32c.

In the following description, such a way of pressing and deforming a given position on the sheet bundle Pb to bind the sheet bundle Pb may be referred to as “crimp binding.” In other words, the crimper 32 crimps and binds the sheet bundle Pb or performs the crimp binding on the sheet bundle Pb. The crimping and binding operation of the crimper 32 that involves control processing is referred to as “crimp binding process”.

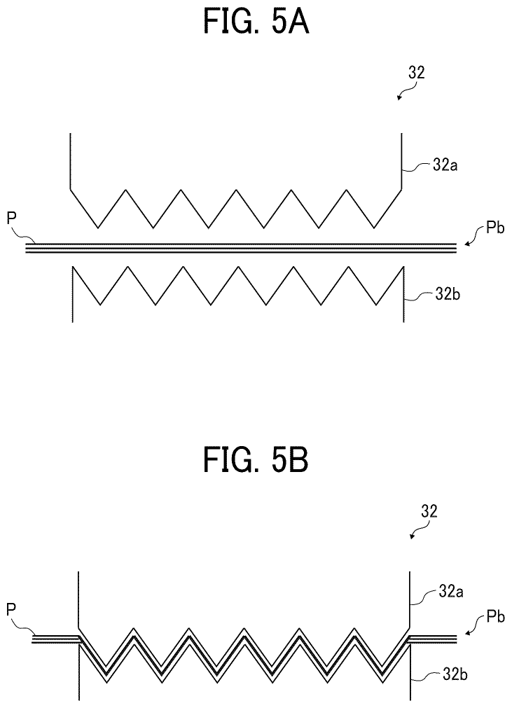

FIGS. 5A and 5B are schematic diagrams illustrating a configuration of the crimper 32. As illustrated in FIGS. 5A and 5B, the crimper 32 includes the upper crimping teeth 32a and the lower crimping teeth 32b. The upper crimping teeth 32a and the lower crimping teeth 32b are disposed to face each other in the thickness direction of the sheet bundle Pb to pinch the sheet bundle Pb placed on the internal tray 22. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The upper crimping teeth 32a and the lower crimping teeth 32b are formed in a positional relationship in which the concave portions and convex portions of each of the upper crimping teeth 32a are alternately arranged and the concave portions and convex portions of the upper crimping teeth 32a are shifted from the concave portions and convex portions of the lower crimping teeth 32b so that the upper crimping teeth 32a and the lower crimping teeth 32b mesh with each other. The upper crimping teeth 32a and the lower crimping teeth 32b are brought into contact with and separated from each other by the driving force of a contact-separation motor 32d illustrated in FIG. 11.

In the process of supplying the sheets P of the sheet stack Pb to the internal tray 22, the upper crimping teeth 32a and the lower crimping teeth 32b are separated from each other as illustrated in FIG. 5A. When all the sheets P of the sheet stack Pb are placed on the internal tray 22, the upper crimping teeth 32a and the lower crimping teeth 32b are engaged with each other as illustrated in FIG. 5B by the driving force of the contact-separation motor 32d to press and deform the sheet stack Pb in the thickness direction. As a result, the sheet stack Pb that has been placed on the internal tray 22 is crimped and bound. The sheet stack Pb thus crimped and bound is ejected to the second ejection tray 26 by the conveyance roller pair 15.

The configuration of the crimper 32 as a crimping assembly is not limited to the configuration of a moving assembly exemplified in the present embodiment, and may be any other suitable structure in which the upper crimping teeth 32a and the lower crimping teeth 32b of the crimping assembly engage with each other. For example, the crimping assembly may bring the upper crimping teeth 32a and the lower crimping teeth 32b into contact with each other and separate the upper crimping teeth 32a and the lower crimping teeth 32b from each other with a link mechanism and a driving source that simply rotates in the forward direction or that rotates the forward and backward directions (e.g., the crimping assembly disclosed in Japanese Patent No. 6057167). Alternatively, the crimping assembly may employ a linear motion system to linearly bring the upper crimping teeth 32a and the lower crimping teeth 32b into contact with each other and separate the upper crimping teeth 32a and the lower crimping teeth 32b from each other with a screw assembly that converts the forward and backward rotational motions of a driving source into linear reciprocating motion.

As illustrated in FIG. 3, the edge binder 25 includes an edge-binder movement assembly 57. The edge-binder movement assembly 57 moves the edge binder 25, specifically, the liquid applier 31 and the crimper 32, in the main scanning direction along a downstream end, in the conveyance direction, of the sheet P placed on the internal tray 22. The edge-binder movement assembly 57 includes, for example, the base 48, a guide shaft 49, the edge-binder movement motor 55, and a driving force transmission assembly 551 that transmits the driving force of the edge-binder movement motor 55 to the base 48, and a standby position sensor 540 (see FIG. 11).

The liquid applier 31 and the crimper 32 are attached to the base 48 such that the liquid applier 31 and the crimper 32 are adjacent to each other in the main scanning direction. As illustrated in FIG. 4, the guide shaft 49 is held by multiple guide shaft brackets 49a disposed in the main scanning direction at a position on the upstream side of a binding assembly base 116 in the conveyance direction of the sheet P. As illustrated in FIG. 3, the guide shaft 49 extends in the main scanning direction on the binding assembly base 116. The guide rail 115 is disposed in the main scanning direction on the downstream side of the binding assembly base 116 in the conveyance direction of the sheet P. As illustrated in FIG. 4, the guide rail 115 includes a fitting target portion 115a that fits to a fitting portion 48a of the base 48 in the main scanning direction. In other words, the base 48 is movably held by the guide shaft 49 and the guide rail 115 in the main scanning direction on the binding assembly base 116.

The edge-binder movement motor 55 generates a driving force to move the edge binder 25. The driving force transmission assembly 551 transmits the driving force of the edge-binder movement motor 55 to the base 48 via pulleys 551a and 551b, a timing belt 551c, and a fastening portion 48b that fastens the base 48 and the timing belt 551c. As a result, the liquid applier 31 and the crimper 32 integrated by the base 48 move in the main scanning direction along the guide shaft 49.

The edge-binder movement motor 55 according to the present embodiment is, for example, a servo motor that can stop the edge binder 25 at a target position (the first binding position B1 and a second binding position B2 described below) without returning the edge binder 25 to an origin position (for example, a standby position HP described below) each time the edge binder 25 moves.

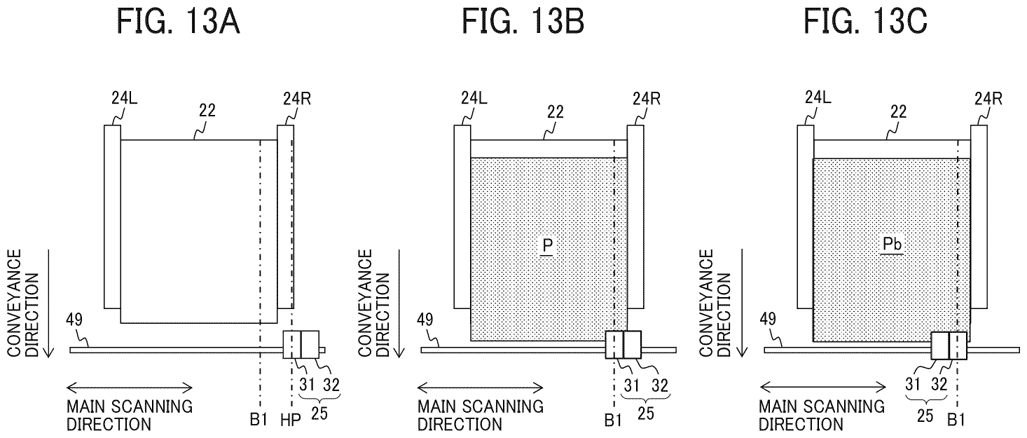

The post-processing apparatus 3 further includes a standby position sensor 540 and an encoder sensor 541. The standby position sensor 540 is, for example, a light-shielding optical sensor (see FIG. 11) to detect that the edge binder 25 has reached a standby position HP (see FIG. 13A). The encoder sensor 541 (see FIG. 11) is attached to an output shaft of the edge-binder movement motor 55. The controller 100b, which is described below, detects that the edge binder 25 has reached the standby position HP, based on a detection result of the standby position sensor 540. The controller 100b also counts pulse signals output from the encoder sensor 541 to ascertain the current position of the edge binder 25 moved from the standby position HP.

However, a specific method of stopping the edge binder 25 at the target position without returning the edge binder 25 to the standby position HP is not limited to the aforementioned example. As another example, the post-processing apparatus 3 may include a sensor that detects the arrival of the edge binder 25 at a given target position determined in advance.

As illustrated in FIG. 3, a crimper rotary shaft 54 provided with a drive transmission gear 54a is fixed to a bottom face of the crimping frame 32c that holds the components of the crimper 32. The crimper rotary shaft 54 and the drive transmission gear 54a are held by a base 48 on which the crimping frame 32c is disposed, so as to be rotatable in the forward and reverse directions. The drive transmission gear 54a meshes with an output gear 56a of a crimper pivot motor 56. The crimper 32 can be rotated in the forward and reverse directions about the crimper rotary shaft 54 on the base 48 by a driving force transmitted from the crimper pivot motor 56 to the crimper rotary shaft 54 via the output gear 56a and the drive transmission gear 54a.

In the above description, the edge binder 25 has a configuration of moving along the guide shaft 49 with the crimper 32 and the liquid applier 31 being integrated, the embodiments of the present disclosure are not limited to the above-described configuration. For example, the crimper 32 and the liquid applier 31 may have a configuration of moving separately from each other.

A description is given below of an edge binder 25′ according to a modification.

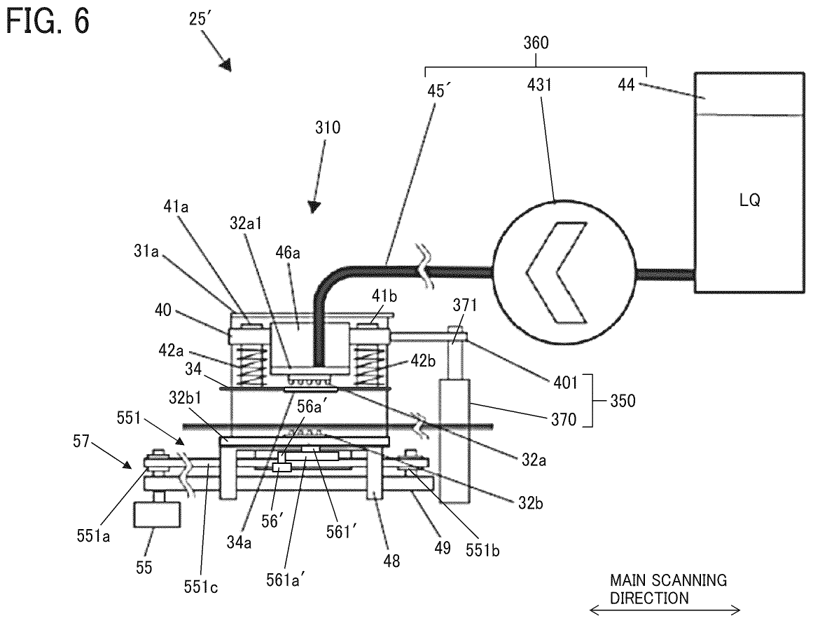

Specifically, referring now to FIGS. 6 to 8C, a description is given of an edge binder 25′ as a modification of the edge binder 25 included in the post-processing apparatus 3. A difference of the edge binder 25′ from the edge binder 25 according to the first embodiment is that the liquid applier 31 and the crimper 32 are integrated as a single unit. In the following description, the same or like components as those of the edge binder 25 described above are denoted by the same or like reference numerals, and redundant descriptions thereof may be omitted.

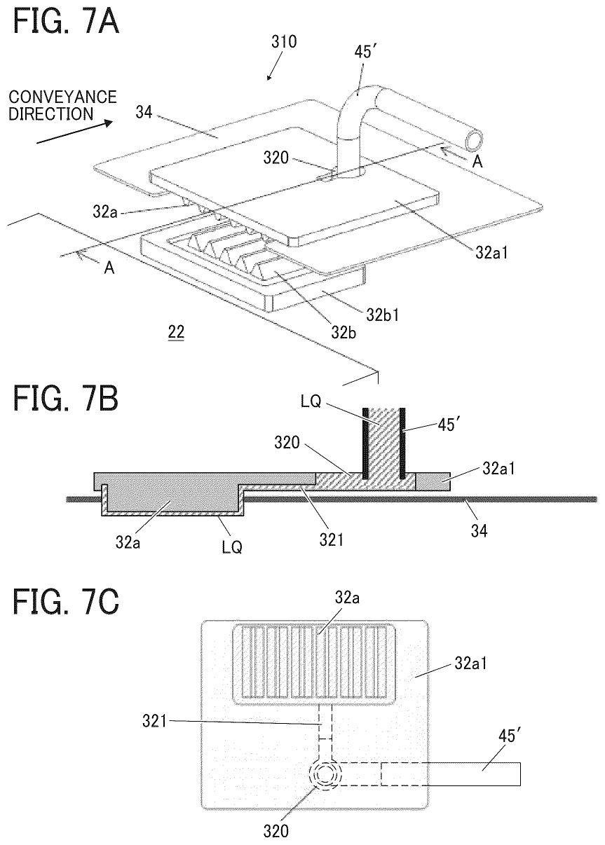

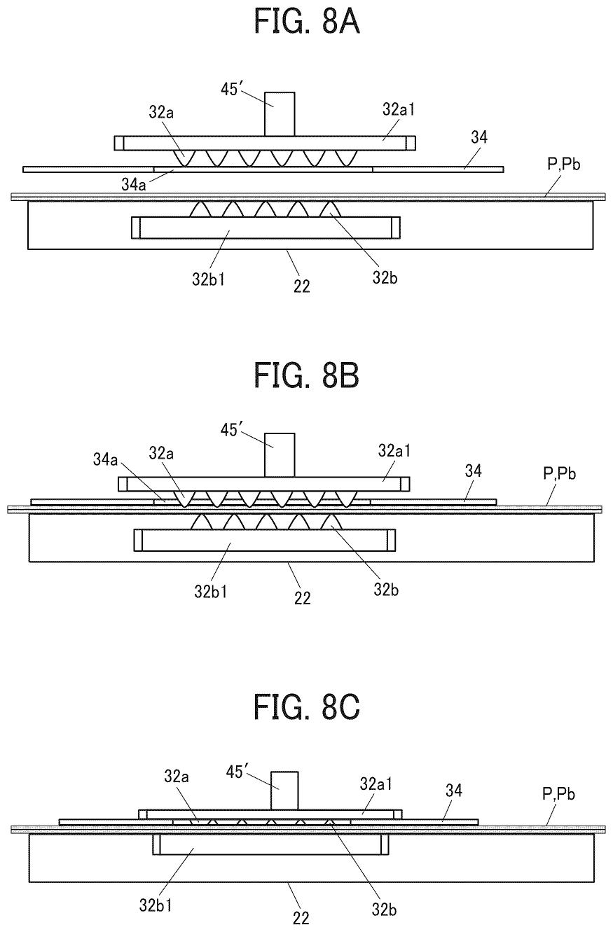

FIG. 6 is a schematic view of the edge binder 25′ viewed from the upstream side in the conveyance direction. FIG. 7A is a perspective view of a liquid application crimper 310. FIG. 7B is a cross-sectional view of the liquid application crimper 310 taken along line A-A in FIG. 7A. FIG. 7C is a plan view of the upper crimping teeth 32a of FIG. 7A as viewed from the side at which the lower crimping teeth 32b is disposed. FIGS. 8A, 8B, and 8C illustrate a liquid application operation and a crimp binding operation performed by the liquid application crimper 310 and are schematic views of the liquid application crimper 310 viewed from the downstream side in the conveyance direction.

As illustrated in FIG. 6, the edge binder 25′ includes the liquid application crimper 310 in which the liquid applier 31 and the crimper 32 (an example of a post-processing device) of the edge binder 25 according to the first embodiment are integrated as a single unit. The liquid application crimper 310 is disposed downstream from the internal tray 22 in the conveyance direction.

The liquid application crimper 310 applies liquid LQ stored in the first liquid storage tank 44 to a sheet P or a sheet bundle Pb placed on the internal tray 22. The liquid application crimper 310 can be moved in the main scanning direction by the driving force that is transmitted from the edge-binder movement motor 55 to the base 48 by the driving force transmission assembly 551. The liquid application crimper 310 includes the upper pressure plate 34, the upper crimping teeth (upper binding teeth) 32a, the lower crimping teeth (lower binding teeth) 32b, a liquid application crimper movement assembly 350, and a liquid supply assembly 360. Components of the liquid application crimper 310 are held by at least one of the liquid application frame 31a and the base 48.

A liquid application crimper shaft 561′ provided with a drive transmission gear 561a′ is fixed to a bottom face of the liquid application frame 31a. The liquid application crimper shaft 561′ and the drive transmission gear 561a′ are held by the base 48 on which the liquid application frame 31a is disposed, so as to be rotatable in the forward and reverse directions. The drive transmission gear 561a′ meshes with an output gear 56a′ of a liquid application crimper pivot motor 56′. The liquid application crimper 310 can be rotated in the forward and reverse directions about the liquid application crimper shaft 561′ on the base 48 by a driving force transmitted from the liquid application crimper pivot motor 56′ to the liquid application crimper shaft 561′ via the output gear 56a′ and the drive transmission gear 561a′.

The liquid application crimper movement assembly 350 moves the upper pressure plate 34, the base plate 40, and the upper crimping teeth 32a in cooperation with each other in the thickness direction of the sheet P or the sheet bundle Pb by an electric cylinder 370. The base plate 40 holds the upper crimping teeth holder 32al and the upper crimping teeth 32a via a holder 46a. The base plate 40 movably holds the upper pressure plate 34 via the columns 41a and 41b. The base plate 40 is attached to the distal end of a rod 371 of the electric cylinder 370 via a connecter 401.

The columns 41a and 41b hold the upper pressure plate 34 at lower ends of the columns 41a and 41b. The coil springs 42a and 42b are externally inserted into the columns 41a and 41b between the base plate 40 and the upper pressure plate 34. The coil springs 42a and 42b bias the upper pressure plate 34 and the columns 41a and 41b in a direction away from the base plate 40.

The liquid supply assembly 360 includes the first liquid storage tank 44, a liquid supply pump 431, and a liquid supply member 45′. The liquid supply pump 431 supplies the liquid LQ to the liquid reservoir 320 disposed in the upper crimping teeth holder 32al as illustrated in FIG. 7A via the liquid supply member 45′. The liquid supply member 45′ is coupled to the liquid supply pump 431 at the base end and to the liquid reservoir 320 at the distal end. The liquid supply member 45′ includes a long and elastic member.

As illustrated in FIG. 7B, the upper crimping teeth 32a are integrated with the upper crimping teeth holder 32a1. The upper crimping teeth holder 32al is provided with the liquid reservoir 320 and a liquid supply passage 321 for supplying the liquid LQ stored in the liquid reservoir 320 to the upper crimping teeth 32a. As illustrated in FIG. 7C, the surface of the upper crimping teeth 32a is subjected to a hydrophilic treatment so that the liquid LQ that is supplied through the liquid supply passage 321 uniformly spreads over the surface of the upper crimping teeth 32a. On the other hand, the portions of the upper crimping teeth holder 32al other than the upper crimping teeth 32a are subjected to a hydrophobic treatment so that the liquid LQ efficiently spreads over the surfaces of the upper crimping teeth 32a.

As illustrated in FIG. 6, the lower crimping teeth 32b are integrated with a lower crimping teeth holder 32b1, which is a part of the liquid application frame 31a. The lower crimping teeth 32b are attached to the base 48 via the lower crimping teeth holder 32b1.

A description is given below of the liquid application operation and the crimp binding operation of the liquid application crimper 310 with reference to FIGS. 8A, 8B, and 8C. In the process of supplying a sheet P to the internal tray 22, as illustrated in FIG. 8A, the upper crimping teeth 32a and the lower crimping teeth 32b are separated from each other. When the sheet P is placed on the internal tray 22, the electric cylinder 370 is contracted to move the upper crimping teeth 32a and the upper pressure plate 34 toward the sheet P. Then, as illustrated in FIG. 8B, the upper pressure plate 34 first comes into contact with the sheet P, and then the upper crimping teeth 32a pass through the through-hole 34a of the upper pressure plate 34 and come into contact with the sheet P. At this time, since the liquid LQ is spread over the surfaces of the upper crimping teeth 32a, bringing the upper crimping teeth 32a into contact with the sheet P allows the liquid to be applied to the liquid application position on the sheet P. When liquid application to the liquid application position is completed, the electric cylinder 370 is extended to separate the upper crimping teeth 32a and the upper pressure plate 34 from the sheet P. The above-described contact and separation operation (liquid application operation) of the upper crimping teeth 32a and the upper pressure plate 34 with respect to the sheets P is repeatedly performed on sheets P of the sheet bundle Pb.

When the sheet bundle Pb including a predetermined number of sheets P is placed on the internal tray 22, the electric cylinder 370 is further contracted to move the upper crimping teeth 32a form the liquid application position toward the lower crimping teeth 32b. Then, as illustrated in FIG. 8C, in a state in which the sheet bundle Pb is sandwiched between the upper crimping teeth 32a and the lower crimping teeth 32b, the upper crimping teeth 32a further moves toward the lower crimping teeth 32b. Thus, the upper crimping teeth 32a and the lower crimping teeth 32b press and deform the sheet bundle Pb to crimp and bind the sheet bundle Pb (crimp binding operation).

A description is given of a staple binder 155.

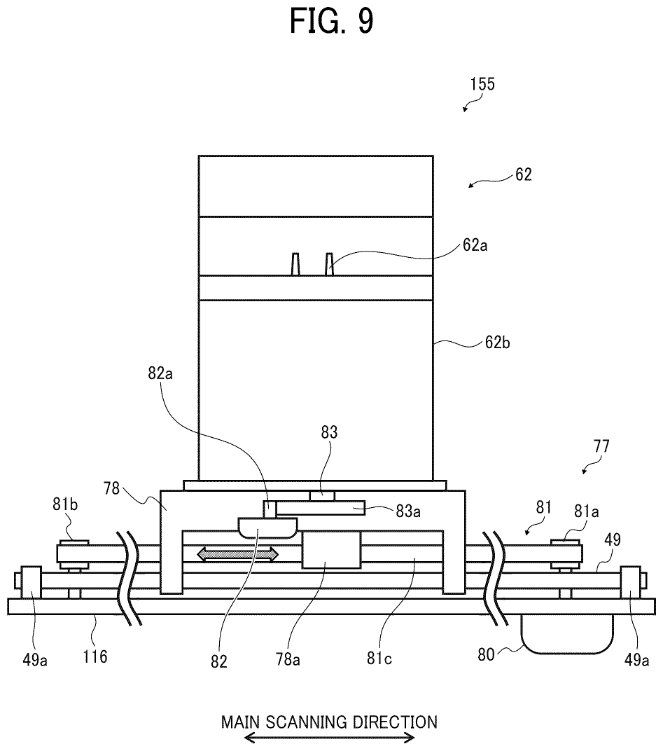

Specifically, a detailed description is given below of the staple binder 155 having a function of executing a stapling process. FIG. 9 is a schematic diagram illustrating the staple binder 155, viewed from the upstream side of the staple binder 155 in the conveyance direction. The staple binder 155 includes a stapler 62 that binds the sheet bundle Pb with staples. The stapler 62 is disposed downstream from the internal tray 22 in the conveyance direction and spaced apart from the edge binder 25 in the main scanning direction.

The stapler 62, which is an example of a post-processing device, has a configuration of performing so-called “stapling” (i.e., stapling process) to bind the sheet bundle Pb with a staple or staples. More specifically, the stapler 62 includes a stapling-part drive motor 62d illustrated in FIG. 11. The stapling-part drive motor 62d drives a stapling part 62a. The driving force of the stapling-part drive motor 62d causes a staple loaded in the stapling part 62a to penetrate through a sheet bundle Pb, so that the stapling part 62a binds the sheet bundle Pb. Since the stapler 62 has a typical configuration, a detailed description thereof will be omitted unless otherwise required.

As illustrated in FIG. 9, the staple binder 155 includes a staple binder movement assembly 77. The staple binder movement assembly 77 moves the staple binder 155 in the main scanning direction along a downstream end in the conveyance direction of the sheet P or the sheet bundle Pb placed on the internal tray 22. The staple binder movement assembly 77 includes, for example, a base 78, the guide shaft 49, a staple-binder movement motor 80, and a driving force transmission assembly 81. The driving force transmission assembly 81 transmits a driving force of the staple-binder movement motor 80 to the base 78 via pulleys 81a and 81b, a timing belt 81c, and a fastening portion 78a that fastens the base 78 and the timing belt 81c. A stapler shaft 83 including a drive transmission gear 83a is fixed to a bottom face of a stapling frame 62b that holds the components of the stapler 62.

The stapler shaft 83 and the drive transmission gear 83a are held by the base 78 on which the stapling frame 62b is disposed, so as to be rotatable in the forward and reverse directions. The drive transmission gear 83a meshes with an output gear 82a of a stapler pivot motor 82. The stapler 62 can be rotated in the forward and reverse directions about the stapler shaft 83 on the base 78 by a driving force transmitted from the stapler pivot motor 82 to the stapler shaft 83 via the output gear 82a and the drive transmission gear 83a.

The edge binder 25 and the staple binder 155 are supported by the common guide shaft 49. In other words, the edge-binder movement assembly 57 and the staple binder movement assembly 77 move the edge binder 25 and the staple binder 155 in the main scanning direction along the common guide shaft 49. The edge-binder movement assembly 57 and the staple binder movement assembly 77 can independently move the edge binder 25 and the staple binder 155.

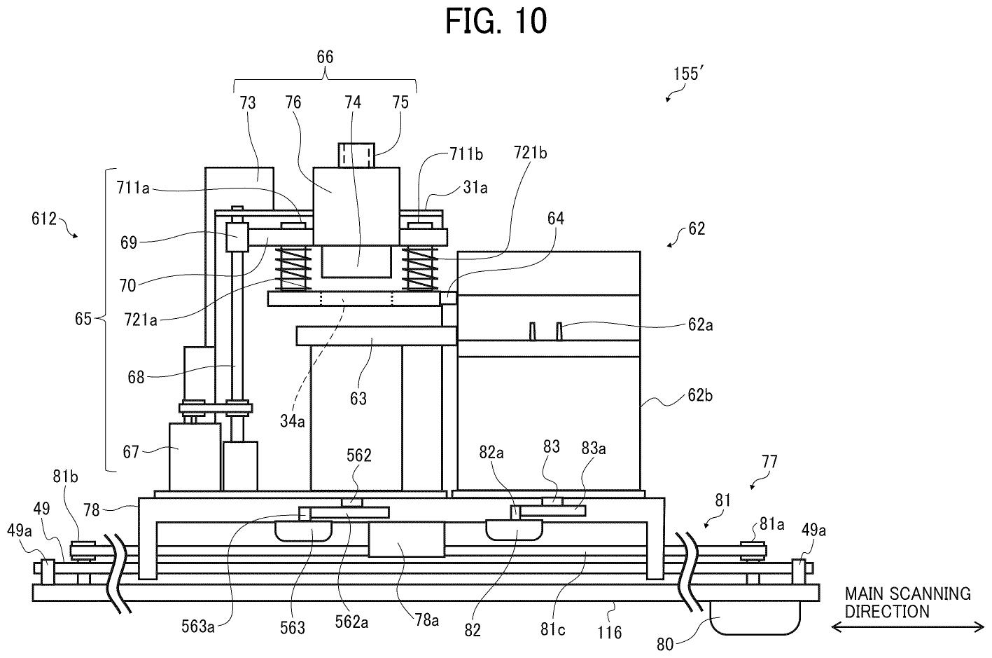

FIG. 10 illustrates a staple binder 155′ as a modification of the staple binder 155. Specifically, FIG. 10 is a view of an upstream side of the staple binder 155′ in the conveyance direction. The staple binder 155′ is different from the staple binder 155 in that the staple binder 155′ includes a second liquid applier 612 in addition to the stapler 62. As illustrated in FIG. 10, the staple binder 155′ includes the second liquid applier 612 and the stapler 62. The second liquid applier 612 and the stapler 62 are disposed downstream from the internal tray 22 in the conveyance direction and adjacent to each other in the main scanning direction.

The second liquid applier 612 performs the liquid application of applying liquid stored in a third liquid storage tank 73 to the sheet P or the sheet stack Pb placed on the internal tray 22. A given area including a position to which the liquid application is performed on the sheet P or the sheet bundle Pb by the second liquid applier 612 corresponds to a binding position to be stapled by the stapler 62. As illustrated in FIG. 10, the second liquid applier 612 includes a second lower pressure plate 63, a second upper pressure plate 64, a second liquid-applier movement assembly 65, and a second liquid application assembly 66. The second liquid-applier movement assembly 65 includes, for example, a second liquid-applier movement motor 67, a second trapezoidal screw 68, a second nut 69, a second base plate 70, second columns 711a and 711b, and second coil springs 721a and 721b.

The second liquid application assembly 66 includes the third liquid storage tank 73, a second liquid supply member 75, a second liquid application member 74, and a second joint 76. Since the second liquid application assembly 66 and the liquid application assembly of the liquid applier 31 (including the first liquid storage tank 44, the liquid supply member 50, the liquid application member 501, and the holder 37) illustrated in FIGS. 3 and 4 have common configurations, redundant descriptions thereof will be omitted unless otherwise required. Since the configuration of the stapler 62 illustrated in FIG. 9 is like the configuration of the stapler 62 illustrated in FIG. 7, a detailed description thereof is omitted below unless otherwise required. Since the second liquid applier 612 and the liquid applier 31 that are illustrated in FIG. 3 have common pivot mechanisms, redundant descriptions thereof will be omitted unless otherwise required. The pivot mechanism of the second liquid applier 612 includes a liquid-applier pivot motor 563, an output gear 563a, a drive transmission gear 562a, and a liquid applier shaft 562.

In the binding process, the staple binder 155′ that is illustrated in FIG. 10 performs the liquid application process on the sheet P to loosen and soften the binding position, allowing the staple to easily pass through the sheet bundle Pb. As a result, the number of sheets to be bound per sheet bundle Pb can be increased as compared with a case where the stapling process is performed without performing the liquid application.

A description is given below of a control block of the post-processing apparatus 3, with reference to FIG. 11.

FIG. 11 is a block diagram illustrating a hardware configuration for executing control processing in the post-processing apparatus 3. As illustrated in FIG. 11, the post-processing apparatus 3 includes a central processing unit (CPU) 101, a random-access memory (RAM) 102, a read-only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic device and controls the overall operation of the post-processing apparatus 3. The RAM 102 is a volatile storage medium that allows high speed reading and writing of data, and is used as a working area when the CPU 101 processes information. The ROM 103 is a read-only non-volatile storage medium, and stores programs such as firmware. The HDD 104 is a non-volatile storage medium that allows data to be read and written and has a relatively large storage capacity. The HDD 104 stores, for example, an operating system (OS), various control programs, and application programs.

By an arithmetic function of the CPU 101, the post-processing apparatus 3 processes, for example, a control program stored in the ROM 103 and an information processing program (application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, the HDD 104, and the I/F 105 constitute at least part of a controller 100b, which is an example of a control device, to control the operation of the post-processing apparatus 3.

The I/F 105 is an interface that connects the conveyance roller pairs 10, 11, 14, and 15, the switching member 20, the side fences 24L and 24R, the contact-separation motor 32d, the crimper pivot motor 56, the liquid-applier movement motor 42, the liquid-applier pivot motor 563, the edge-binder movement motor 55, the stapling-part drive motor 62d, the stapler pivot motor 82, the staple-binder movement motor 80, the liquid supply pump 46, the movement sensor 40a, the first liquid-level sensor 43, the second liquid-level sensor 94, the setting detection sensor 51, the standby position sensor 540, the encoder sensor 541, and an operation panel 110 to the common bus 109.

The controller 100b controls, via the I/F 105, the operations of the conveyance roller pairs 10, 11, 14, and 15, the switching member 20, the side fences 24L and 24R, the contact-separation motor 32d, the crimper pivot motor 56, the liquid-applier movement motor 42, the liquid-applier pivot motor 563, the edge-binder movement motor 55, the stapling-part drive motor 62d, the stapler pivot motor 82, the staple-binder movement motor 80, and the liquid supply pump 46. The controller 100b acquires detection results from the movement sensor 40a, the first liquid-level sensor 43, the second liquid-level sensor 94, the setting detection sensor 51, the standby position sensor 540, and the encoder sensor 541. Although FIG. 11 illustrates only the components related to the edge binder 25 and the staple binder 155 that perform the edge binding, the components related to the saddle binder 28 that performs the saddle binding are also controlled by the controller 100b.

As illustrated in FIG. 1, the image forming apparatus 2 includes the operation panel 110. The operation panel 110 includes an operation section that receives instructions input by an operator and a display (which is an example of a notifier) that notifies the operator of information. The operation section includes, for example, hard keys and a touch screen overlaid on the display. The operation panel 110 acquires information from the user through the operation section and provides information to the user through the display. A specific example of the notifier is not limited to the display and may be a light-emitting diode (LED) lamp or a speaker. The post-processing apparatus 3 may include an operation panel 110 similar to the above-described operation panel 110 of the image forming apparatus 2.

As described above, the post-processing apparatus 3 implements the function of performing operation control related to the liquid application by software (control programs) executed by the CPU 101 with hardware resources included in the controller 100b.

The liquid application performed by the post-processing apparatus 3 may be performed in a form in which the staple binder 155 is provided with only the stapler 62 and the liquid application is performed using the liquid applier 31 of the edge binder 25. By contrast, the edge binder 25 may include only the crimper 32, and the liquid application may be performed in a mode in which the second liquid applier 612 is used. In other words, the post-processing apparatus 3 may have a configuration in which only one of the liquid applier 31 and the second liquid applier 612 performs the liquid application, regardless of the type of the binding process.

In the above description, the staple binder 155′ has a configuration of moving along the guide shaft 49 with the stapler 62 and the second liquid applier 612 being integrated, the embodiments of the present disclosure are not limited to the above-described configuration. For example, the stapler 62 and the second liquid applier 612 may have a configuration of moving separately from each other.

A description is given below of a binding process.

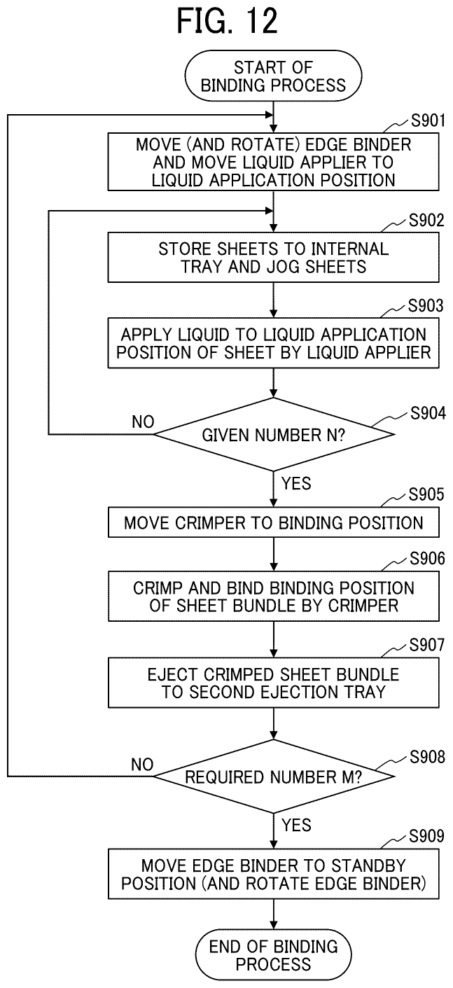

Specifically, a description is given below of a binding process executed by the edge binder 25 included in the post-processing apparatus 3. FIG. 12 is a flowchart of a process of a one-point binding performed by the edge binder 25. FIGS. 13A, 13B, and 13C are diagrams each illustrating the positions of the edge binder 25 (the liquid applier 31 and the crimper 32) during the one-point binding. FIGS. 13A, 13B, and 13C do not illustrate changes in the postures of the liquid applier 31 and the crimper 32. The position (liquid application position) to which liquid is applied on a sheet P or a sheet bundle Pb by the liquid applier 31 corresponds to the binding position on the sheet bundle Pb to be crimped by the crimper 32. For this reason, in the following description, the liquid application position and the binding position are denoted by the same reference sign (B1 or B2).

For example, the controller 100b starts the binding process illustrated in FIG. 12 when the controller 100b acquires an execution command of the binding process from the image forming apparatus 2. In the following description, the execution command of the binding process may be referred to as a “binding command.”

The binding command includes, for example, the type of the sheet P (i.e., information affecting the spread of liquid, such as material and thickness), the number of sheets P of the sheet bundle Pb, the number of sheet bundles Pb to be bound, the binding position on the sheet bundle Pb, and the binding posture of the edge binder 25. In the following description, the number of sheets P of the sheet bundle Pb may be referred to as “given number N” whereas the number of sheet bundles Pb to be bound may be referred to as “requested number M of copies.” The liquid applier 31 and the crimper 32 are assumed to be in a parallel binding posture and located at a standby position HP (FIG. 13A) that is a position shifted in the width direction from the sheets P placed on the internal tray 22 at the start of the binding process.

When the posture that is instructed by the binding command is the “oblique binding posture,” in step S901, the controller 100b drives the liquid-applier pivot motor 563 and the crimper pivot motor 56 to rotate the liquid applier 31 and the crimper 32 of the edge binder 25 into the oblique binding posture. Alternatively, when the posture that is instructed by the binding command is the “oblique binding posture,” only the crimper 32 may be rotated to the oblique binding posture while the liquid applier 31 may not be rotated. Such a configuration can simplify the drive mechanism as compared with a configuration in which both the liquid applier 31 and the crimper 32 are rotated in the forward and reverse directions. Thus, the effects of cost reduction, the downsizing of the apparatus, and the reduction of a failure of devices are obtained.

On the other hand, when the posture that is instructed by the binding command is the “parallel binding posture,” the controller 100b omits the aforementioned operation of rotating the liquid applier 31 and the crimper 32 of the edge binder 25 to the oblique binding posture.

In step S901, the controller 100b drives the edge-binder movement motor 55 to move the edge binder 25 in the main scanning direction so that the liquid applier 31 faces the first liquid application position B1 instructed by the binding command. The controller 100b executes the operation of step S901 before a first sheet P is conveyed to the internal tray 22 by the conveyance roller pairs 10, 11, 14, and 15.

In step S902, the controller 100b rotates the conveyance roller pairs 10, 11, 14, and 15 to store the sheet P, on which the image has been formed by the image forming apparatus 2, onto the internal tray 22. In step S902, the controller 100b also moves the side fences 24L and 24R to align the position of the sheet P or the sheet bundle Pb placed on the internal tray 22 in the main scanning direction. In short, the controller 100b performs so-called jogging to the sheet P or the sheet bundle Pb.

In step S903, the controller 100b causes the liquid applier 31 facing the first liquid application position B1 to apply liquid to the first liquid application position B1 of the sheet P placed on the internal tray 22 in the immediately preceding step S902, based on the liquid application control data adjusted in advance. In other words, the controller 100b drives the liquid-applier movement motor 42 to bring the liquid application member 501 into contact with the liquid application position B1 on the sheet P placed on the internal tray 22 (see FIG. 13B). In the liquid application process in step S903, the controller 100b adjusts the position at which the liquid application member 501 applies liquid to the sheet P in accordance with the type of the sheet P and the binding position included in the binding command. The controller 100b adjusts the amount of pressing the liquid application member 501 against the sheet P. In other words, the controller 100b controls the driving of the liquid-applier movement motor 42 based on the adjusted control data, and adjusts the amount of movement of the liquid application member 501 with respect to the first liquid application position B1 of the sheet P placed on the internal tray 22.

In step S904, the controller 100b determines whether the number of sheets P placed on the internal tray 22 has reached the given number N instructed by the binding command. When the controller 100b determines that the number of sheets P placed on the internal tray 22 has not reached the given number of sheets N (NO in step S904), the controller 100b executes the operations of steps S902 to S904 again until the number of sheets P placed on the internal tray 22 reaches the given number of sheets N (YES in step S904). In other words, the controller 100b executes the processing of steps S902 to S904 each time the sheet P is conveyed to the internal tray 22 by the conveyance roller pairs 10, 11, 14, and 15. The liquid application by the liquid applier 31 may be performed on each of the sheets P of the sheet bundle Pb.

When the controller 100b determines that the number of sheets P placed on the internal tray 22 has reached the given number of sheets N (YES in step S904), in step S905, the controller 100b drives the edge-binder movement motor 55 to move the edge binder 25 in the main scanning direction such that the crimper 32 faces the first binding position B1 as illustrated in FIG. 13C.

In step S906, the controller 100b causes the crimper 32 to crimp the sheet bundle Pb placed on the internal tray 22. In step S907, the controller 100b causes the conveyance roller pair 15 to eject the sheet bundle Pb thus crimped and bound by the crimper 32 to the second ejection tray 26. Specifically, the controller 100b drives the contact-separation motor 32d to cause the upper crimping teeth 32a and the lower crimping teeth 32b to pinch the first binding position B1 on the sheet bundle Pb placed on the internal tray 22. The sheet bundle Pb is pressed and deformed between the upper crimping teeth 32a and the lower crimping teeth 32b, and thus the sheet bundle Pb is crimped. Then, the controller 100b rotates the conveyance roller pair 15 to eject the sheet bundle Pb thus crimped and bound to the second ejection tray 26.

The sheet bundle Pb that is placed on the internal tray 22 has a crimping area (corresponding to the first binding position B1) sandwiched between the upper crimping teeth 32a and the lower crimping teeth 32b in step S906. The crimping area overlaps a liquid application area (corresponding to the first liquid application position B1) contacted by the end of the liquid application member 501 in step S903. In other words, the crimper 32 crimps an area to which liquid is applied by the liquid applier 31 on the sheet bundle Pb placed on the internal tray 22. The crimping area that is pinched by the upper crimping teeth 32a and the lower crimping teeth 32b may completely or partially overlap with the liquid application area contacted by the distal end of the liquid application member 501, to obtain a sufficient binding strength.

The controller 100b determines whether the number of sheet bundles Pb thus ejected to the second ejection tray 26 has reached the requested number of copies M indicated by the binding command (step S908). When the controller 100b determines that the number of sheet bundles Pb thus ejected has not reached the requested number of copies M (NO in step S908), the controller 100b executes the operations of step S901 and the following steps again. In other words, when the controller 100b determines that the number of sheet stacks Pb thus ejected has not reached the requested number of copies M (NO in step S908), the controller 100b repeats the operations of steps S901 to S908 until the number of sheet stacks Pb ejected to the second ejection tray 26 reaches the requested number of copies M.

On the other hand, when the controller 100b determines that the number of sheet bundles Pb output to the second ejection tray 26 has reached the requested number of copies M (YES in step S908), in step S909, the controller 100b drives the edge-binder movement motor 55 to move the edge binder 25 (the liquid applier 31 and the crimper 32) to the standby position HP as illustrated in FIG. 13A. When the posture that is instructed by the binding command is the “oblique binding posture,” in step S909, the controller 100b drives the liquid-applier pivot motor 563 and the crimper pivot motor 56 to rotate the liquid applier 31 and the crimper 32 into the parallel binding posture. On the other hand, when the posture that is instructed by the binding command is the “parallel binding posture,” the controller 100b skips the aforementioned operation of rotating the liquid applier 31 and the crimper 32 to the parallel binding posture. As a result, the edge binder 25 (the liquid applier 31 and the crimper 32) returns to the standby position HP position illustrated in FIG. 13A. In steps S901 and S909, the execution order of the movement in the main scanning direction and the rotation in the forward and reverse directions of the liquid applier 31 and the crimper 32 is not limited to the aforementioned order and may be reversed.

A detailed description is given below of a second liquid storage tank 47 according to an embodiment of the present disclosure.

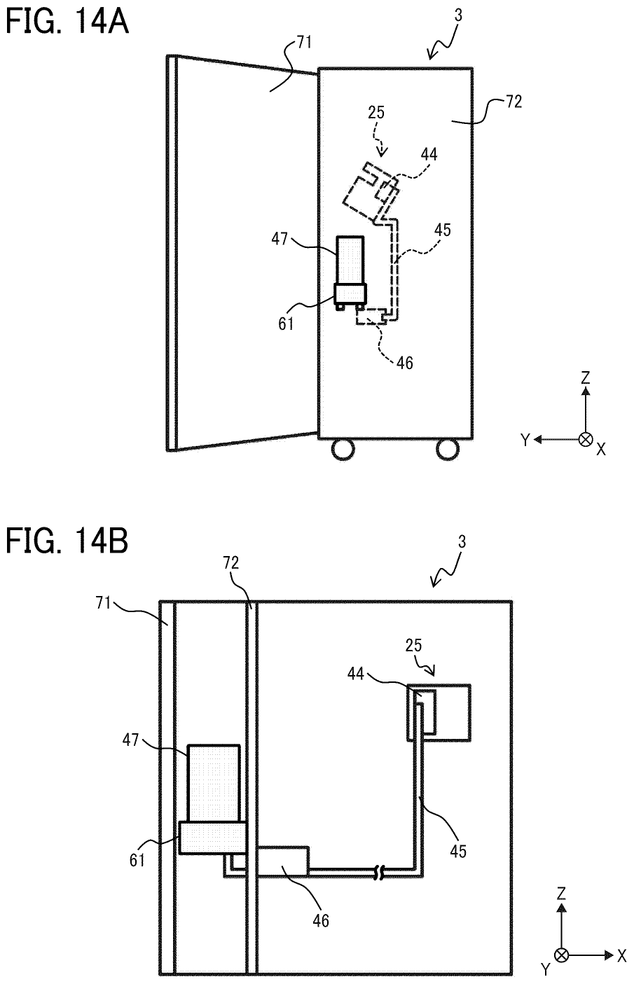

Referring now to FIGS. 14A, 14B, and 15, a description is given of the arrangement and configuration of the second liquid storage tank 47 in the post-processing apparatus 3. FIGS. 14A and 14B illustrate an example of the location and configuration of the second liquid storage tank 47 as the main tank. FIG. 14A illustrates a state where an opening-and-closing cover 71 constituting part of an apparatus housing of the post-processing apparatus 3 is opened. FIG. 14B is a cross-sectional side view of the post-processing apparatus 3, illustrating the post-processing apparatus 3 with the cover 71 closed. As illustrated in FIG. 14A, the second liquid storage tank 47 is located so as to be accessible when the cover 71 of the post-processing apparatus 3 is opened. As illustrated in FIG. 14B, the second liquid storage tank 47 and the second-liquid-storage-tank fixer 61 are disposed on the near side in a depth direction (X direction) of the post-processing apparatus 3. The first liquid storage tank 44 is disposed on the far side in the depth direction (X direction) of the post-processing apparatus 3. A housing side plate 72 of the post-processing apparatus 3 is disposed between the location of the second liquid storage tank 47 and the second-liquid-storage-tank fixer 61 and the location of the first liquid storage tank 44 and so forth. The second-liquid-storage-tank fixer 61 is attached to the housing side plate 72 of the post-processing apparatus 3. The housing side plate 72 is a part of the apparatus housing and corresponds to a portion at which a locking hole (engaged portion) of a locking mechanism described later is formed.

FIG. 15 illustrates a state in which the second liquid storage tank 47 is attachable to and detachable from the second-liquid-storage-tank fixer 61 and a state in which liquid Lis replenished to the second liquid storage tank 47. As illustrated in FIG. 15A, the second liquid storage tank 47 is detachably attached to the first liquid storage tank 44 so that the second liquid storage tank 47 can replenish the liquid to the first liquid storage tank 44. As illustrated in part (B) of FIG. 15, the second-liquid-storage-tank fixer 61 is provided with the setting detection sensor 51 serving as a setting detector that detects that the second liquid storage tank 47 is set on the second-liquid-storage-tank fixer 61.

When the setting detection sensor 51 detects the set state of the second liquid storage tank 47 to the second-liquid-storage-tank fixer 61 (see part (C) of FIG. 15), a signal indicating the set state is transmitted to the controller 100b. Thus, the controller 100b detects whether the second liquid storage tank 47 is set on the second-liquid-storage-tank fixer 61.

The second liquid-level sensor 94 (a second liquid detector) that detects the amount (liquid level) of liquid L stored in the second liquid storage tank 47 is disposed in the second-liquid-storage-tank fixer 61. The output value (voltage) of the second liquid-level sensor 94 is notified to the controller 100b. The controller 100b determines the output value (voltage) of the second liquid-level sensor 94 to determine whether the amount of liquid stored in the second-liquid-storage-tank fixer 61 is a required amount of liquid. When the controller 100b determines that the second liquid storage tank 47 is set on the second-liquid-storage-tank fixer 61 (i.e., is in a set state) based on the output signal of the setting detection sensor 51, the controller 100b turns on the second liquid-level sensor 94 such that the remaining amount of liquid (the amount of the liquid stored) in the second-liquid-storage-tank fixer 61 can be detected.

When the second liquid storage tank 47 is not set on the second-liquid-storage-tank fixer 61 (i.e., is in a non-set state), an outlet of the second liquid storage tank 47 is closed by a liquid supply valve 471 so that the liquid does not leak. As illustrated in part (C) of FIG. 15, when the second liquid storage tank 47 is set to the second-liquid-storage-tank fixer 61, the liquid supply valve 471 is pushed up to open a liquid discharge port 471a of the second liquid storage tank 47. Thus, the liquid L can flow out from the second liquid storage tank 47 to the second-liquid-storage-tank fixer 61. As a result, the liquid L stored in the second liquid storage tank 47 flows out to the second-liquid-storage-tank fixer 61. The liquid L that has flowed out from the second liquid storage tank 47 is stored in the second-liquid-storage-tank fixer 61.

As a measurement to prevent the liquid from being frozen during maintenance of the post-processing apparatus 3, a liquid draining process may be performed to drain the liquid in the post-processing apparatus 3. In the liquid draining process, the liquid L remaining in the first liquid storage tank 44 and the liquid supply passage 45 is supplied by the liquid supply pump 46 to the second-liquid-storage-tank fixer 61 via the liquid supply passage 45 in the reverse direction. For that purpose, the second-liquid-storage-tank fixer 61 is set to the capacity that can sufficiently store liquid L in the first liquid storage tank 44 and the liquid supply passage 45. The second-liquid-storage-tank fixer 61 has a liquid drain plug 611. After the liquid L remaining in the first liquid storage tank 44 and the liquid supply passage 45 is reversely fed by the liquid supply pump 46 to the second-liquid-storage-tank fixer 61, the liquid drain plug 611 is opened to drain the liquid stored in the second-liquid-storage-tank fixer 61 from the inside of the post-processing apparatus 3.

A description is given below of a liquid supply/discharge operation in the liquid applier 31.

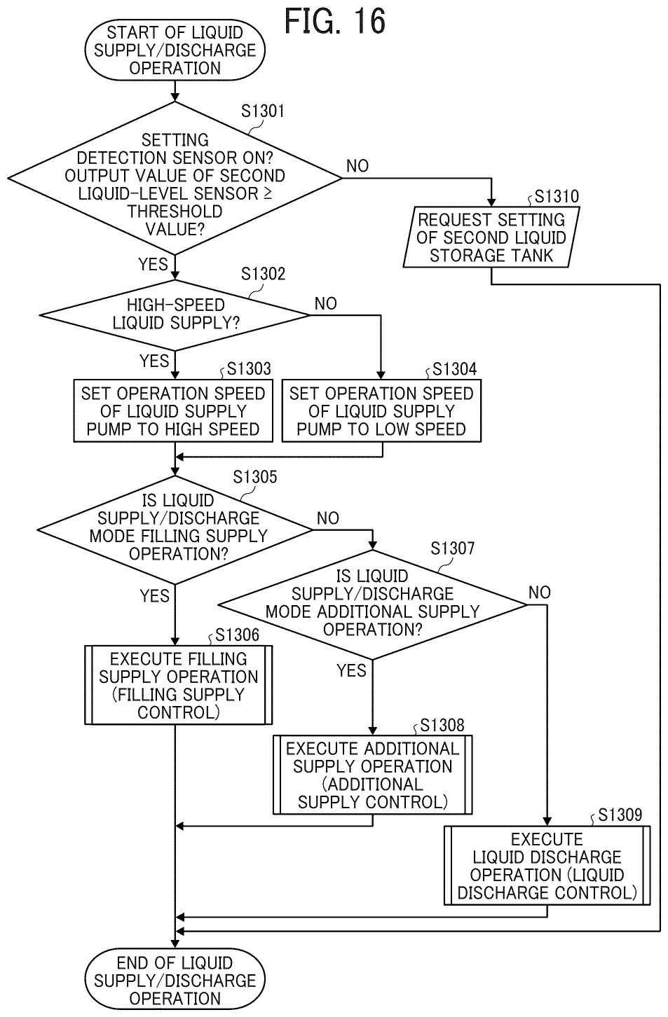

FIG. 16 is a flowchart of an example of the control process of the liquid supply/discharge operation (referred to as the “liquid supply/discharge operation process” in the following description) in the liquid applier 31 of the edge binder 25, which is executed in the controller 100b. In the following description, the term “liquid supply/discharge operation” means that liquid used for liquid application is transferred between the second liquid storage tank 47 and the first liquid storage tank 44 by the liquid supply pump 46. In other words, the term “liquid supply/discharge operation” includes both an operation of supplying (replenishing) liquid from the second liquid storage tank 47 to the first liquid storage tank 44 by the liquid supply pump 46 and an operation of feeding (discharging) liquid from the first liquid storage tank 44 to the second liquid storage tank 47 by the liquid supply pump 46.

First, when the liquid supply/discharge operation process is started, as illustrated in FIG. 15, in step S1301, the controller 100b determines whether the detachable second liquid storage tank 47 is set on the second-liquid-storage-tank fixer 61 (i.e., the setting detection sensor 51 is in ON state) and whether the liquid Lis sufficiently stored in the second-liquid-storage-tank fixer 61 (the output value of the second liquid-level sensor 94 is equal to or greater than the threshold). When the controller 100b determines that the second liquid storage tank 47 is not properly set (the setting detection sensor 51 is in OFF state) and the second-liquid-storage-tank fixer 61 does not store sufficient liquid L (the output value of the second liquid-level sensor 94 is less than the threshold) (NO in step S1301), in step S1310, the controller 100b outputs a request for setting the second liquid storage tank 47 via the operation panel 110 and ends the liquid supply/discharge operation process, since there is a possibility that liquid supply from the second liquid storage tank 47 to the first liquid storage tank 44 by the liquid supply pump 46 may not be normally performed due to lack of liquid in the second-liquid-storage-tank fixer 61.

On the other hand, when the second liquid storage tank 47 is set (the setting detection sensor 51 is in an ON state) and the liquid L is sufficiently stored in the second-liquid-storage-tank fixer 61 (the output value of the second liquid-level sensor 94 is equal to or more than the threshold) (YES in step S1301), the controller 100b subsequently sets the operation mode of the liquid supply pump 46.

The liquid supply pump 46 can change a liquid supply speed (a liquid supply mode). The liquid supply speed is changed by selecting and setting one of a plurality of operation modes. The plurality of liquid supply modes of the liquid supply pump 46 are, for example, a “high-speed liquid supply mode” and a “low-speed liquid supply mode”.

In step S1302, the controller 100b determines whether the high-speed liquid supply is performed by the liquid supply pump 46, that is, whether the high-speed liquid supply mode is set. When the controller 100b determines in step S1302 that high-speed liquid supply is to be performed (YES in step S1302), the controller 100b sets the operation speed of the liquid supply pump 46 to high speed (step S1303). The high-speed liquid supply mode is set, for example, in a case where liquid is supplied from the second liquid storage tank 47 to the first liquid storage tank 44 by the liquid supply pump 46 when the liquid stored in the first liquid storage tank 44 is empty. In such a case, it takes time to complete the supply of the liquid into the first liquid storage tank 44, and therefore the controller 100b sets the liquid supply speed of the liquid supply pump 46 (the liquid-supply-pump operation speed) to high speed in order to shorten the time for supplying the liquid into the first liquid storage tank 44.

On the other hand, when the controller 100b determines in step S1302 that the high-speed liquid supply is not to be performed, that is, the low-speed liquid supply mode is set (NO in step S1302), in step S1304, the controller 100b sets the operation speed of the liquid supply pump 46 to low speed. For example, in a case where an amount of liquid stored in the first liquid storage tank 44 has been consumed by the liquid applying operation of the liquid applier 31, liquid is supplied from the second liquid storage tank 47 to the first liquid storage tank 44 by the liquid supply pump 46 by an amount corresponding to the consumed amount of liquid, which is an example of the case when the low-speed liquid supply mode is set. In such a case, a small amount of liquid is to be supplied, and therefore, if the liquid is supplied at a high speed, there is a possibility that the liquid overflows from the first liquid storage tank 44 due to excessive supply. Since such side effects are conceivable, there are cases where it is desirable to set the liquid supply speed of the liquid supply pump 46 (the liquid-supply-pump operation speed) to low speed.

As a premise of the processing of determination in step S1302, a user may be allowed to select a setting of the liquid supply speed of the liquid supply pump 46 via the operation panel 110. In addition, the liquid supply speeds of the liquid supply pump 46 corresponding to liquid supply/discharge modes such as a “filling supply operation” and a “additional supply operation”, which will be described later, may be set such that the supply speed of the liquid supply pump 46 corresponding to each liquid supply/discharge mode may be automatically selected according to the selection of each liquid supply/discharge mode in the controller 100b.

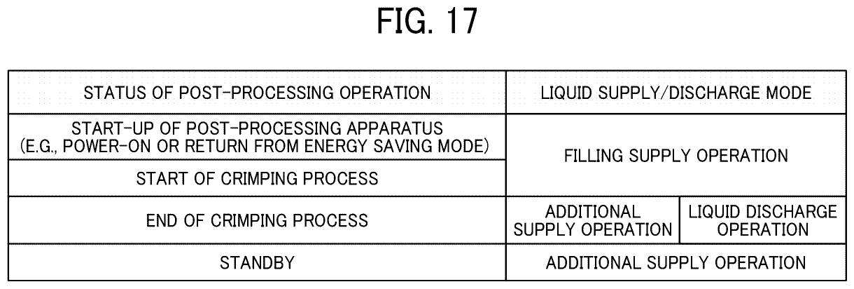

Subsequently, in step S1305, the controller 100b determines the liquid supply/discharge mode. The determination of the liquid supply/discharge mode is performed based on, for example, the operation status of the post-processing apparatus 3 (“post-processing operation status”) illustrated in FIG. 17 described later and/or the result of user's input to the selection input screen of the liquid supply/discharge mode illustrated in FIG. 25.

First, in step S1305, the controller 100b determines whether the liquid supply/discharge mode is the “filling supply operation.” When the liquid supply/discharge mode is the “filling supply operation” according to the determination of step S1305 (YES in step S1305), the controller 100b causes the liquid applier 31 to execute the “filling supply operation” described later (step S1306) and ends the liquid supply/discharge operation process. On the other hand, when the determination result of step S1305 indicates that the liquid supply/discharge mode is not the “filling supply operation” (NO in step S1305), in step S1307, the controller 100b determines whether the liquid supply/discharge mode is the “additional supplying operation.”

When the liquid supply/discharge mode is the “additional supply operation” according to the determination of step S1307 (YES in step S1307), the controller 100b causes the liquid applier 31 to execute the “additional supply operation” in step S1308, and ends the liquid supply/discharge operation process. On the other hand, when the determination result of the step S1307 indicates that the liquid supply/discharge mode is not the “additional supply operation” (NO in step S1307), the controller 100b determines that the liquid supply/discharge mode is the “liquid discharge operation”, and causes the liquid applier 31 to execute a “liquid discharge operation” to be described later (step S1309), and ends the liquid supply/discharge operation flow.

Details of “filling supply control,” “additional supply control,” and “liquid discharge control” as controls corresponding to the liquid supply/discharge modes (the liquid supply/discharge operations described above) selected based on the determination results of step S1305 and step S1307 will be described later.

A description is given below of a control method for selecting, in a case where an operation executable by the post-processing apparatus 3, for example, the crimp binding process accompanied by liquid application is performed by the crimper 32, a liquid supply/discharge mode optimum for each step of the crimp binding process accompanied by liquid application from a plurality of liquid supply/discharge modes set corresponding to a plurality of steps of the crimp binding process accompanied by liquid application.

FIG. 17 illustrates correspondence between the operation status of the post-processing apparatus 3 (referred to as a “post-processing operation status” in the following description) and the liquid supply/discharge mode selected correspondingly when the post-processing apparatus 3 performs the liquid supply/discharge operation.

For example, the “post-processing operation status” is classified into, e.g., “activation of post-processing apparatus” (such as when the post-processing apparatus 3 is turned on or returns from an energy saving mode) that corresponds to the time of activation of the post-processing apparatus 3, “start of crimp binding process”, “end of crimp binding process”, and “standby”.

The term “crimp binding process” in the above-described “start of crimp binding process” and “end of crimp binding process” is a crimp binding process involving application of liquid.

The “filling supply operation” is selected as the liquid supply/discharge mode at a timing when the crimp binding process is started in the post-processing apparatus 3, such as “activation of the post-processing apparatus” or “start of the crimp binding process.” For example, when the number of times of execution of crimp binding process accompanied by liquid application is large and it is desired to shorten a wait time until a state in which liquid application is executable is achieved, the filling supply operation is also executed at the time of activation of the post-processing apparatus 3. Furthermore, in a case where the frequency of execution of the crimp binding process accompanied by liquid application is low and it is desired to prevent, for example, evaporation of the liquid while the edge binder 25 is not operating, the filling supply operation is executed each time the crimp binding process accompanied by liquid application is started.

The “additional supply operation” is selected as the liquid supply/discharge mode, for example, at the time of “end of crimp binding process” or “standby.” For example, at the end of the crimp binding process accompanied by liquid application, the additional supply operation is executed for the liquid application in the next crimp binding process accompanied by liquid application. The additional supply operation is an operation executed for the purpose of supplying (replenishing), into the first liquid storage tank 44, an amount of liquid equivalent to the amount consumed by the liquid application in the ended crimp binding process accompanied by liquid application. The additional supply operation is also executed in a case where a wait time until a start of liquid application in the next crimp binding process accompanied by liquid application is shortened. Furthermore, in a case where the liquid in the first liquid storage tank 44 evaporates due to the post-processing apparatus 3 continuing the standby state for a predetermined time, the additional supply operation is also executed in order to supply (replenish) the first liquid storage tank 44 with an amount of liquid decreased by the evaporation.

In addition to the above-described method, a user may select the liquid supply/discharge mode via the operation panel 110 of at least one of the image forming apparatus 2 and the post-processing apparatus 3 so that the above-described filling supply operation and additional supply operation can be manually selected for execution.

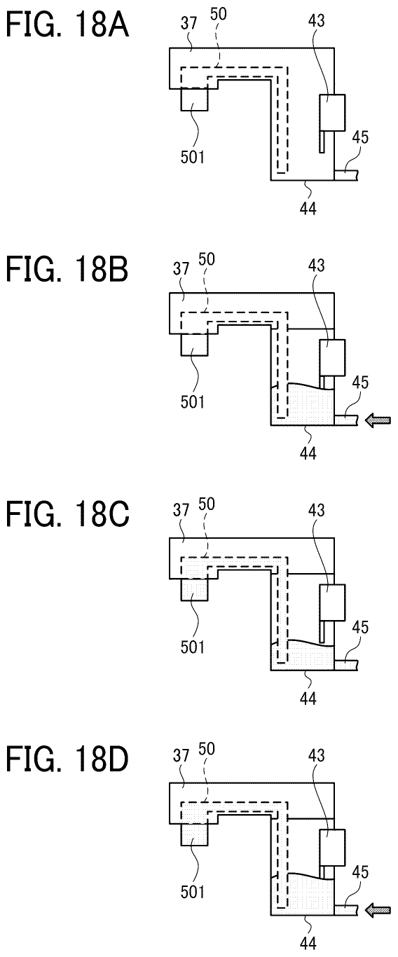

A description is given below of an outline of a filling supply operation that is one of the liquid supply/discharge modes with reference to FIGS. 18A, 18B, 18C, and 18D.

FIG. 18A illustrates an example of an empty state of liquid in the first liquid storage tank 44. From this state, liquid is supplied from the second liquid storage tank 47 to the first liquid storage tank 44 by the liquid supply pump 46 until a state as illustrated in FIG. 18B. At this time, liquid is supplied from the second liquid storage tank 47 to the first liquid storage tank 44 by the liquid supply pump 46 until the first liquid-level sensor 43 detects liquid in the first liquid storage tank 44. The liquid level (the amount of liquid stored in the first liquid storage tank 44) detected when the first liquid-level sensor 43 detects the liquid in the first liquid storage tank 44 is referred to as a “reference liquid level.”

Then, the liquid stored in the first liquid storage tank 44 is sucked up by the action of capillary phenomenon of the liquid supply member 50. As a result, the level of the liquid stored in the first liquid storage tank 44 decreases to a level lower than the reference liquid level (see FIG. 18C). When the liquid level of the liquid stored in the first liquid storage tank 44 decreases, in order to return the liquid level of the liquid stored in the first liquid storage tank 44 to the reference liquid level, an operation of supplying liquid from the second liquid storage tank 47 to the first liquid storage tank 44 is performed again by the liquid supply pump 46 as necessary (see FIG. 18D).

In the present embodiment, the electrode sensor has been described as an example of the first liquid-level sensor 43. However, the first liquid detector is not limited to the electrode sensor and may be other types of sensors. For example, a float sensor or a capacitance sensor may be used to detect the presence of the liquid. Further, the first liquid-level sensor 43 is not limited to a sensor that detects the liquid level (liquid surface) of the liquid in the first liquid storage tank 44, and may be any sensor that detects the presence or absence of the liquid in the first liquid storage tank 44 (the amount of the liquid stored) to detect the liquid level (liquid surface).

In a case where an electrode sensor is used as the first liquid-level sensor 43, there is a concern that the metal used for the electrodes might be corroded due to electrolytic corrosion if the pair of electrodes is energized (applied with electricity) constantly. Further, since the voltage is always applied to the liquid stored in the first liquid storage tank 44, there is a concern that the liquid might be electrolyzed or that the electrodes might be dissolved due to adhesion of foreign matter to the surface of the electrodes by electrolysis, which might induce deterioration of the electrodes. For this reason, the controller 100b controls the timing of energization of the first liquid-level sensor 43 such that the first liquid-level sensor 43 is not energized all the time but is energized (energized ON) only when the first liquid-level sensor 43 detects the stored liquid amount (liquid level) of liquid stored in the first liquid storage tank 44.

A description is given below of a control process of the filling supply operation.

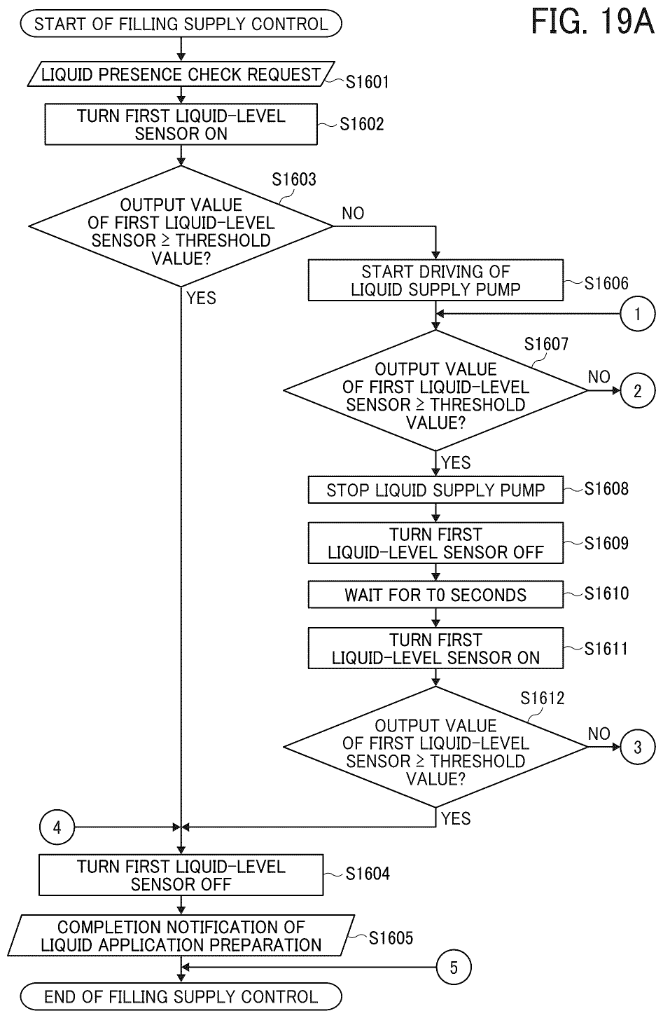

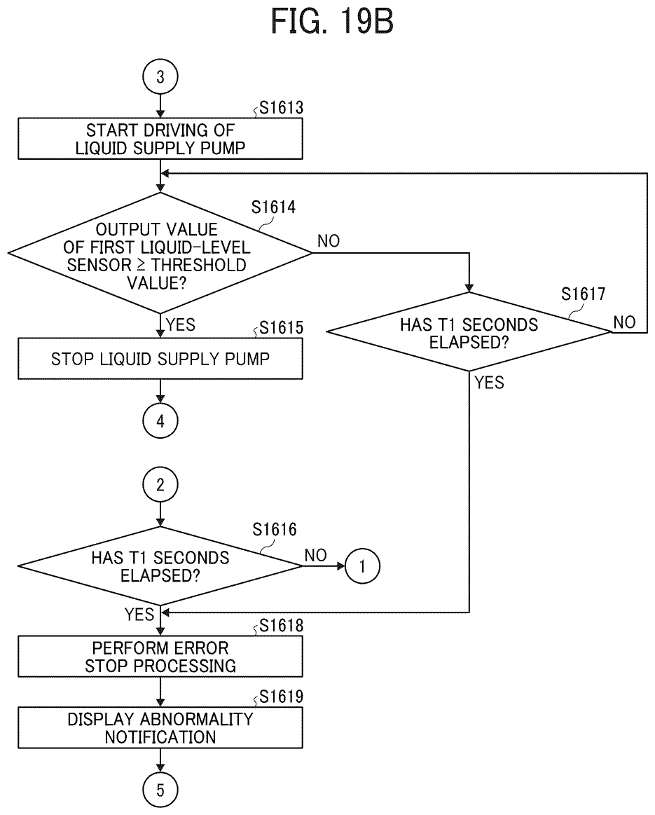

FIGS. 19A and 19B are flowcharts of a control process of a filling supply operation which is an example of a liquid supply operation executed in the controller 100b. The control process is referred to as a “filling supply control process” in the following description. As illustrated in FIG. 17, the filling supply operation is executed at an activation of the post-processing apparatus 3 or a start of a crimp binding process accompanied by liquid application.

When the post-processing apparatus 3 is activated, the filling supply control process is started. When the filling supply control process is started, in step S1601, a liquid presence check request is instructed from the image forming apparatus 2 to the controller 100b. The liquid presence check request may be instructed based on information input by the user from the operation panel 110 of one or both of the image forming apparatus 2 and the post-processing apparatus 3. In response to receipt of the liquid presence check request instructed from the image forming apparatus 2, in step S1602, the controller 100b applies a voltage to the first liquid-level sensor 43 (turns on energization).

Subsequently, in step S1603, the controller 100b acquires an output value (voltage) that is output when the first liquid-level sensor 43 detects liquid in the first liquid storage tank 44, and determines the presence (the stored liquid amount) of liquid in the first liquid storage tank 44. The determination of the presence of liquid (the stored liquid amount) in the first liquid storage tank 44 is performed based on whether the output value (voltage) from the first liquid-level sensor 43 exceeds a “liquid detection threshold” (threshold) set in advance. For example, when the output value (voltage) from the first liquid-level sensor 43 is equal to or greater than the liquid detection threshold (e.g., output voltage V1), the controller 100b determines that the amount of liquid stored in the first liquid storage tank 44 is a sufficient amount (YES in step S1603). In this case, the controller 100b stops the application of the voltage to the first liquid-level sensor 43 (turns the energization of the first liquid-level sensor 43 off) in step S1604, displays a completion notification of the preparation for liquid application on, for example, the operation panel 110 in step S1605, and ends the filling supply control process.

On the other hand, when the output value (voltage) from the first liquid-level sensor 43 is less than the liquid detection threshold (e.g., the output voltage V1) in step S1603 (NO in step S1603), in step S1606, the controller 100b operates the liquid supply pump 46 to execute the supply of the liquid from the second liquid storage tank 47 to the first liquid storage tank 44.

Subsequently, in step S1607, the controller 100b determines whether the output value (voltage) from the first liquid-level sensor 43 is equal to or greater than the “liquid detection threshold” (threshold) set in advance. When the output value (voltage) from the first liquid-level sensor 43 is equal to or greater than the liquid detection threshold (e.g., the output voltage V1), the controller 100b determines that a sufficient amount of liquid has been supplied from the second liquid storage tank 47 into the first liquid storage tank 44 by the liquid supply pump 46 (YES in step S1607). On the other hand, when the output value from the first liquid-level sensor 43 is less than the liquid detection threshold (e.g., the output voltage V1) (NO in step S1607), in step S1616, the controller 100b determines whether an elapsed time from the start of the operation of the liquid supply pump 46 (in step S1606) has reached an abnormality determination time (T1 seconds (sec)). When the elapsed time has not reached the abnormality determination time T1 (NO in step S1616), the controller 100b continues the supply of the liquid from the second liquid storage tank 47 to the first liquid storage tank 44 by the liquid supply pump 46 until the output value (voltage) from the first liquid-level sensor 43 becomes equal to or greater than the liquid detection threshold (e.g., output voltage V1) (YES in step S1607).

On the other hand, when the elapsed time has reached the abnormality determination time T1 (YES in step S1616), in step S1618, the controller 100b determines that some abnormality (such as a failure of the liquid supply pump 46 and/or the first liquid-level sensor 43) has occurred in a device, and executes an error stop process of stopping the liquid supply pump 46 and/or turning off the energization of the first liquid-level sensor 43. In step S1619, the controller 100b causes the operation panel 110 to display an abnormality notification, and ends the filling supply control process.

When the output value (voltage) from the first liquid-level sensor 43 becomes equal to or greater than the liquid detection threshold (e.g., output voltage V1) in step S1607 (YES in step S1607), in step S1608, the controller 100b stops the liquid supply pump 46 and stops the supply of liquid from the second liquid storage tank 47 to the first liquid storage tank 44. In step S1609, the controller 100b stops the application of voltage to the first liquid-level sensor 43 (turns off the energization).

Then, in step S1610, the filling supply control process is temporarily stopped until a standby time (first predetermined time TO seconds) elapses. The standby time is set in advance as a time taken until liquid in the first liquid storage tank 44 is sucked up by, e.g., capillary phenomenon and the liquid supply member 50 turns to an executable state for liquid application (a state where the liquid is sufficiently stored in at least one of the liquid application member 501 and the liquid supply member 50).

After the first predetermined time TO has elapsed, the controller 100b turns on the energization of the first liquid-level sensor 43 again (in step S1611), acquires an output value (voltage) that is output when the first liquid-level sensor 43 detects the liquid in the first liquid storage tank 44, and determines the presence (the stored liquid amount) of liquid in the first liquid storage tank 44 (in step S1612). At this stage, the liquid level (stored liquid amount) of liquid in the first liquid storage tank 44 decreases due to the sucking-up of the liquid supply member 50. However, when the output value (voltage) from the first liquid-level sensor 43 is equal to or greater than the liquid detection threshold (e.g., the output voltage V1) (YES in step S1612), in step S1604, the controller 100b stops the application of the voltage to the first liquid-level sensor 43 (i.e., turns off the energization). In step S1605, the controller 100b displays a completion notification of the preparation for liquid application on, for example, the operation panel 110, and ends the filling supply control process.

On the other hand, when the output value (voltage) from the first liquid-level sensor 43 is less than the liquid detection threshold (e.g., the output voltage V1) in step S1612 (NO in step S1612), in step S1613, the controller 100b operates the liquid supply pump 46 to execute the supply of the liquid from the second liquid storage tank 47 to the first liquid storage tank 44.

Subsequently, in step S1614, the controller 100b acquires an output value (voltage) that is output when the first liquid-level sensor 43 detects liquid in the first liquid storage tank 44, and determines the presence (the stored liquid amount) of liquid in the first liquid storage tank 44. Subsequently, when the output value (voltage) from the first liquid-level sensor 43 is equal to or greater than the liquid detection threshold (e.g., the output voltage V1) (YES in step S1614), the controller 100b determines that a sufficient amount of liquid has been supplied into the first liquid storage tank 44. In this case, in step S1615, the controller 100b stops the liquid supply pump 46 to stop the supply of liquid from the second liquid storage tank 47 to the first liquid storage tank 44. Then, the controller 100b stops the application of the voltage to the first liquid-level sensor 43 (i.e., turns the energization of the first liquid-level sensor 43 off) in step S1604, displays a completion notification of the preparation for liquid application on, for example, the operation panel 110 in step S1605, and ends the filling supply control process.

On the other hand, when the output value (voltage) from the first liquid-level sensor 43 is less than the liquid detection threshold (e.g., the output voltage V1) (NO in step S1614), in step S1617, the controller 100b determines whether the elapsed time from the start (in step S1613) of the operation of the liquid supply pump 46 has reached the abnormality determination time (T1 seconds). When the elapsed time has not reached the abnormality determination time T1 (NO in step S1617), the controller 100b continues the supply of the liquid from the second liquid storage tank 47 to the first liquid storage tank 44 by the liquid supply pump 46 until the output value (voltage) from the first liquid-level sensor 43 becomes equal to or greater than the liquid detection threshold (e.g., output voltage V1) (YES in step S1614).

On the other hand, when the elapsed time has reached the abnormality determination time T1 (YES in step S1617), the controller 100b determines that some kind of abnormality has occurred in the apparatus, and performs error stop processing of stopping the liquid supply pump 46 and/or turning off the energization of the first liquid-level sensor 43 in step S1618. In step S1619, the controller 100b causes the operation panel 110 to display an abnormality notification, and ends the filling supply control process. The “abnormality notification” may be, for example, a display of a warning on the operation panel 110 to prompt a check because there is a possibility that one or both of the liquid supply pump 46 and the first liquid-level sensor 43 are out of order.

The above-described execution of the filling supply control process allows a constant amount of liquid that enables the liquid application by the liquid application member 501 to be stably ensured for the liquid supply member 50 and/or the liquid application member 501. As a result, the frequency of the liquid supply operation from the second liquid storage tank 47 to the first liquid storage tank 44 by the liquid supply pump 46 can be reduced, and the efficiency of the liquid application process can be enhanced.

A description is given below of a relation between the filling supply control process described with reference to FIGS. 19A band 19B and a filling supply operation that is an example of the liquid supply operation described with reference to FIGS. 18A to 18D. First, in the state illustrated in FIG. 18A (“activation of the post-processing apparatus” in FIG. 17), the controller 100b turns on the energization of the first liquid-level sensor 43 in step S1602, acquires an output value (voltage) that the first liquid-level sensor 43 outputs when detecting the liquid in the first liquid storage tank 44, and determines the presence of the liquid (the stored liquid amount) in the first liquid storage tank 44 in step S1603. At this stage, the first liquid storage tank 44 is empty, and thus the output value (voltage) from the first liquid-level sensor 43 is less than the liquid detection threshold (e.g., output voltage V1). For this reason, the controller 100b determines that the state of the inside of the first liquid storage tank 44 is the state of “absence of liquid” (NO in step S1603), and drives the liquid supply pump 46 to execute supply of liquid from the second liquid storage tank 47 to the first liquid storage tank 44 in step S1606. When the amount (liquid level) of the liquid stored in the first liquid storage tank 44 reaches the state of FIG. 18B, the output value (voltage) from the first liquid-level sensor 43 becomes equal to or greater than the liquid detection threshold (e.g., the output voltage V1) (YES in step S1607). The controller 100b stops the liquid supply pump 46 in step S1608 and turns off the energization of the first liquid-level sensor 43 in step S1609.

Subsequently, when the first predetermined time TO, which is set in advance as the time taken until the liquid supply member 50 sucks up liquid as illustrated in FIG. 18C and turns to an executable state for liquid application, has elapsed, in step S1611, the controller 100b turns on the energization of the first liquid-level sensor 43 again. At this stage, a predetermined amount of liquid is sucked up by the liquid supply member 50 from the first liquid storage tank 44 to the liquid supply member 50. As a result, the amount of the liquid stored in the first liquid storage tank 44 decreases and the liquid level of the liquid in the first liquid storage tank 44 becomes lower than the reference liquid level. As a result, the output value (voltage) from the first liquid-level sensor 43 becomes less than the liquid detection threshold (e.g., the output voltage V1) (NO in step S1612).

Then, the controller 100b causes the liquid supply pump 46 to operate again in step S1613 and executes supply of the liquid from the second liquid storage tank 47 to the first liquid storage tank 44 until the output value (voltage) from the first liquid-level sensor 43 becomes equal to or greater than the liquid detection threshold (e.g., the output voltage V1) (YES in step S1614). When the output value (voltage) from the first liquid-level sensor 43 becomes equal to or greater than the liquid detection threshold (e.g., the output voltage V1), the controller 100b stops the liquid supply pump 46 in step S1615 and turns off the energization of the first liquid-level sensor 43 in step S1604. As a result, as illustrated in FIG. 18D, the liquid in the first liquid storage tank 44 is sufficiently stored in the entirety of the liquid supply member 50 and/or the liquid application member 501, and the controller 100b causes the operation panel 110 to display the completion notification of the preparation for liquid application in step S1605.

As described above, the “filling supply operation” is a liquid supply/discharge mode to be executed when the liquid application is executed by the liquid applier 31. That is, in order to stably apply a constant amount of liquid to a sheet P, preferably, the liquid supply member 50 and/or the liquid application member 501 always store a constant amount of liquid.

However, in a case where the first liquid-level sensor 43 cannot detect liquid in a state where the first liquid storage tank 44 is empty as in the case of activation of the post-processing apparatus 3 (see FIG. 18A), preferably, the supply of liquid from the second liquid storage tank 47 to the first liquid storage tank 44 by the liquid supply pump 46 is executed such that the liquid level (stored liquid amount) of liquid in the first liquid storage tank 44 becomes equal to or greater than the reference liquid level. Furthermore, the same applies to a case where the amount of liquid stored in the first liquid storage tank 44 decreases and the liquid level of the liquid in the first liquid storage tank 44 becomes lower than the reference liquid level (see FIG. 18C) due to the operation of the liquid applier 31 (the liquid application member 501) to apply liquid to the sheet P. In other words, the supply of the liquid from the second liquid storage tank 47 to the first liquid storage tank 44 by the liquid supply pump 46 is preferably executed such that the liquid level (stored liquid amount) of the liquid in the first liquid storage tank 44 is equal to or higher than the reference liquid level. The liquid supply/discharge mode in which the liquid supply pump 46 supplies liquid from the second liquid storage tank 47 to the first liquid storage tank 44 is the “filling supply operation”.

A description is given below of an additional supply operation that is one of the liquid supply/discharge modes.

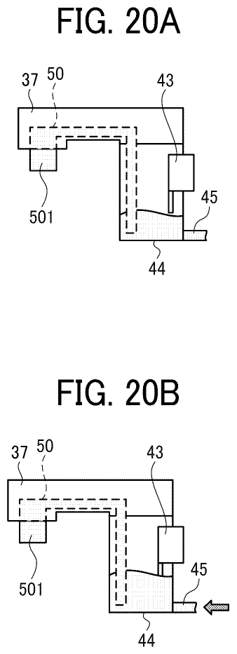

FIGS. 20A and 20B illustrate an outline of the additional supply operation.

The additional supply operation is a liquid supply/discharge mode in which when the liquid stored in the first liquid storage tank 44 is consumed by application of liquid to the sheet P by the liquid applier 31 and the liquid level (stored liquid amount) of the liquid in the first liquid storage tank 44 decreases to a level lower than a reference liquid level, the supply of liquid from the second liquid storage tank 47 to the first liquid storage tank 44 is executed. In this case, when the liquid level in the first liquid storage tank 44 has decreased to a level at which the first liquid-level sensor 43 does not detect the liquid in the first liquid storage tank 44, the controller 100b operates the liquid supply pump 46 to execute the supply of the liquid from the second liquid storage tank 47 to the first liquid storage tank 44 until a state where the first liquid-level sensor 43 detects the liquid in the first liquid storage tank 44 (the liquid level of the liquid in the first liquid storage tank 44 reaches a reference liquid level) is achieved.

The filling supply operation described above is a liquid supply operation performed when the liquid is supplied to the liquid supply member 50 in a state where the stored liquid amount (liquid level) in the first liquid storage tank 44 has decreased and it is necessary to supply the liquid to the liquid supply member 50 (a state where the liquid used for the liquid application is insufficient). On the other hand, the additional supply operation is a liquid supply operation in which liquid is supplied to the first liquid storage tank 44 in a state where liquid is held by the liquid supply member 50 (a state where liquid used for liquid application is not insufficient). In other words, it is assumed that the liquid level (stored liquid amount) of the liquid in the first liquid storage tank 44 has dropped to a level lower than the reference liquid level (see FIG. 20A) as a result of consumption of the liquid by liquid application from a state (see FIG. 18D) in which the liquid level (stored liquid amount) of the liquid in the first liquid storage tank 44 has been filled to above the reference liquid level. In this case, the liquid supply pump 46 is operated to supply additional liquid from the second liquid storage tank 47 into the first liquid storage tank 44 such that the liquid level (stored liquid amount) of the liquid in the first liquid storage tank 44 turns to be equal to or greater than the reference liquid level again as illustrated in FIG. 20B. In other words, the additional supply operation is a liquid supply/discharge mode in which liquid is supplied from the second liquid storage tank 47 to the first liquid storage tank 44 by the liquid supply pump 46 as the liquid in the first liquid storage tank 44 is consumed by liquid application.

A description is given below of a control process of an additional supply operation.

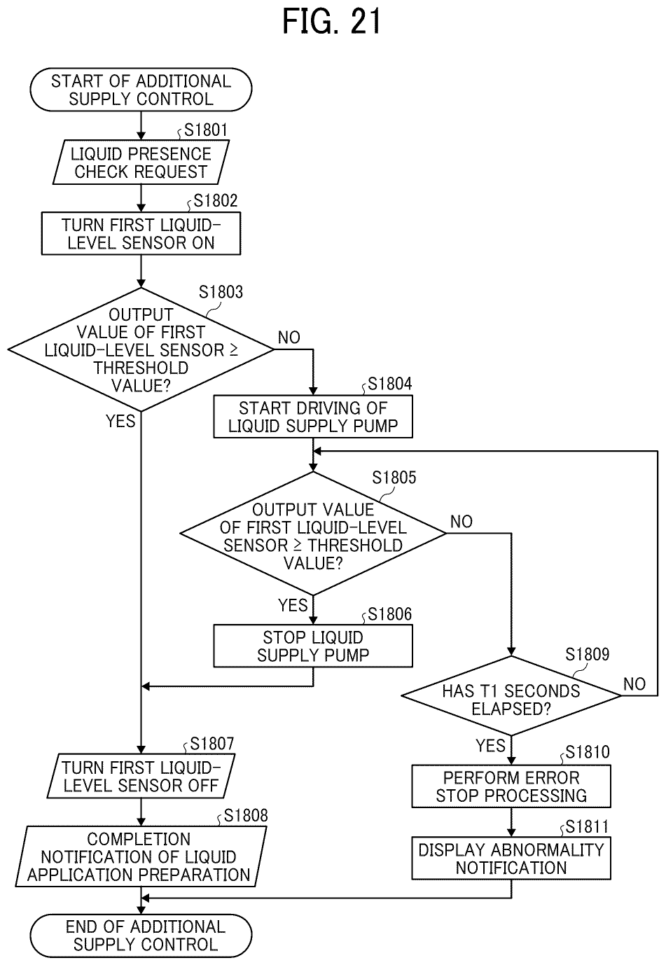

FIG. 21 is a flowchart of an example of a control process of an additional supply operation (referred to as a “additional supply control process” in the following description) which is an example of a liquid supply operation executed in the controller 100b. As illustrated in FIG. 17, the additional supply operation is executed at an end of the crimp binding process by the crimper 32 accompanied by the liquid application or during standby of the post-processing apparatus 3 (such as when the edge binder 25 is not operating).

For example, when the crimp binding process by the crimper 32 accompanied by the liquid application ends, the additional supply control process is started. When the additional supply control process is started, in step S1801, a liquid presence check request is instructed from the image forming apparatus 2 to the controller 100b. The liquid presence check request may be instructed based on information input by the user from the operation panel 110 of one or both of the image forming apparatus 2 and the post-processing apparatus 3. In response to receipt of the liquid presence check request instructed from the image forming apparatus 2, in step S1802, the controller 100b applies a voltage to the first liquid-level sensor 43 (turns on energization).

Subsequently, in step S1803, the controller 100b acquires an output value (voltage) that is output when the first liquid-level sensor 43 detects liquid in the first liquid storage tank 44, and determines the presence (the stored liquid amount) of liquid in the first liquid storage tank 44. The determination of the presence of liquid (the stored liquid amount) in the first liquid storage tank 44 is performed based on whether the output value (voltage) from the first liquid-level sensor 43 exceeds a “liquid detection threshold” (threshold) set in advance. For example, when the output value (voltage) from the first liquid-level sensor 43 is equal to or greater than the liquid detection threshold (e.g., output voltage V1), the controller 100b determines that the amount of liquid stored in the first liquid storage tank 44 is a sufficient amount (YES in step S1803). In this case, the controller 100b stops the application of the voltage to the first liquid-level sensor 43 (turns the energization of the first liquid-level sensor 43 off) in step S1807, displays a completion notification of the preparation for liquid application on, for example, the operation panel 110 in step S1808, and ends the additional supply control process.

On the other hand, when the output value (voltage) from the first liquid-level sensor 43 is less than the liquid detection threshold (e.g., the output voltage V1) in step S1803 (NO in step S1803), in step S1804, the controller 100b operates the liquid supply pump 46 to execute the supply of the liquid from the second liquid storage tank 47 to the first liquid storage tank 44.

Subsequently, in step S1805, the controller 100b determines whether the output value (voltage) from the first liquid-level sensor 43 is equal to or greater than the “liquid detection threshold” (threshold) set in advance. When the output value (voltage) from the first liquid-level sensor 43 is equal to or greater than the liquid detection threshold (e.g., the output voltage V1), the controller 100b determines that a sufficient amount of liquid has been supplied from the second liquid storage tank 47 into the first liquid storage tank 44 by the liquid supply pump 46 (YES in step S1805). In step S1806, the controller 100b stops the liquid supply pump 46 to stop the supply of liquid from the second liquid storage tank 47 to the first liquid storage tank 44. The controller 100b stops the application of the voltage to the first liquid-level sensor 43 (turns the energization of the first liquid-level sensor 43 off) in step S1807, displays a completion notification of the preparation for liquid application on, for example, the operation panel 110 in step S1808, and ends the additional supply control process.

On the other hand, when the voltage outputted from the first liquid-level sensor 43 is less than the liquid detection threshold (for example, the output voltage V1) (NO in step S1805), in step S1809, the controller 100b determines whether the elapsed time from the start of the operation of the liquid supply pump 46 (in step S1804) has not exceeded the abnormality determination time (T1 seconds). When the elapsed time has not reached the abnormality determination time T1 (NO in step S1809), the controller 100b continues the supply of the liquid from the second liquid storage tank 47 to the first liquid storage tank 44 by the liquid supply pump 46 until the output value (voltage) from the first liquid-level sensor 43 becomes equal to or greater than the liquid detection threshold (e.g., output voltage V1) (YES in step S1805).

On the other hand, when the elapsed time has reached the abnormality determination time T1 (YES in step S1809), the controller 100b determines that some kind of abnormality has occurred in the apparatus, and performs error stop processing of stopping the liquid supply pump 46 and/or turning off the energization of the first liquid-level sensor 43 in step S1810. In step S1811, the controller 100b causes the operation panel 110 to display an abnormality notification, and ends the additional supply control process. The “abnormality notification” is similar to that described above, and hence the description thereof is omitted.

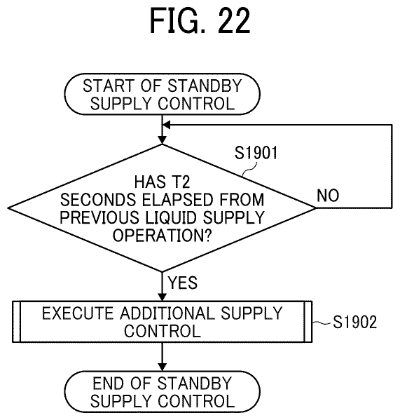

A description is given below of a control process of the standby supply operation (referred to as a “standby supply control process” in the following description) with reference to FIG. 22.

When the above-described liquid application and liquid supply operations are periodically performed in the post-processing apparatus 3, the amount of liquid stored in the first liquid storage tank 44 is maintained at an appropriate level. However, in a case where the liquid application and/or the liquid supply operation is not performed for a long period of time, there is a risk that the liquid evaporates and the amount of the liquid stored in the first liquid storage tank 44 decreases or the first liquid storage tank 44 becomes empty.

As already described, the liquid supply member 50 and/or the liquid application member 501 is/are made of a liquid absorber such as a sponge, and hence the liquid absorber may dry out if the liquid storage device is left for a long time in a state where there is no liquid in the first liquid storage tank 44. Once the liquid supply member 50 and/or the liquid application member 501 (liquid absorber) is in a dry state, even if liquid supply to the first liquid storage tank 44 is performed again, it will take a considerable time for the liquid application member 501 and/or the liquid application member 501 to complete sucking up of liquid. As a result, a user's wait time increases and user convenience decreases. In addition, if a binding process (crimp binding process and/or staple binding process) accompanied by liquid application is performed before suction of liquid by the liquid application member 501 and/or the liquid application member 501 is completed, there is a risk that liquid application to the sheet P becomes insufficient, binding failure occurs, and binding quality decreases.

For this reason, when the liquid supply operation has not been performed for a certain period of time (during standby), the liquid supply operation is periodically performed in preparation for the next crimp binding process accompanied by liquid application, thereby preventing the liquid application member 501 and/or the liquid application member 501 from drying. Accordingly, the time required until the start of the liquid application process by the liquid applier 31 in the next crimp binding process accompanied by liquid application can be shortened. Thus, user convenience can be enhanced by shortening the user's wait time. In addition, since it is possible to reduce a binding failure which occurs due to insufficient liquid application to the sheet P since a binding operation (crimp binding process and/or staple binding process) accompanied by the liquid application process is performed before the completion of the suction of the liquid by the liquid application member 501 and/or the liquid application member 501, the binding quality can be enhanced.

FIG. 22 is a flowchart of an example of a standby supply control process. When the standby supply control process is started, in step S1901, the controller 100b counts, with a timer, an elapsed time (referred to as an elapsed time after the liquid supply operation in the following description) from a point in time when the liquid supply operation such as the filling supply operation and the additional supply operation ends, and monitors whether the elapsed time after the liquid supply operation has reached the second predetermined time (T2 seconds) as the elapsed determination time. The monitoring is continued until the elapsed time from the liquid supply operation reaches the second predetermined time T2 (NO in step S1901).

When the elapsed time after the liquid supply operation has reached the second predetermined time T2 (YES in step S1901), in step S1902, the controller 100b executes the additional supply control process that is control of the additional supply operation described above, and then ends the standby supply control process. During the timer count, the timer is reset when any liquid supply operation is performed. The second predetermined time T2 is set to a time taken until the first liquid storage tank 44 becomes empty when left without performing the liquid supply operation, in consideration of properties of the liquid stored in the first liquid storage tank 44 and other factors.

A description is given below of a liquid discharge operation and a control process of the liquid discharge operation.

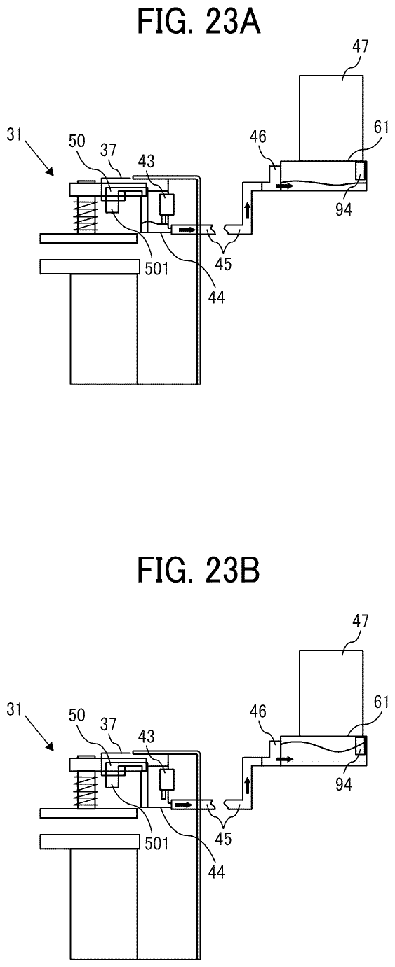

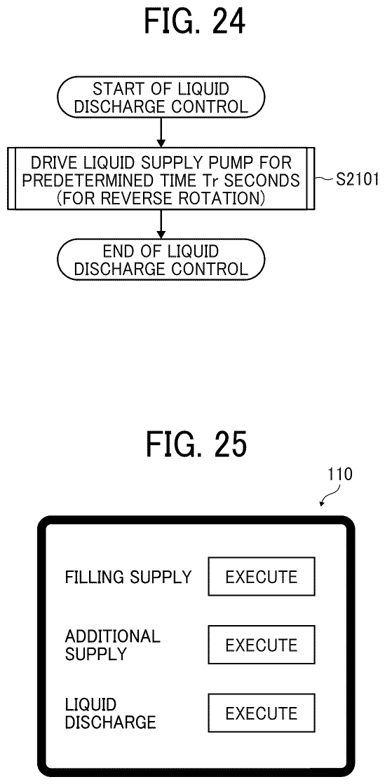

Specifically, a description is given below of a liquid discharge control of controlling a liquid discharge operation executable in the post-processing apparatus 3. FIGS. 23A and 23B are diagrams illustrating an outline of a liquid discharge operation which is one of liquid supply/discharge modes. FIG. 24 is a flowchart of an example of a control process of the liquid discharge operation (“liquid discharge control process”). The “liquid discharge operation” used herein is to feed the liquid stored in the first liquid storage tank 44 to the second liquid storage tank 47 by the liquid supply pump 46. In other words, the liquid is fed in a direction opposite to the liquid supply direction in the above-described liquid supply operation.

During use of the post-processing apparatus 3, the first liquid storage tank 44, the liquid supply member 50, and/or the liquid application member 501 are filled with liquid. However, it may be necessary to perform an operation (“liquid draining process” described above) of emptying the first liquid storage tank 44 in order to prevent liquid leakage from the first liquid storage tank 44 when an operation is performed with the liquid supply member 50 and/or the liquid application member 501 removed for maintenance or in order to prevent contamination by liquid when the post-processing apparatus 3 is not used for a long time. For example, in such a case, the liquid discharge operation is executed.

When the “liquid discharge operation” is selected as the liquid supply/discharge mode, the liquid discharge control process is started. When the liquid discharge control process starts, in S2101, the controller 100b drives (rotates in reverse) the liquid supply pump 46 for a predetermined time (Tr seconds) to suck up liquid from the first liquid storage tank 44 (see FIG. 23A). As a result, liquid in the first liquid storage tank 44 is sent to the second-liquid-storage-tank fixer 61 and is discharged from the first liquid storage tank 44, thus leaving the first liquid storage tank 44 empty (see FIG. 23B). The predetermined time Tr, which is the operation time of the liquid supply pump 46, is set to, for example, a time during which the liquid in the first liquid storage tank 44 and the liquid in the liquid supply member 50 and/or the liquid application member 501 are sufficiently discharged. The controller 100b drives (rotates in reverse) the liquid supply pump 46 for the predetermined time Tr, and ends the liquid discharge control process.

The “liquid discharge operation” as the liquid supply/discharge mode may be executed by a user's selection of a desired mode on an operation screen of the operation panel 110 as illustrated in FIG. 25. Further, a user can also provide an instruction to execute the “filling supply operation” or the “additional supply operation” as the liquid supply/discharge mode via the operation panel 110.

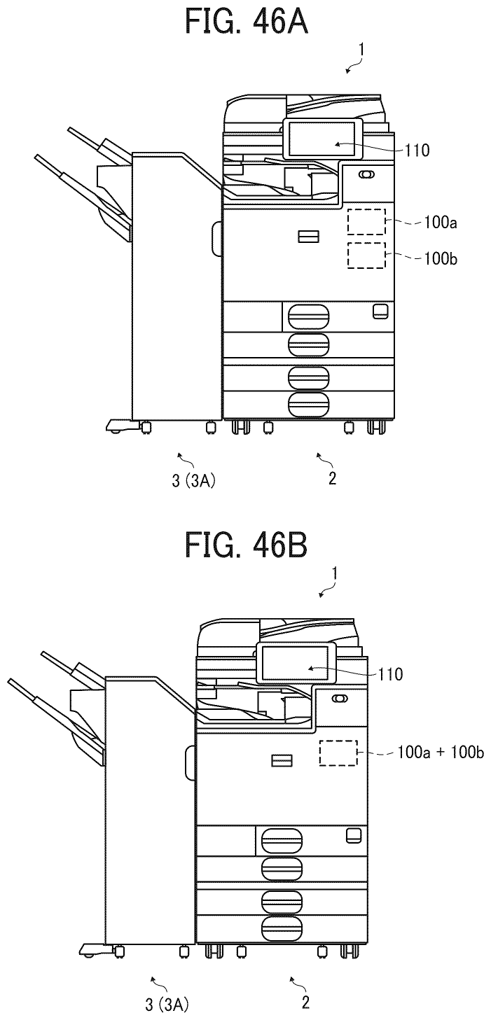

In the above description, the controller 100b of the post-processing apparatus 3 is provided separately from the controller 100a of the image forming apparatus 2 as illustrated in FIG. 1. However, the present disclosure is not limited to the above-described configuration. For example, as illustrated in FIG. 46A, the controller 100b of the post-processing apparatus 3 may be disposed in the image forming apparatus 2. Further, as illustrated in FIG. 46B, the controller 100b of the post-processing apparatus 3 may be integrated with the controller 100a of the image forming apparatus 2.

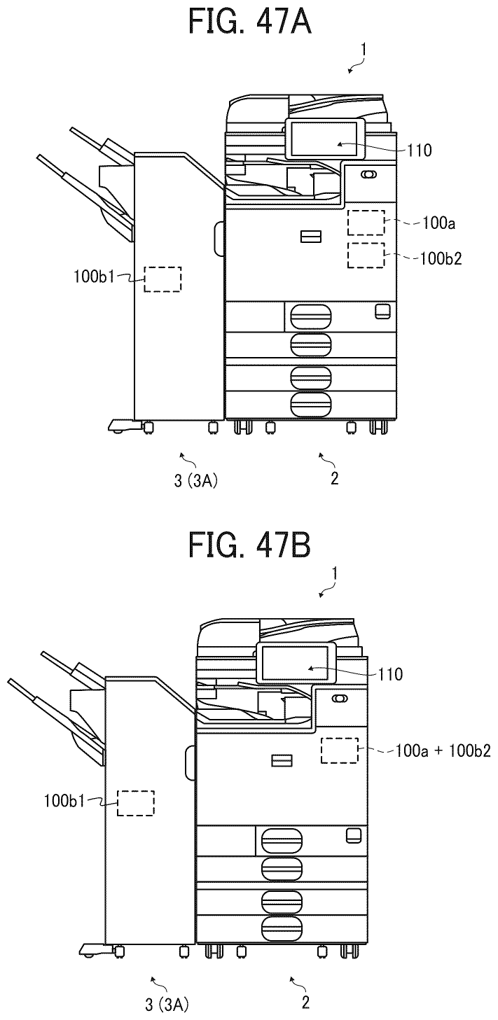

As illustrated in FIG. 47A, the controller 100b of the post-processing apparatus 3 may be divided into a controller 100b1 (of, e.g., a drive system such as a motor) and a controller 100b2 (of, e.g., a detector system such as a sensor) according to the function, and only the controller 100b2 of the post-processing apparatus 3 may be located in the image forming apparatus 2. Further, as illustrated in FIG. 47B, the controller 100b2 of the post-processing apparatus 3 located in the image forming apparatus 2 may be integrated with the controller 100a of the image forming apparatus 2.

A description is given below of a configuration of attachment and detachment of a second liquid storage of a medium processing apparatus according to an embodiment of the present disclosure with reference to the drawings.

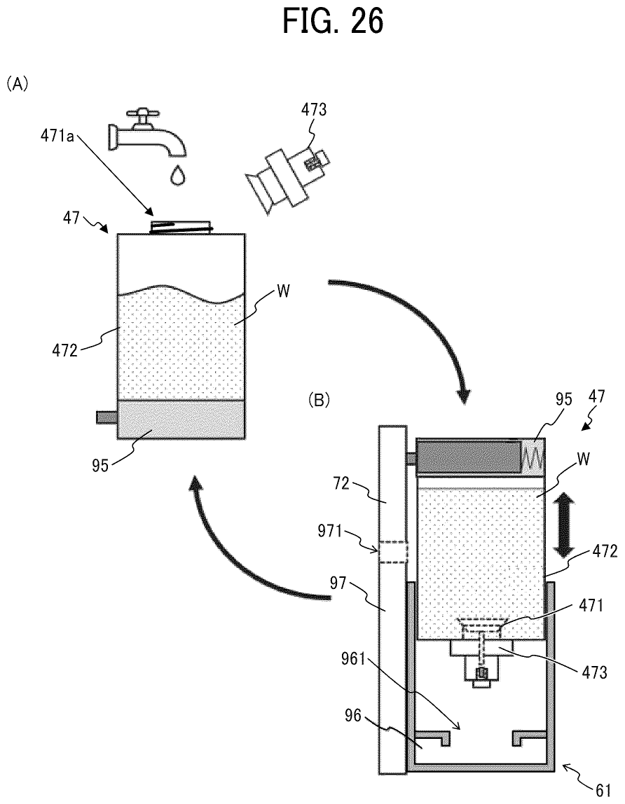

FIG. 26 is a schematic view of a configuration in which the second liquid storage tank 47 as an example of the second liquid storage is detachably attached to the post-processing apparatus 3.

The second liquid storage tank 47 is attachable to and detachable from the second-liquid-storage-tank fixer 61 as an example of a liquid storage tray. The second liquid storage tank 47 includes a tank portion 472 as a liquid storage tank to store the liquid used for liquid application and supplied to the first liquid storage tank 44, a cap 473, and the second-liquid-storage-tank fixer 61. The cap 473 is attachable to and detachable from the tank portion 472, and liquid can be supplied from the liquid discharge port 471a of the tank portion 472 into the cap 173. The cap 473 is configured to be fitted into a cap insertion hole 961 of the second-liquid-storage-tank fixer 61.

When the liquid stored in the first liquid storage tank 44 is reduced by the liquid application, liquid is supplied from the second liquid storage tank 47 to the first liquid storage tank 44. When the liquid stored in the second liquid storage tank 47 is reduced by this liquid supply and the liquid is replenished (supplied), the tank portion 472 is detached from the second-liquid-storage-tank fixer 61. Then, the cap 473 is detached from the tank portion 472, and the liquid is replenished into the tank portion 472 from the liquid discharge port 471a (see FIG. 26A).

Then, when the liquid discharge port 471a is closed by the cap 473 and the tank portion 472 is set in the second-liquid-storage-tank fixer 61, the cap 473 is fitted into the cap insertion hole 961. By this series of operations, the liquid is stored in the liquid storage tray 96 as the liquid storage tray of the second-liquid-storage-tank fixer 61, and the liquid is supplied from the liquid storage tray 96 to the liquid supply passage 45.

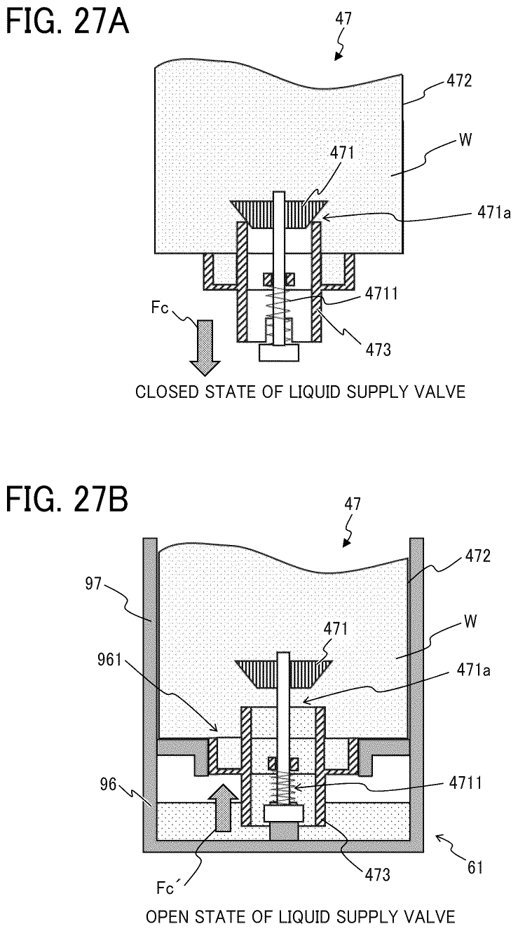

A description is given below of a configuration of the liquid supply valve 471 of the second liquid storage tank 47 with reference to FIGS. 27A and 27B.

FIG. 27A illustrates a state where the tank portion 472 is detached from the second-liquid-storage-tank fixer 61 and the liquid supply valve 471 is closed. FIG. 27B illustrates a state where the tank portion 472 is attached to the second-liquid-storage-tank fixer 61 and the liquid supply valve 471 is opened.

As illustrated in FIGS. 27A and 27B, the cap 473 is provided with the liquid supply valve 471. The liquid supply valve 471 is biased by a cap spring 4711 in a direction from the inside of the tank portion 472 toward the outside of the tank portion 472. Accordingly, in the state where the tank portion 472 is detached from the second-liquid-storage-tank fixer 61, the liquid supply valve 471 is in a state of closing the liquid discharge port 471a by the biasing force Fc (see the arrow in FIG. 24A) of the cap spring 4711.

When the tank portion 472 is set in the second-liquid-storage-tank fixer 61, the liquid supply valve 471 is pushed up against the biasing force Fc of the cap spring 4711, and the liquid discharge port 471a is opened. As a result, the liquid flows from an opening (liquid discharge port 471a) of the cap 473 to the liquid storage tray 96 of the second-liquid-storage-tank fixer 61. The tip of the cap 473 has a notch, and the liquid level of liquid in the second-liquid-storage-tank fixer 61 can be maintained constant.

A description is given below of a locking mechanism (of a locking tab type) of the second liquid storage tank 47.

Specifically, a description is given of a configuration that allows easy operation and reliable attachment and detachment when the second liquid storage tank 47 is fixed to and detached from the second-liquid-storage-tank fixer 61. The second liquid storage tank 47 according to the present embodiment includes a locking mechanism 95 as a configuration for facilitating attachment and detachment of the tank portion 472, as illustrated in FIG. 26.

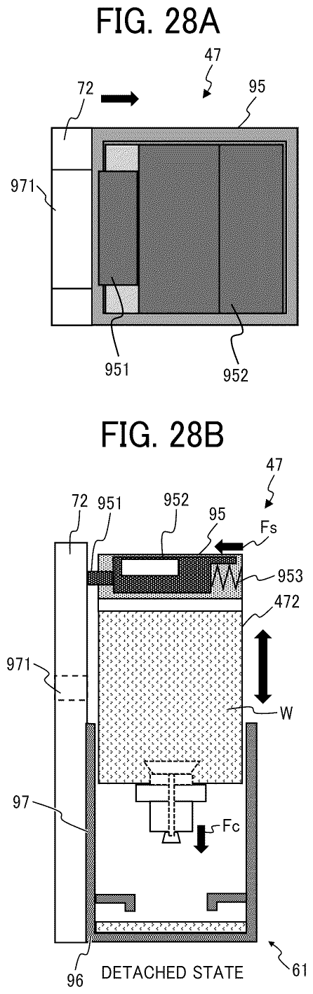

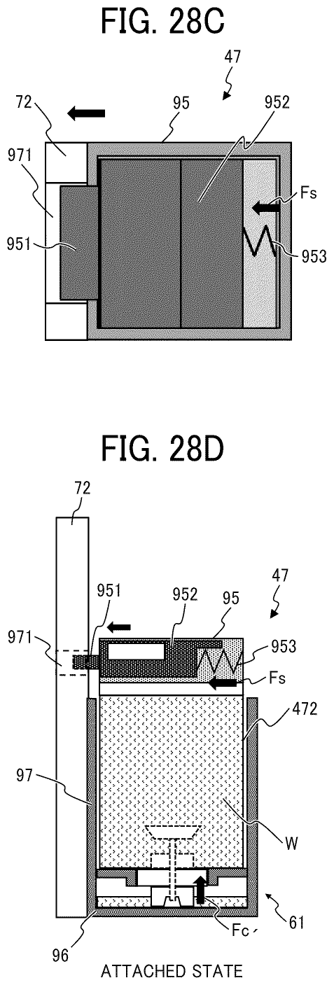

FIGS. 28A, 28B, 28C, and 28D are diagrams illustrating a configuration of the locking mechanism 95 according to the present embodiment. FIG. 28A is a top view of the second liquid storage tank 47 in the state where the tank portion 472 is detached from the second-liquid-storage-tank fixer 61. FIG. 28B is a side view of the second liquid storage tank 47 in the state where the tank portion 472 is detached from the second-liquid-storage-tank fixer 61. FIG. 28C is a top view of the second liquid storage tank 47 in the state where the tank portion 472 is attached to the second-liquid-storage-tank fixer 61. FIG. 28D is a side view of the second liquid storage tank 47 in the state where the tank portion 472 is attached to the second-liquid-storage-tank fixer 61.

As described above, the liquid supply valve 471 is biased in a direction of being closed by the biasing force Fc of the cap spring 4711. When the tank portion 472 is set in the second-liquid-storage-tank fixer 61, the distal end of the liquid supply valve 471 presses the liquid storage tray 96 of the second-liquid-storage-tank fixer 61. In other words, a reaction force Fc′ in a direction of pushing up the second liquid storage tank 47, which is generated by the biasing force Fc of the cap spring 4711, acts on the second liquid storage tank 47 (see FIGS. 27B and 28D).

The locking mechanism 95 of the second liquid storage tank 47 includes a locking tab 951 (engaging portion), a lock release lever 952 (engagement releaser), and a lock spring 953 (biasing member). The locking tab 951 and the lock release lever 952 are biased by the biasing force Fs of the lock spring 953 acting in the direction in which the locking tab 951 projects (see FIGS. 28B and 28D). Accordingly, when the lock release lever 952 is slid, the user slides the lock release lever 952 in a direction opposite to the biasing force Fs of the lock spring 953. Then, when the user releases his/her sliding force, the locking tab 951 automatically slides in the direction of the biasing force Fs of the lock spring 953.

As illustrated in FIGS. 28A to 28D, when the tank portion 472 is attached to the second-liquid-storage-tank fixer 61, the locking tab 951 is inserted toward the locking hole 971 of the housing side plate 72, which is a part of the apparatus housing of the post-processing apparatus 3, by the biasing force Fs of the lock spring 953 (see FIGS. 28C and 28D). Thus, the locking tab 951 is engaged with the locking hole 971, and the position of the tank portion 472 in the attachment/detachment direction (vertical direction) is restricted.

When the second liquid storage tank 47 is pulled out, the lock release lever 952 is slid in a direction opposite to the biasing force Fs of the lock spring 953 (see arrow in FIGS. 28A and 28B), and the locking tab 951 is retracted from the locking hole 971 to be in a non-engagement state. Thus, the lock is released. Then, the user can remove the tank portion 472 by pulling the tank portion 472 out of the second-liquid-storage-tank fixer 61 while holding an upper portion of the tank portion 472 and maintaining the unlocked state.

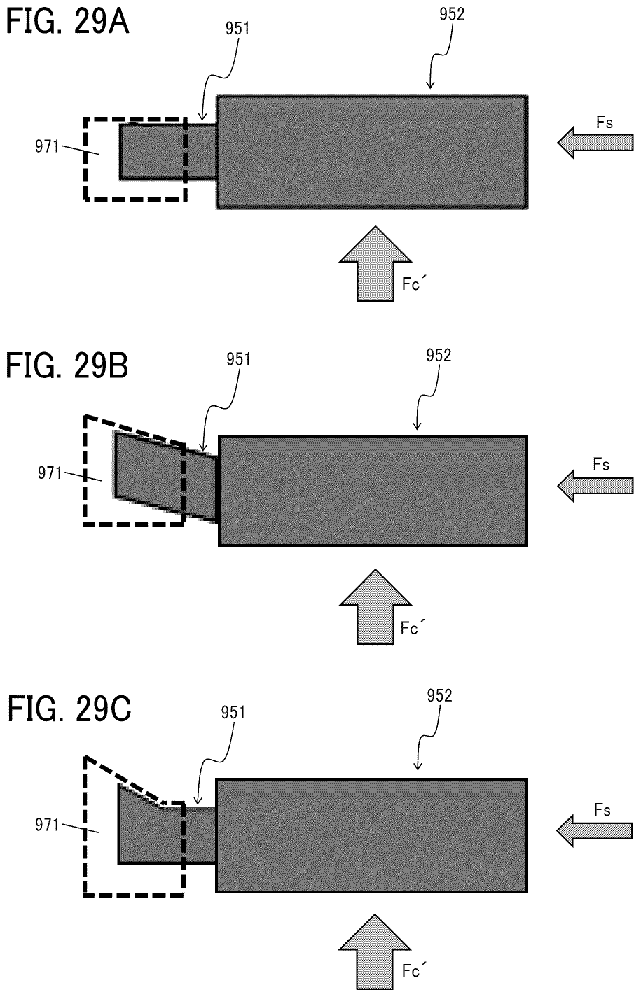

A description is given below of examples of the shape of the locking tab 951 with reference to FIGS. 29A, 29B, and 29C.

FIGS. 29A, 29B, and 29C are diagrams illustrating examples of the relationship between the locking tab 951 and the locking hole 971 when the locking tab 951 is engaged with the locking hole 971 as illustrated in FIGS. 28C and 28D and the position of the tank portion 472 in the attachment/detachment direction is restricted.

As illustrated in FIG. 29A, the entire shape of the locking tab 951 may be a shape having a horizontal surface with respect to the sliding direction (the left-right direction in FIG. 29A). However, in this case, the weight of the tank portion 472 itself is light. Accordingly, when the liquid W stored in the tank portion 472 decreases, the reaction force Fc′ in the direction of pushing up the second liquid storage tank 47 increases. On the other hand, the biasing force Fs of the lock spring 953 is desirably small from the viewpoint of enhancing the operability of the user (e.g., the minimum magnitude at which the engagement state between the locking tab 951 and the locking hole 971 can be maintained). Accordingly, for example, when the locking tab 951 is deformed by the reaction force Fc′ in the direction of pushing up the second liquid storage tank 47, the locking tab 951 may be easily removed from the locking hole 971.

Further, as illustrated in FIG. 29B, the entire shape of the protruding portion of the locking tab 951 may be formed in an inclined state so as to have an upward inclined surface with respect to a body portion. In this case, it is desirable that the inner surface of the locking hole 971, which abuts against the upward inclined surface of the protruding portion of the locking tab 951, is also formed as a similar inclined surface. Even when the reaction force Fc′ in the direction of pushing up the second liquid storage tank 47 increases due to the decrease in the liquid W stored in the tank portion 472 as described above, the shapes of the locking tab 951 and the locking hole 971 formed as illustrated in FIG. 29B can restrict the deformation of the locking tab 951. Thus, the inclined surface can reduce the force of pulling out the locking tab 951 from the locking hole 971 to be smaller than the biasing force Fs of the lock spring 953. Accordingly, the inclined surface of the locking tab 951 is caught by the locking hole 971, and the locking tab 951 is less likely to come off the locking hole 971.

Further, as illustrated in FIG. 29C, the distal end of the projecting portion of the locking tab 951 may be shaped as an inclined portion that projects upward with respect to the sliding direction of a body portion. In this case, it is also desirable that the inner surface of the locking hole 971, which abuts against the upper surface of the protruding portion of the locking tab 951, has the same or similar shape. With the shapes of the locking tab 951 and the locking hole 971 formed as illustrated in FIG. 29C, the inclined portion of the locking tab 951 is more firmly caught by the locking hole 971. Thus, the locking tab 951 is more unlikely to from the locking hole 971 than in the case of FIG. 29B.

A description is given of a guide mechanism that restricts the position of the second liquid storage tank 47 in the front-rear and left-right directions.

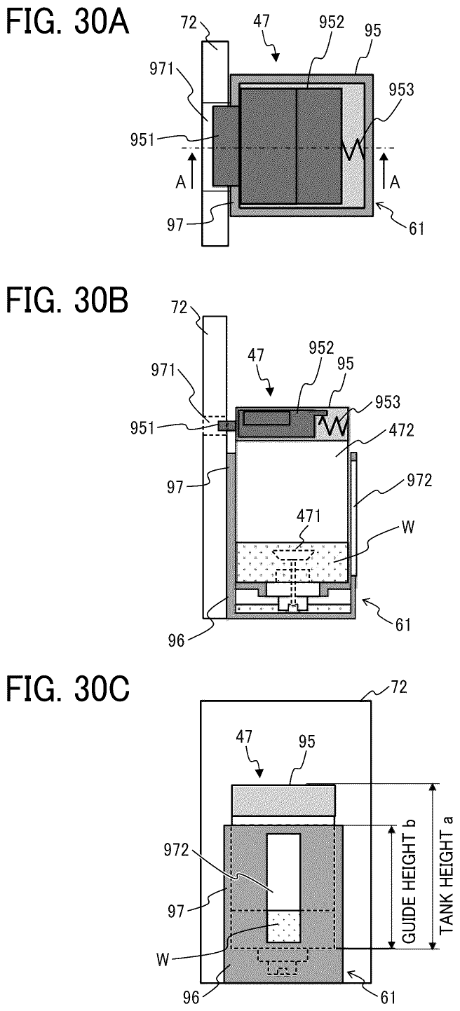

FIGS. 30A, 30B, and 30C are schematic views of a guide mechanism of the second liquid storage tank 47. FIG. 30A is a top view of the second liquid storage tank 47 in the state where the tank portion 472 is attached to the second-liquid-storage-tank fixer 61. FIG. 30B is a cross-sectional view of the second liquid storage tank 47 taken along a dash-dotted line in FIG. 30A, as viewed from the direction indicated by arrows A in FIG. 30A. FIG. 30B illustrates the second liquid storage tank 47 in the state where the tank portion 472 is attached to the second-liquid-storage-tank fixer 61. FIG. 30C is a diagram illustrating a correlation between the height of the tank portion 472 and the height of a guide portion 97 as an example of the guide mechanism.

As illustrated in FIGS. 30B and 30C, the second-liquid-storage-tank fixer 61 is provided with a liquid storage tray 96 to store the liquid flowing out of the second liquid storage tank 47, and a guide portion 97 to guide and hold the tank portion 472 when the tank portion 472 is attached or detached. When the tank portion 472 is removed (detached) from the second-liquid-storage-tank fixer 61, the tank portion 472 is lifted so as to be pulled out along the guide portion 97. In other words, when the tank portion 472 is detached from the second-liquid-storage-tank fixer 61 to replenish the liquid, the guide portion 97 restricts the position of the tank portion 472 in the horizontal direction when the tank portion 472 is pulled up along the guide portion 97. In other words, the guide portion 97 is configured to restrict the position of the tank portion 472 in the attachment/detachment direction. This configuration prevents the tank portion 472 from sway in a direction different from the attachment/detachment direction, for example, sway form side to side in the horizontal direction. The position of the tank portion 472 in the attachment/detachment direction is restricted to prevent the tank portion 472 from swaying when the user pulls out the tank portion 472. Thus, the user can easily pull out the tank portion 472.

If the height of the guide portion 97 as a wall is too low with respect to the height of the tank portion 472, the tank portion 472 may become an unstable posture, for example, fall down without standing upright with respect to the second-liquid-storage-tank fixer 61 and the posture when the tank portion 472 is attached to the second-liquid-storage-tank fixer 61. If the tank portion 472 falls, the locking tab 951 may be disengaged.

For this reason, as illustrated in FIG. 30C, in view of the easiness of attachment and detachment and the stability of the tank portion 472, the lower limit of the height dimension (guide height b) of the guide portion 97 is preferably half (or substantially half) or more of the height dimension (tank height a) of the tank portion 472. In addition, from the viewpoint of operability, the upper limit of the guide height b may be set to be lower than the locking mechanism 95 attached to the upper surface of the tank portion 472.

Further, the tank portion 472 may be entirely or partially transparent or translucent so that the amount of liquid inside the tank portion 472 can be visually recognized. In this case, if the height of the guide portion 97 is increased, the side surface of the tank portion 472 cannot be visually recognized in the state where the tank portion 472 is set in the second-liquid-storage-tank fixer 61, and it is difficult to check the liquid amount. For this reason, as illustrated in FIG. 30C, the guide portion 97 may have a check window 972 as a window portion (visual recognition portion) so that the liquid amount inside the tank portion 472 can be visually recognized from the outside. Thus, the contents of the tank portion 472 can be directly viewed through the check window 972.

A description is given below of modifications of the locking mechanism 95 according to the present embodiment.

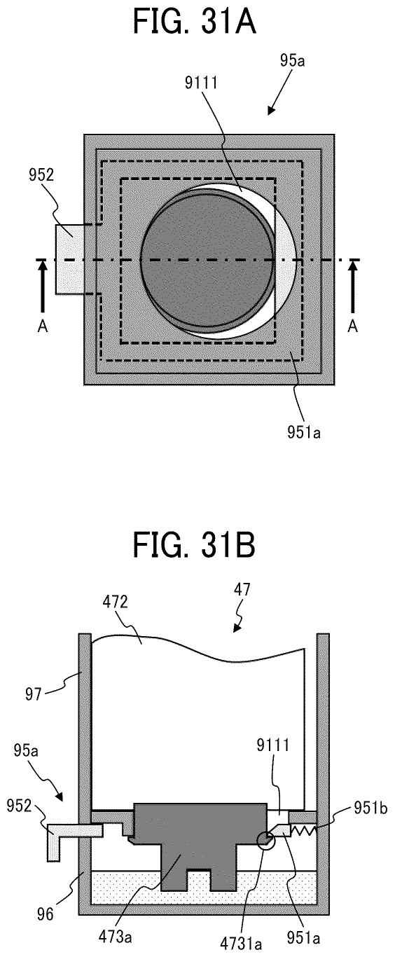

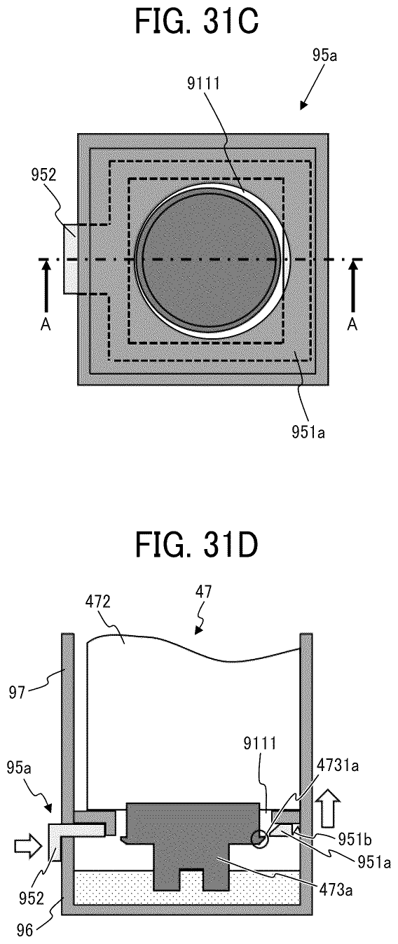

FIG. 31A is a top view of a locking mechanism 95a according to a first modification in the locked state. FIG. 31B is a cross-sectional view of the locking mechanism 95a according to the first modification in the locked state, taken along the dash-dotted line in FIG. 31A, as viewed from a direction indicated by arrows A. FIG. 31C is a top view of the locking mechanism 95a according to the first modification in the unlocked state. FIG. 31D is a cross-sectional view of the locking mechanism 95a according to the first modification in the unlocked state, taken along the dash-dotted line in FIG. 31C, as viewed from the direction indicated by arrows A.

The locking mechanism 95a illustrated in FIGS. 31A to 31D includes a lock plate 951a (engaging portion) instead of the locking tab 951. The lock plate 951a is disposed on a top portion of the liquid storage tray 96, which is a part of the second-liquid-storage-tank fixer 61, so as to be slidable in the left-right direction. The lock plate 951a is biased by an elastic member 951b so as to protrude in a direction to decrease a gap in the radial direction of a bottle insertion hole 9111 disposed in the top portion of the liquid storage tray 96 which is a part of the second-liquid-storage-tank fixer 61. Accordingly, when a force in a direction against the biasing to the lock plate 951a is applied to the lock plate 951a, the elastic member 951b contracts, and the lock plate 951a retreats in a direction of expanding the gap of the bottle insertion hole 9111.

A plate engagement portion 4731a (engaged portion) that engages with the lock plate 951a and the top portion of the liquid storage tray 96 is disposed on the side surface of a cap 473a to which the tank portion 472 is attached. The plate engagement portion 4731a is a portion having a convex shape or a concave shape. The lock plate 951a is inserted into the plate engagement portion 4731a, and the entire tank portion 472 moves in the insertion direction to restrict the position of the cap 473a in the attachment/detachment direction. Thus, the position of the tank portion 472 in the attachment/detachment direction is restricted.

When the tank portion 472 is inserted into the second-liquid-storage-tank fixer 61, the lock plate 951a is pushed by the plate engagement portion 4731a of the cap 473a and moves in the retracting direction. When the tank portion 472 is set to the lower position, the lock plate 951a climbs over the convex shape of the plate engagement portion 4731a, and the lock plate 951a is in the locked state.

The lock plate 951a is provided with an interlocking lock release lever 952, and the tank portion 472 can be pulled out by operating and retracting the lock release lever 952.

A description is given below of another modification of the locking mechanism 95 according to the present embodiment.

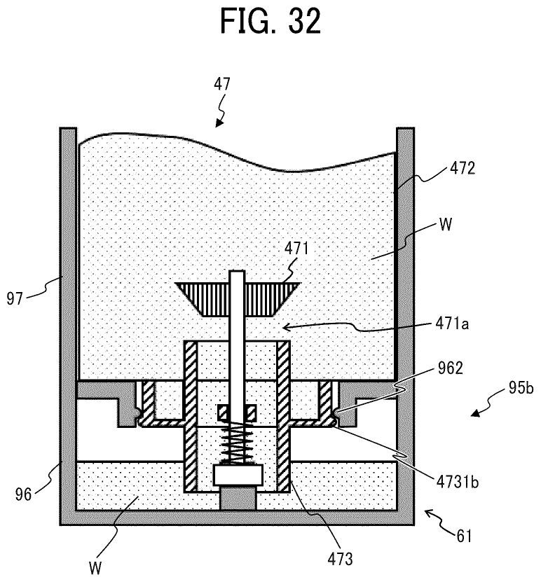

FIG. 32 is a side view of a locking mechanism 95b according to a second modification in the locked state. The locking mechanism 95b is configured as a so-called “snap-fit type.”

Cap convex portions 4731b (convex portions) are disposed on the side faces of the cap 473 attached to a projecting portion of the tank portion 472. In addition, tray convex portions 962 (convex portions) are disposed on the outer periphery of a hole of the liquid storage tray 96 of the second-liquid-storage-tank fixer 61 to which the cap 473 is fitted. An elastic body (e.g., resin) is used as a material for either or both of the cap 473 and the liquid storage tray 96.

In other words, either or both of the cap convex portions 4731b as two lock-shaped portions and the tray convex portions 962 as two protrusion-shaped portions are formed of elastic bodies. Accordingly, when the tank portion 472 is fitted and pushed into the liquid storage tray 96, the tank portion 472 deforms and the cap convex portions 4731b reach positions beyond the tray convex portions 962. The cap convex portions 4731b fit into the opening beyond the tray convex portions 962, thus restricting the position of the tank portion 472 in the attachment/detachment direction.

Further, when the tank portion 472b is detached from the liquid storage tray 96, the operation for unlocking is not necessary. When the tank portion 472b is pulled upward, the cap convex portions 4731b move over the tray convex portions 962 by the resilience, thus allowing the tank portion 472b to be pulled out and inserted as they are.

A description is given below of still another modification of the locking mechanism 95 according to the present embodiment.

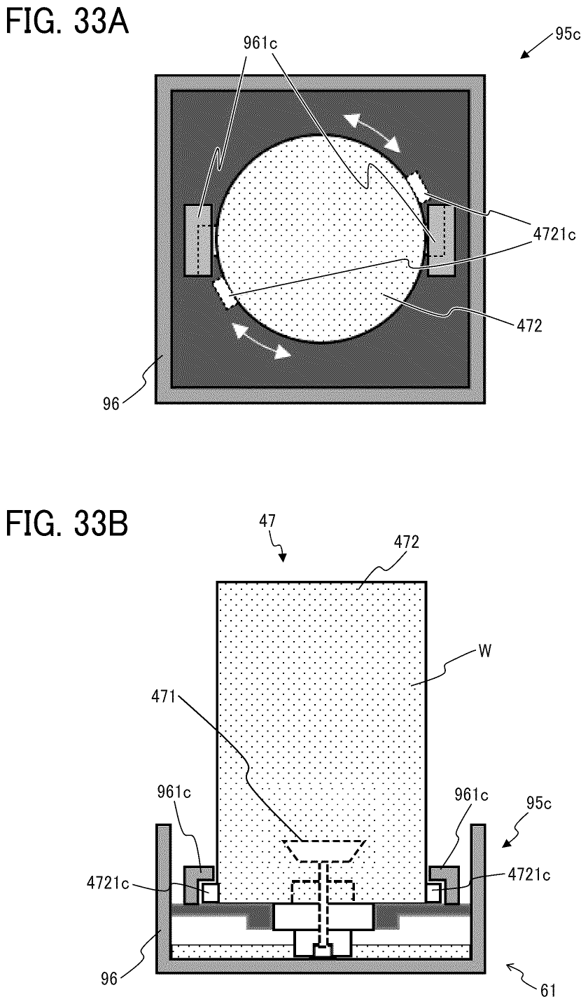

FIGS. 33A and 33B are diagrams illustrating an operating state of a locking mechanism 95c according to a third modification. FIG. 33A is a top view of the locking mechanism 95c, and FIG. 33B is a side view of the locking mechanism 95c. The locking mechanism 95c is a so-called rotation lock type, and fixes the tank portion 472 to the liquid storage tray 96 by engagement between a bottle protrusion 4721c (an engaging protrusion) disposed on a part of the outer peripheral surface of the tank portion 472 and a lock-shaped portion 961c (an engaged protrusion) disposed on the liquid storage tray 96.

As illustrated in FIG. 33A, the bottle protrusion 4721c constituting part of the locking mechanism 95c is disposed at a plurality of positions (at least two positions) on the outer peripheral surface of the tank portion 472. The lock-shaped portion 961c is disposed on an outer area of the top surface of the liquid storage tray 96 so that the bottle protrusion 4721c is inserted from the rotation direction of the tank portion 472. In a state where the cap 473 is mounted on the tank portion 472, the tank portion 472 is inserted to a position where the tank portion 472 is fixed to the second-liquid-storage-tank fixer 61. When the tank portion 472 is rotated in the circumferential direction (clockwise direction in FIG. 33A), the bottle protrusions 4721c are inserted into the lock-shaped portions 961c.

Thus, the tank portion 472 is prevented from moving in the attachment/detachment direction. When the tank portion 472 is detached, the tank portion 472 is rotated counterclockwise in FIG. 33A. Thus, the engagement between the bottle protrusions 4721c and the lock-shaped portions 961c is released to release the locked state.

A description is given below of a first modification of the second-liquid-storage-tank fixer 61.

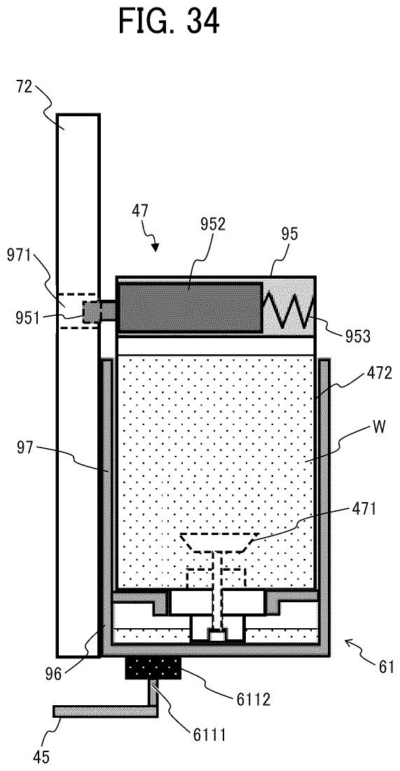

As illustrated in FIG. 34, the second-liquid-storage-tank fixer 61 is provided with a filter 6112 at the liquid supply port 6111. The liquid stored in the second-liquid-storage-tank fixer 61 is supplied to the liquid application member 501 through the liquid supply passage 45 via the liquid supply port 6111 of the second-liquid-storage-tank fixer 61. If contaminants are mixed into the liquid supply passage 45, the liquid supply passage 45 is blocked, which may cause a failure such as a failure in supplying the liquid. For this reason, the filter 6112 that prevents such contaminants from flowing out to the liquid supply passage 45 is disposed on the upstream side (inlet) of the liquid supply port 6111 of the second-liquid-storage-tank fixer 61.

A description is given below of a second modification of the second-liquid-storage-tank fixer 61.

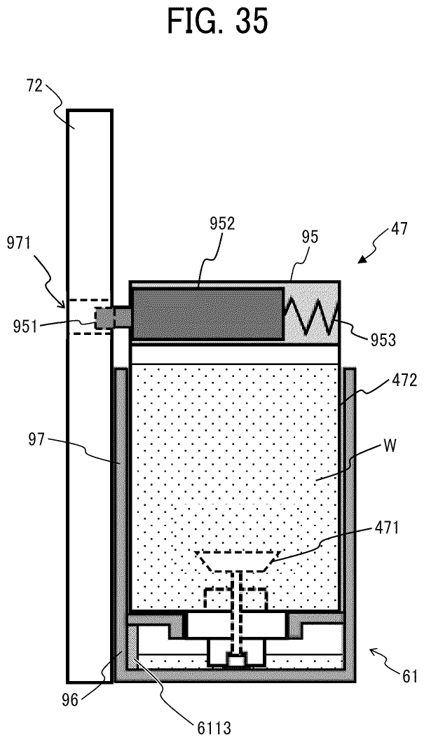

As illustrated in FIG. 35, a tray liquid-level sensor 6113 that detects the liquid level of the liquid storage tray 96 of the second-liquid-storage-tank fixer 61 is disposed to monitor the presence or absence of the liquid supplied from the second liquid storage tank 47. When it is determined that the tank portion 472 is empty and the liquid is not supplied to the second-liquid-storage-tank fixer 61, a display for prompting the replenishment of the liquid may be performed on the operation panel 110.

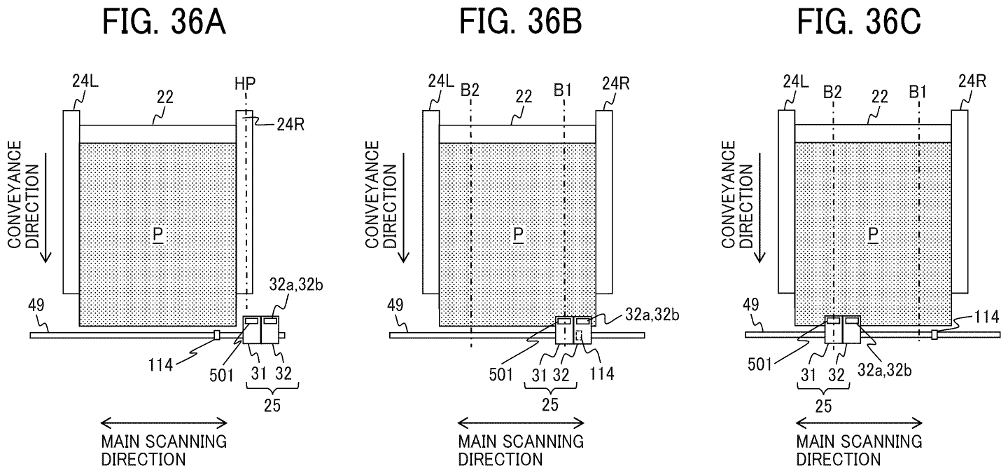

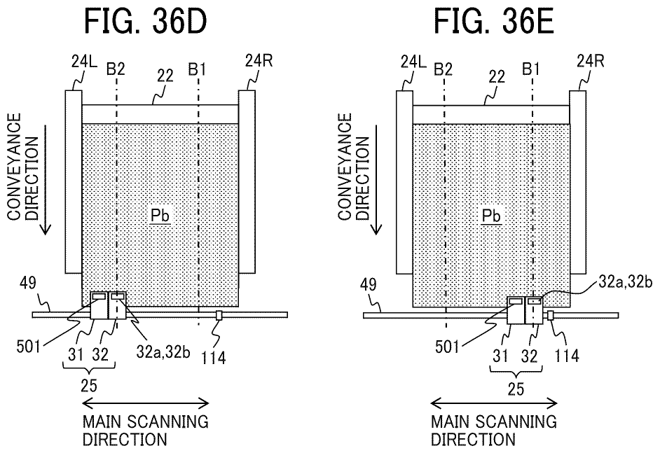

FIGS. 36A to 36E illustrate a case in which parallel binding is performed on a plurality of positions of a sheet bundle Pb in the width direction of the sheet bundle Pb in a “parallel binding posture” (first binding posture) in which a longitudinal direction (i.e., the long side) of a front edge of each of the upper crimping teeth 32a, the lower crimping teeth 32b, and the liquid application member 501 is aligned with the main scanning direction.

First, before a sheet P is conveyed to the internal tray 22, the edge binder 25 is moved from the standby position HP illustrated in FIG. 36A to the first liquid application position B1 illustrated in FIG. 36B such that the liquid applier 31 is located at the first liquid application position B1.

Then, when the alignment of the sheet P supported by the internal tray 22 in the main scanning direction and the conveyance direction ends, the liquid applier 31 located at the first liquid application position B1 executes the liquid application to the sheet P. When the liquid application at the first liquid application position B1 ends, the liquid applier 31 moves to the second liquid application position B2 as illustrated in FIG. 36C. When the movement ends, the liquid applier 31 executes the liquid application on the sheet P at the second liquid application position B2.

The above-described liquid application process illustrated in FIGS. 36B and 36C is repeatedly executed until the number of sheets P placed on the internal tray 22 reaches a predetermined number (the number of sheets included in the sheet bundle Pb).

When the number of sheets P placed on the internal tray 22 reaches the predetermined number and the liquid application process ends, as illustrated in FIG. 36D, the edge binder 25 is moved in the main scanning direction such that the crimper 32 is located at the second binding position B2. When the movement ends, the crimper 32 executes crimp binding on the sheet bundle Pb at the second binding position B2. When the crimp binding at the second binding position B2 ends, as illustrated in FIG. 36E, the edge binder 25 is moved in the main scanning direction such that the crimper 32 is positioned at the first binding position B1. When the movement ends, the crimper 32 executes crimp binding on the sheet bundle Pb at the first binding position B1.

When the crimp binding process at the first binding position B1 ends, the edge binder 25 is moved to the standby position HP in FIG. 36A and the binding process ends.

Although the example with one liquid applier 31 and one crimper 32 has been described in the above-described embodiment, the number of the liquid applier 31 and the crimper 32 are not limited to the above-described example. In another example, two liquid appliers 31L and 31R and two crimpers 32 L and 32R may be provided.

According to the above-described embodiment, the liquid supply control is performed in response to the state of the liquid storage in the post-processing apparatus 3, thus appropriately holding the liquid in the liquid storage. In other words, the operation of supplying liquid to the liquid storage unit is controlled in accordance with the operation status of the post-processing apparatus 3. As a result, the liquid is stably supplied to the liquid applier, thus allowing enhancement of binding qualities. In addition, since the time required for the crimp binding operation can be shortened, the wait time of the user can be optimized, thus allowing enhancement of the convenience for the user.

A description is given below of a post-processing apparatus 3A according to a second embodiment.

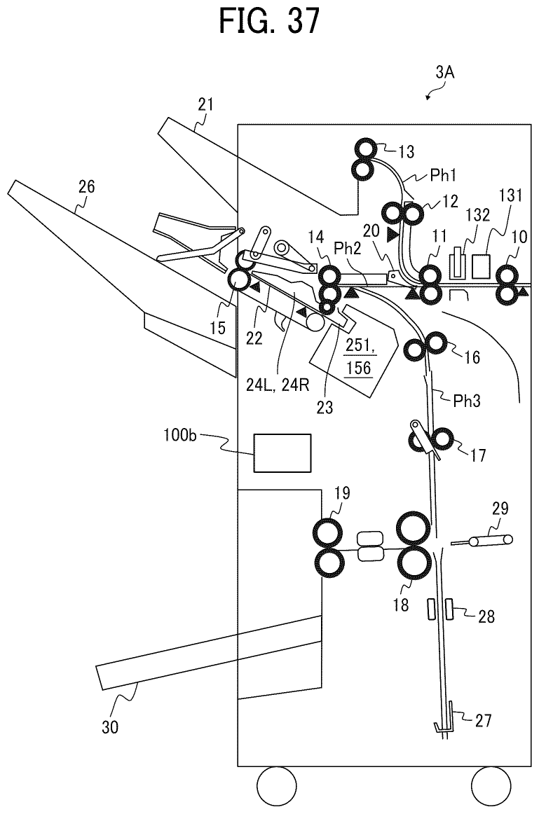

The post-processing apparatus 4 according to the second embodiment is described with reference to FIGS. 37 to 45. Components common to those of the post-processing apparatus 3 according to the first embodiment are attached with the same or like reference signs, and detailed descriptions may be omitted.

An edge binder 251 of the post-processing apparatus 3A according to the second embodiment is different from the edge binder 25 of the post-processing apparatus 3 according to the first embodiment in which the liquid applier 31 and the crimper 32 are arranged side by side, in that the edge binder 251 includes a crimper 32′ only and a liquid applier 131 is disposed on the upstream side in a conveyance passage. Such a configuration allows a given number of sheets P to be stacked in advance after the liquid application process and conveyed to the crimper 32′ of the edge binder 251 disposed at a downstream position in the direction in which the sheet P is conveyed. Accordingly, the productivity of the binding process performed by the crimper 32′ is enhanced.

Since the direction in which the conveyance roller pairs 10, 11, and 14 convey the sheet P is opposite to the “conveyance direction” defined above, the direction in which the conveyance roller pairs 10, 11, and 14 convey the sheet P is defined as an “opposite conveyance direction” in the following description. A direction that is orthogonal to both the opposite conveyance direction and the thickness direction of the sheet P is defined as the “main scanning direction” or the “width direction of the sheet P.” The liquid application position on a sheet P or a sheet bundle Pb onto which liquid application is performed by the liquid applier 131 corresponds to the binding position on the sheet bundle Pb to be crimped by the crimper 32′. For this reason, in the following description, the liquid application position and the binding position are described with the same reference sign (B1).

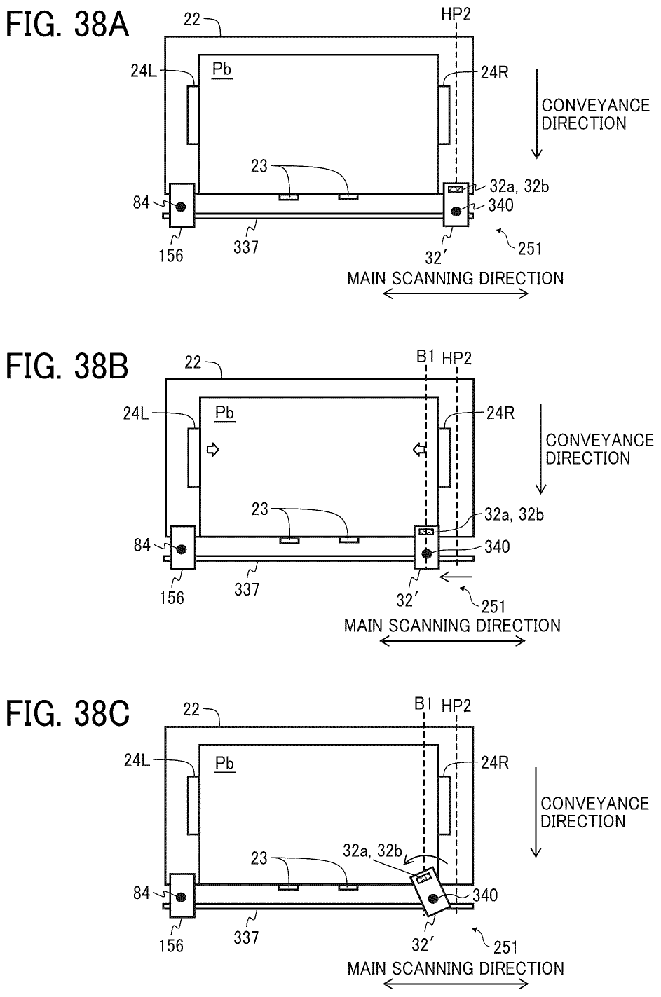

FIG. 37 is a diagram illustrating an internal configuration of the post-processing apparatus 3A according to the second embodiment. As illustrated in FIGS. 38A to 38C, the edge binder 251 includes the crimper 32′. As illustrated in FIG. 38A to 38C, the crimper 32′ and the staple binder 156 are disposed downstream from the internal tray 22 in the conveyance direction. In addition, the crimper 32′ and the staple binder 156 are located to face a downstream end, in the conveyance direction, of the sheet bundle Pb placed on the internal tray 22 and is movable in the main scanning direction.

Further, the crimper 32′ and the staple binder 156 are respectively rotatable in the forward and reverse directions about a crimper shaft 340 and a stapler shaft 84 both extending in the thickness direction of the sheet bundle Pb placed on the internal tray 22. In other words, the crimper 32′ and the staple binder 156 bind, at a desired angle, a desired position in the main scanning direction on the sheet stack Pb placed on the internal tray 22 in, for example, corner oblique binding, parallel one-point binding, or parallel two-point binding.

The crimper 32′ presses and deforms the sheet bundle Pb with the serrate upper crimping teeth 32a and the serrate lower crimping teeth 32b to bind the sheet bundle Pb. In the following description, such a binding way may be referred to as “crimp binding.” In other words, the crimper 32′ crimps and binds the sheet bundle Pb or performs the crimp binding on the sheet bundle Pb. On the other hand, the staple binder 156 passes the staple through a binding position on the sheet bundle Pb placed on the internal tray 22, thus allowing the sheet bundle Pb to be stapled.

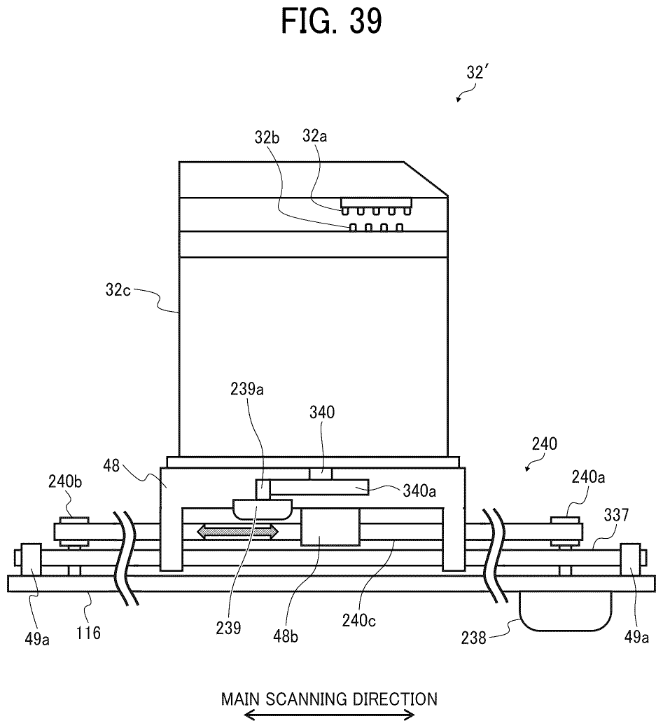

FIGS. 38A, 38B, and 38C are schematic diagrams illustrating the internal tray 22 viewed from the thickness direction of the sheet bundle Pb. FIG. 39 is a schematic diagram illustrating a downstream side of the crimper 32′ in the conveyance direction. As illustrated in FIGS. 38A, 38B, and 38C, the crimper 32′ and the staple binder 156 are disposed downstream from the internal tray 22 in the conveyance direction. The crimper 32′ is movable in the main scanning direction along the surface of the sheet bundle Pb placed on the internal tray 22. Further, the crimper 32′ is rotatable in the forward and reverse directions about a crimper shaft 340 extending in the thickness direction of the sheet bundle Pb placed on the internal tray 22.

Similarly, the staple binder 156 is movable in the main scanning direction of the sheet bundle Pb. The staple binder 156 is rotatable in the forward and reverse directions about the stapler shaft 84 extending in thickness direction of the sheet bundle Pb. Since the other components of the staple binder 156 are similar to those of the staple binder 155 (see FIG. 9) of the post-processing apparatus 3 according to the first embodiment, a detailed description thereof is omitted.

As illustrated in FIG. 39, the crimper 32′ includes a guide rail 337 extending in the main scanning direction at a position downstream from the internal tray 22 in the conveyance direction. The crimper 32′ includes a crimper movement motor 238 as a driving source. A base 48 supporting a crimping frame 32c has a fastening portion 48b for a timing belt 240c at the bottom of the base 48. The driving force of the crimper movement motor 238 is transmitted to the base 48 by the drive transmission assembly 240 that includes the pullies 240a and 240b, the timing belt 240c, and the fastening portion 48b. By so doing, the crimper 32′ is moved in the main scanning direction along the surface of the sheet bundle Pb placed on the internal tray 22, in other words, along the guide rail 337. The crimper shaft 340 including a drive transmission gear 340a is fixed to a bottom face of the crimping frame 32c that holds the components of the crimper 32′.

The crimper shaft 340 and the drive transmission gear 340a are held by a base 48 on which the crimping frame 32c is disposed, so as to be rotatable in the forward and reverse directions. The drive transmission gear 340a meshes with an output gear 239a of a crimper pivot motor 239. When the driving force of the crimper pivot motor 239 is transmitted to the crimper shaft 340 via the output gear 239a and the drive transmission gear 340a, the crimper 32′ rotates in the forward and reverse directions on the base 48 about the crimper shaft 340 extending in the thickness direction of the sheet P placed on the internal tray 22. The guide rail 337, the crimper movement motor 238, the crimper pivot motor 239, the crimper shaft 340, and the drive transmission assembly 240 constitute at least part of an example of a driving assembly of the crimper 32′.

The crimper 32′ is movable between a standby position HP2 illustrated in FIG. 38A and a position where the crimper 32′ faces the first binding position B1 illustrated in FIGS. 38B and 38C. The standby position HP2 is a position away in the main scanning direction from the sheet bundle Pb placed on the internal tray 22. The first binding position B1 is a position on the sheet bundle Pb placed on the internal tray 22. However, the specific position of the first binding position B1 is not limited to the example of FIGS. 38A, 38B, and 38C, and the first binding position B1 may be any one or more positions in the main scanning direction in a downstream end in the conveyance direction of the sheet P.

The posture of the crimper 32′ changes between the parallel binding posture illustrated in FIG. 38B and the oblique binding posture illustrated in FIG. 38C. In other words, the crimper 32′ is rotatable in the forward and reverse directions about the crimper shaft 340. The parallel binding posture is a posture of the crimper 32′ in which the length of the upper crimping teeth 32a and the lower crimping teeth 32b (in other words, a rectangular crimp binding trace) is along the main scanning direction. The oblique binding posture is a posture of the crimper 32′ in which the length of the upper crimping teeth 32a and the lower crimping teeth 32b (in other words, the rectangular crimp binding trace) is inclined with respect to the main scanning direction.

The rotational angle, which is an angle of the upper crimping teeth 32a and the lower crimping teeth 32b with respect to the main scanning direction, in the oblique binding posture is not limited to the angle illustrated in FIG. 38C. The rotational angle in the oblique binding posture may be any angle provided that the upper crimping teeth 32a and the lower crimping teeth 32b face the sheet stack Pb placed on the internal tray 22.

The post-processing apparatus 3A includes the liquid applier 131 and a hole punch 132, which is an example of a processor. The liquid applier 131 and the hole punch 132 are disposed upstream from the internal tray 22 in the opposite conveyance direction. In addition, the liquid applier 131 and the hole punch 132 are disposed at different positions in the opposite conveyance direction to simultaneously face one sheet P that is conveyed by the conveyance roller pairs 10 to 19.

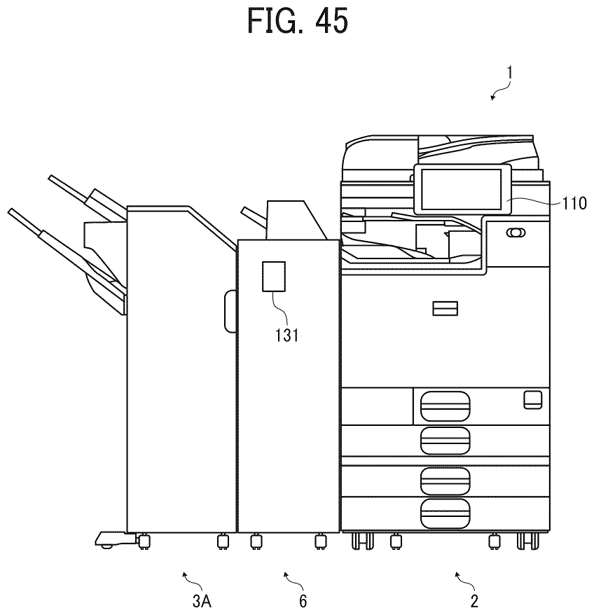

The liquid applier 131 and the hole punch 132 according to the present embodiment are disposed between the conveyance roller pairs 10 and 11. However, the arrangement of the liquid applier 131 is not limited to the example of FIG. 37. For example, in a case where an inserter 6 is disposed between the image forming apparatus 2 and the post-processing apparatus 3A as illustrated in FIG. 45, the liquid applier 131 may be disposed inside the inserter 6 located upstream from the post-processing apparatus 3A in a direction in which the sheet P is conveyed from the image forming apparatus 2 to the post-processing apparatus 3A. Examples of the inserter 6 include, but are not limited to, an apparatus that allows a pre-printed medium, which is to be conveyed to the post-processing apparatus 3A together with the sheet P conveyed from the image forming apparatus 2, to be fed as a cover sheet, an insertion sheet, or a partition sheet without passing through the image forming apparatus 2.

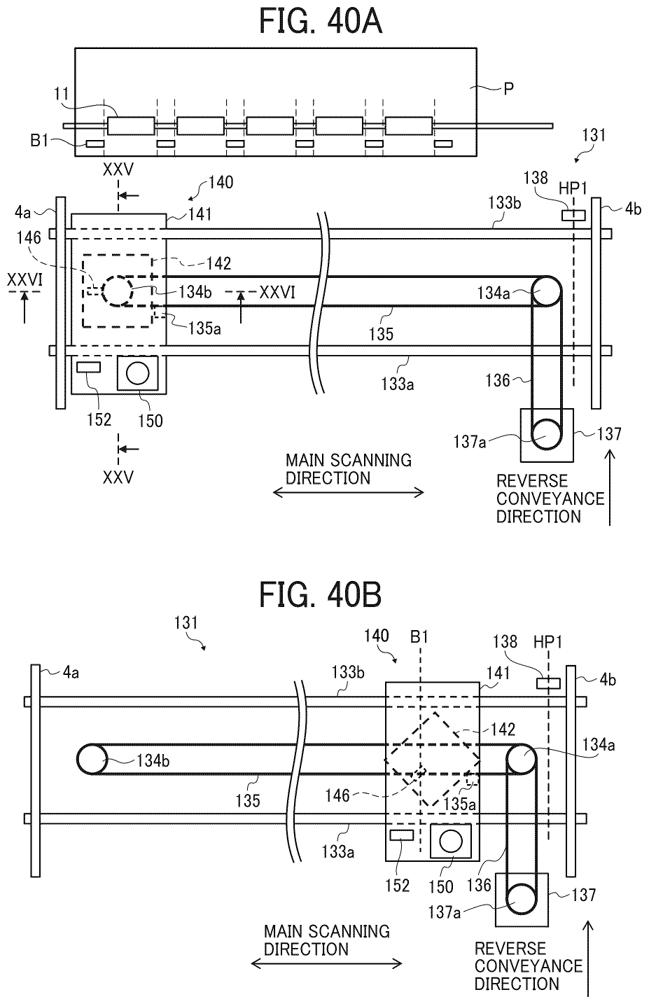

As illustrated in FIG. 40A, the conveyance roller pair 11 is located so as not to overlap, in the main scanning direction, the first liquid application position B1 on the sheet P to which the liquid is applied by a liquid application head 146 of the liquid applier 131. This arrangement is to prevent the amount of liquid at the first liquid application position B1 from decreasing due to multiple roller pairs pressing the first liquid application position B1 when the conveyance roller pair 11 conveys the sheet P. As a result, when the sheet P reaches the crimper 32′ disposed downstream from the liquid applier 131 in the opposite conveyance direction, the amount of liquid at the first liquid application position B1 is sufficient to maintain the binding strength. Accordingly, the binding strength of the sheet bundle Pb is prevented from decreasing due to a decrease in the amount of liquid at the first liquid application position B1 (corresponding to the first binding position B1) while the sheet P is conveyed.

In addition, a plurality of paired rollers constituting the conveyance roller pair 11 are located at positions at which the multiple roller pairs do not overlap with the first liquid application position B1 on the sheet P in the main scanning direction, which can thus prevent the conveying performance of the sheet P from being worse due to the adhesion of liquid to the roller pairs and further prevent a conveyance jam caused by the worsened conveying performance of the sheet P.

Although only the conveyance roller pair 11 has been described above, similarly, the roller pairs constituting the conveyance roller pairs 14 and 15 are also preferably located at positions at which the roller pairs do not overlap with the first liquid application position B1 on the sheet P in the main scanning direction.

The liquid applier 131 applies liquid to the sheet P that is conveyed by the conveyance roller pairs 10 and 11. In the following description, the application of liquid may be referred to as “liquid application.” The hole punch 132 punches a hole in the sheet P that is conveyed by the conveyance roller pairs 10 and 11 such that the hole penetrates the sheet P in the thickness direction of the sheet P. The processor disposed near the liquid applier 131 is not limited to the hole punch 132. Alternatively, the processor may be an inclination corrector that corrects an inclination or skew of the sheet P that is conveyed by the conveyance roller pairs 10 and 11.

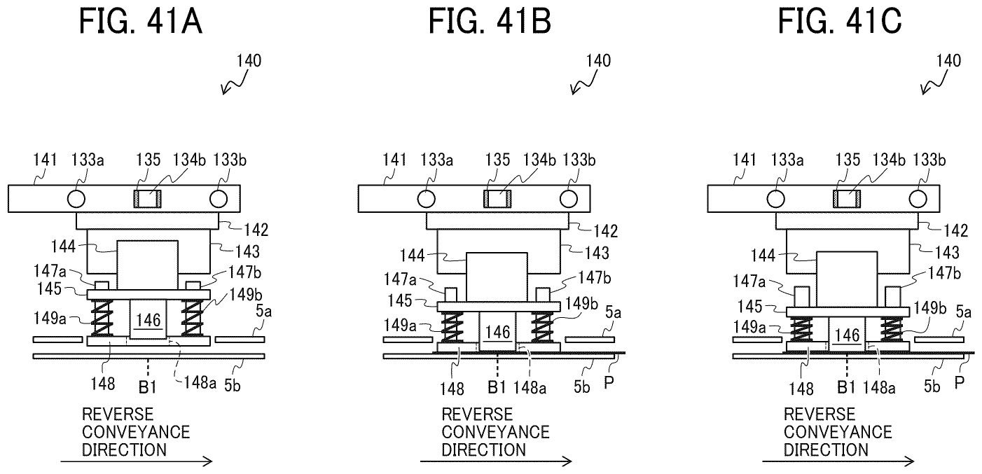

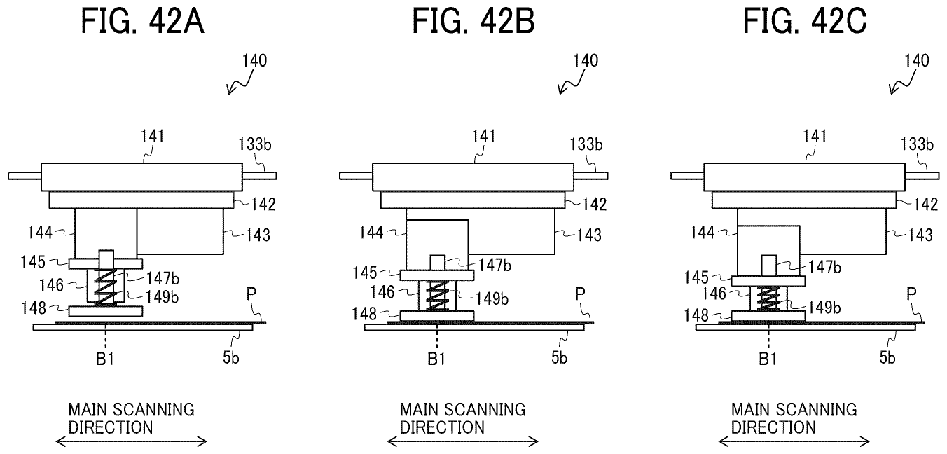

FIGS. 40A and 40B are views of the liquid applier 131 in the thickness direction of the sheet P, according to the second embodiment. FIGS. 41A, 41B, and 41C are cross-sectional views of a liquid application unit 140 of the liquid applier 131 taken through XXV-XXV of FIG. 40A. FIGS. 42A, 42B, and 42C are cross-sectional views of the liquid application unit 140 of the liquid applier 131 taken through XXVI-XXVI of FIG. 40A. As illustrated in FIGS. 40A to 42C, the liquid applier 131 includes a pair of guide shafts 133a and 133b, a pair of pulleys 134a and 134b, endless annular belts 135 and 136, a liquid-applier movement motor 137, a standby position sensor 138, and the liquid application unit 140.

The pair of guide shafts 133a and 133b each extend in the main scanning direction at positions spaced apart from each other in the opposite conveyance direction. The pair of guide shafts 133a and 133b are supported by a pair of side plates 4a and 4b of the post-processing apparatus 3A. The pair of guide shafts 133a and 133b support the liquid application unit 140 such that the liquid application unit 140 can move in the main scanning direction.

The pair of pulleys 134a and 134b is disposed between the guide shafts 133a and 133b in the opposite conveyance direction. On the other hand, the pulleys 134a and 134b are apart from each other in the main scanning direction. The pulleys 134a and 134b are supported by a frame of the post-processing apparatus 3A so as to be rotatable in the forward and reverse directions about the respective shafts extending in the thickness direction of the sheet P.

The endless annular belt 135 is looped around the pair of pulleys 134a and 134b. The endless annular belt 135 is coupled to the liquid application unit 140 by a connection 135a. The endless annular belt 136 is entrained around the pulley 134a and a driving pulley 137a that is fixed to an output shaft of the liquid-applier movement motor 137. The liquid-applier movement motor 137 generates a driving force to move the liquid application unit 140 in the main scanning direction.

As the liquid-applier movement motor 137 rotates, the endless annular belt 136 circulates around the pulley 134a and the driving pulley 137a to rotate the pulley 134a. As the pulley 134a rotates, the endless annular belt 135 circulates between the pair of pulleys 134a and 134b. Accordingly, the liquid application unit 140 moves in one direction along the main scanning direction along the pair of guide shafts 133a and 133b. Further, when the rotation direction of the liquid-applier movement motor 137 is rotated, the liquid application unit 140 moves in a direction opposite to the one direction along the main scanning direction.

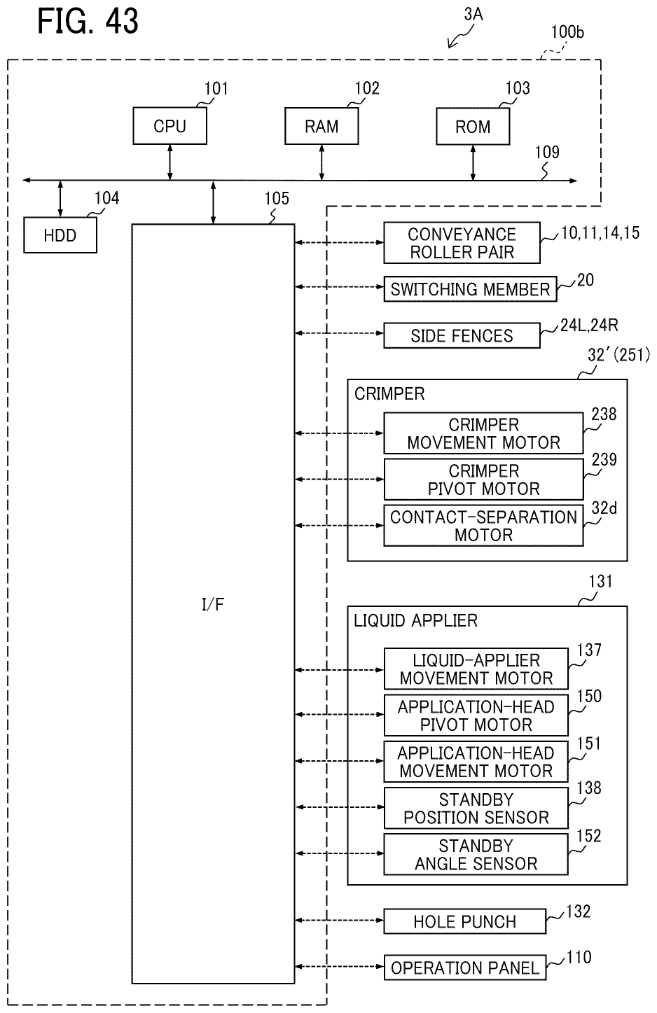

The standby position sensor 138 detects that the liquid application unit 140 has reached a standby position HP1 (see FIG. 40B) in the main scanning direction. The standby position sensor 138 then outputs a standby position signal indicating the detection result to the controller 100b, which will be described below with reference to FIG. 43. The standby position sensor 138 is, for example, an optical sensor including a light emitter and a light receiver. The liquid application unit 140 at the standby position blocks an optical path between the light emitter and the light receiver. The standby position sensor 138 outputs the standby position signal in response to the light output from the light emitter not being received by the light receiver. The specific configuration of the standby position sensor 138 is not limited to the configuration described above.

As illustrated in FIGS. 41A, 41B, and 41C, the conveyance passage inside the post-processing apparatus 3A is defined by an upper guide plate 5a and a lower guide plate 5b, which are apart from each other in the thickness direction of the sheet P. The liquid application unit 140 is located to face an opening of the upper guide plate 5a. In other words, the liquid application unit 140 is disposed to face the conveyance passage (a position at which the liquid application unit 140 can face the sheet P) through the opening of the upper guide plate 5a.

As illustrated in FIGS. 40A to 42C, the liquid application unit 140 includes a base 141, a rotary bracket 142, a liquid storage tank 143, a liquid-application-head mover 144, a holder 145, the liquid application head 146, columns 147a and 147b, a pressure plate 148, coil springs 149a and 149b, the application-head pivot motor 150, the application-head movement motor 151 (see FIG. 43), and a standby angle sensor 152 (see FIG. 43).

The base 141 is supported by the pair of guide shafts 133a and 133b so as to be slidable in the main scanning direction. The base 141 is coupled to the endless annular belt 135 by the connection 135a. The base 141 supports the components 142 to 152 of the liquid application unit 140.

The rotary bracket 142 is attached to the lower face of the base 141 so as to be rotatable in the forward and reverse directions about an axis extending in the thickness direction of the sheet P. The rotary bracket 142 is rotated with respect to the base 141 by a driving force transmitted from the application-head pivot motor 150. The rotary bracket 142 retains the liquid storage tank 143, the liquid-application-head mover 144, the holder 145, the liquid application head 146, the columns 147a and 147b, the pressure plate 148, and the coil springs 149a and 149b.

The standby angle sensor 152, which is also illustrated in FIG. 43, detects that the rotary bracket 142 has reached a standby angle. The standby angle sensor 152 then outputs a standby angle signal indicating the detection result to the controller 100b. The standby angle is, for example, an angle at the time of performing parallel binding. The standby angle sensor 152 is, for example, an optical sensor including a light emitter and a light receiver. The rotary bracket 142 at the standby angle blocks an optical path between the light emitter and the light receiver. The standby angle sensor 152 outputs the standby angle signal in response to the light output from the light emitter not being received by the light receiver. The specific configuration of the standby angle sensor 152 is not limited to the configuration described above.

FIG. 40A illustrates the rotary bracket 142 in a position for the parallel binding that is performed by the crimper 32′ disposed downstream from the liquid applier 131 in a direction in which the sheet P is conveyed. FIG. 40B illustrates the rotary bracket 142 in a position for the oblique binding (i.e., corner binding) that is performed by the crimper 32′ disposed downstream from the liquid applier 131 in the direction in which the sheet P is conveyed.

The liquid storage tank 143 stores liquid to be applied to the sheet P. The liquid-application-head mover 144 is attached to the liquid storage tank 143 so as to be movable (e.g., up and down) in the thickness direction of the sheet P. The liquid-application-head mover 144 moves in the thickness direction of the sheet P with respect to the liquid storage tank 143 by a driving force transmitted from the application-head movement motor 151. The holder 145 is attached to a lower end of the liquid-application-head mover 144. The liquid application head 146 projects from the holder 145 toward the conveyance passage (downward in the present embodiment). The liquid that is stored in the liquid storage tank 143 is supplied to the liquid application head 146. The liquid application head 146 is made of a material having a high liquid absorption (e.g., sponge or fiber).

The columns 147a and 147b project downward from the holder 145 around the liquid application head 146. The columns 147a and 147b are movable with respect to the holder 145 relatively in the thickness direction. The columns 147a and 147b hold the pressure plate 148 at lower ends thereof. The pressure plate 148 has a through hole 148a at a position to face the liquid application head 146. The coil springs 149a and 149b are inserted to the outsides of the columns 147a and 147b between the holder 145 and the pressure plate 148. The coil springs 149a and 149b bias the columns 147a and 147b and the pressure plate 148 in a direction away from the holder 145.

As illustrated in FIG. 41A and FIG. 42A, at the stage before the sheet P is conveyed to the position where the sheet P faces the opening of the upper guide plate 5a, the pressure plate 148 is positioned at or above the opening. Subsequently, when the sheet P that is conveyed by the conveyance roller pairs 10 and 11 stops at a position where the liquid application position B1 on the sheet P faces the opening, the application-head movement motor 151 is rotated in a first direction. As a result, the liquid-application-head mover 144, the holder 145, the liquid application head 146, the columns 147a and 147b, the pressure plate 148, and the coil springs 149a and 149b move down together, and the pressure plate 148 contacts the sheet P. The first liquid application position B1 is a position (i.e., the first binding position B1) to be crimped and bound by the edge binder 251 (i.e., the crimper 32′).

As the application-head movement motor 151 keeps rotating in the first direction after the pressure plate 148 contacts the sheet P, the coil springs 149a and 149b are compressed to further move down the liquid-application-head mover 144, the holder 145, the liquid application head 146, and the columns 147a and 147b. Then, as illustrated in FIG. 41B and FIG. 42B, a lower face of the liquid application head 146 contacts the sheet P through the through hole 148a. As a result, the liquid contained in the liquid application head 146 is applied to the sheet P.

Further rotation of the application-head movement motor 151 in the first direction further strongly presses the liquid application head 146 against the sheet P as illustrated in FIGS. 41C and 42C. Accordingly, the amount of liquid applied to the sheet P increases. In short, the liquid applier 131 changes the pressing force of the liquid application head 146 against the sheet P to adjust the amount of liquid that is applied to the sheet P.

On the other hand, the rotation of the application-head movement motor 151 in the second direction opposite to the first direction moves up the liquid-application-head mover 144, the holder 145, the liquid application head 146, the columns 147a and 147b, the pressure plate 148, and the coil springs 149a and 149b together. As a result, as illustrated in FIG. 41A and FIG. 42A, the liquid application head 146 and the pressure plate 148 move away from the sheet P. In other words, the liquid applier 131 includes the liquid application head 146 that can be separated from the sheet P.

FIG. 43 is a block diagram illustrating a hardware configuration of control blocks that control the operation of the post-processing apparatus 3A according to the second embodiment. As illustrated in FIG. 43, the post-processing apparatus 3A has a configuration in which a central processing unit (CPU) 101, a random-access memory (RAM) 102, a read-only memory (ROM) 103, a hard disk drive (HDD) 104, and an interface (I/F) 105 are connected via a common bus 109.

The CPU 101 is an arithmetic device and controls the overall operation of the post-processing apparatus 3A. The RAM 102 is a volatile storage medium that allows high speed reading and writing of data, and is used as a working area when the CPU 101 processes information. The ROM 103 is a read-only non-volatile storage medium, and stores programs such as firmware. The HDD 104 is a non-volatile storage medium that allows data to be read and written and has a relatively large storage capacity. The HDD 104 stores, for example, an operating system (OS), various control programs, and application programs.

The post-processing apparatus 3 processes, by an arithmetic function of the CPU 101, e.g., a control program stored in the ROM 103 and an information processing program (or application program) loaded into the RAM 102 from a storage medium such as the HDD 104. With such processing, a software controller including various functional modules of the post-processing apparatus 3A is configured. The software controller thus configured is combined with hardware resources of the post-processing apparatus 3A mounted in the post-processing apparatus 3A to configure functional blocks that implement functions of the post-processing apparatus 3A. In other words, the CPU 101, the RAM 102, the ROM 103, the HDD 104, and the I/F 105 constitute at least part of the controller 100b (control device) that controls the operation of the post-processing apparatus 3A.

The I/F 105 is an interface that connects the conveyance roller pairs 10, 11, 14, and 15, the switching member 20, the side fences 24L and 24R, the crimper movement motor 238, the crimper pivot motor 239, a contact-separation motor 32d, a liquid-applier movement motor 137, an application-head pivot motor 150, an application-head movement motor 151, a standby position sensor 138, a standby angle sensor 152, a hole punch 132, and an operation panel 110 to the common bus 109.

The controller 100b controls, via the I/F 105, the operations of the conveyance roller pairs 10, 11, 14, and 15, the switching member 20, the side fences 24L and 24R, the crimper movement motor 238, the crimper pivot motor 239, the contact-separation motor 32d, the liquid-applier movement motor 137, the application-head pivot motor 150, the application-head movement motor 151, and the hole punch 132. The controller 100b acquires detection results from the standby position sensor 138 and the standby angle sensor 152 through the I/F 105.

Although FIG. 43 illustrates the components of the liquid applier 131 and the edge binder 251 (the crimper 32′) that executes the edge binding, the components of the saddle binder 28 that executes the saddle binding are controlled by the controller 100b like the components of the liquid applier 131 and the edge binder 251 (the crimper 32′) that executes the edge binding.

As illustrated in FIG. 45, the image forming apparatus 2 includes the operation panel 110. The operation panel 110 includes an operation section that receives instructions input by an operator and a display (which is an example of a notifier) that notifies the operator of information. The operation section includes, for example, hard keys and a touch screen overlaid on the display. The operation panel 110 acquires information from the user through the operation section and provides information to the user through the display. The post-processing apparatus 3A may include an operation panel 110 similar to the above-described operation panel 110.

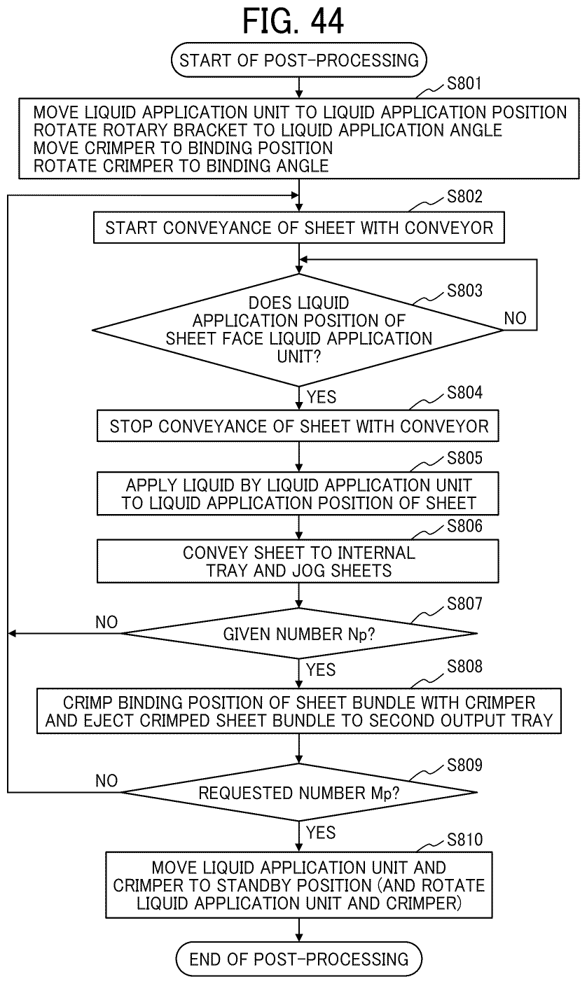

FIG. 44 is a flowchart of post-processing of the post-processing apparatus 3A according to the second embodiment. Specifically, FIG. 44 is a flowchart of a process to execute the one-point binding illustrated in FIGS. 38A, 38B, and 38C.

For example, the controller 100b executes the post-processing illustrated in FIG. 44 in response to acquisition of an instruction (denoted below as “post-processing command”) of executing the post-processing from the image forming apparatus 2. The post-processing command includes, for example, the number of sheets P of the sheet bundle Pb (denoted below as “given number of sheets Np”), the number of sheet bundles Pb to be subjected to binding process (denoted below as “requested number of sheets Mp”), the first binding position B1 (corresponding to the first liquid application position B1), the angle of the first binding position B1 (corresponding to the angle of the first liquid application position B1), the type of binding process (parallel binding process or oblique binding process), and a process that is executed in parallel with the liquid application process (punching a hole in the present embodiment). At the start of the post-processing, the liquid application unit 140 is at the standby position HP1 (see FIGS. 40A and 40B), and the rotary bracket 142 is held at the standby angle (corresponding to “parallel binding posture”).

First, the controller 100b drives the liquid-applier movement motor 137 to move the liquid application unit 140 (corresponding to a liquid application device) in the main scanning direction, thus causing the liquid application head 146 to move from the standby position HP1 to the position where the liquid application head 146 can face the first liquid application position B1 (see FIG. 40B, the position corresponding to the first binding position B1 illustrated in FIG. 38B and FIG. 38C). If the type of the binding process instructed by the post-processing command is “oblique binding process,” in step S801, the controller 100b drives the application-head pivot motor 150 to rotate the rotary bracket 142. Thus, the liquid application head 146 is rotated from the standby angle to the liquid application angle corresponding to the “oblique binding posture.” It can be ascertained, based on pulse signals output from rotary encoders of the liquid-applier movement motor 137 and the application-head pivot motor 150, that the liquid application head 146 has reached the position where the liquid application head 146 can face the first liquid application position B1. If the type of the binding process instructed by the post-processing command is “parallel binding process”, the controller 100b omits the above-described operation of rotating the rotary bracket 142. In other words, the liquid application unit 140 moves in the main scanning direction while holding the rotary bracket 142 at the standby angle.

Further, in step S801, the controller 100b drives the crimper movement motor 238 to move the crimper 32′ from the standby position HP2 to the position where the crimper 32′ can face the first binding position B1 as illustrated in FIGS. 38A and 38B. Alternatively, if the type of the binding process instructed by the post-processing command is “oblique binding process,” in step S801, the controller 100b drives the crimper pivot motor 239 to rotate the crimper 32′ from the standby angle to the crimping angle corresponding to the “oblique binding posture.” It is ascertained based on a pulse signal output from a rotary encoder of the crimper movement motor 238 that the crimper 32 has reached the position where the crimper 32 can face the first binding position B1. Similarly, it is ascertained based on a pulse signal output from a rotary encoder of the crimper pivot motor 239 that the crimper 32 has reached the crimp binding angle. If the type of the binding process instructed by the post-processing command is “parallel binding process,” the controller 100b omits the above-described operation of rotating the crimper 32′. In other words, the crimper 32′ moves in the main scanning direction while maintaining the standby angle.

In step S802, the controller 100b drives the conveyance roller pairs 10 and 11 to start conveying the sheet P on which an image is formed by the image forming apparatus 2. In step S803, the controller 100b determines whether the first liquid application position B1 on the sheet P has faced the liquid application unit 140 (more specifically, the liquid application head 146). When the controller 100b determines that the first liquid application position B1 on the sheet P has not faced the liquid application unit 140 (NO in S803), the controller 100b continues causing the conveyance roller pairs 10 and 11 to convey the sheet P until the first liquid application position B1 on the sheet P faces the liquid application unit 140 (YES in S803). When the controller 100b determines that the first liquid application position B1 on the sheet P has faced the liquid application head 146 (YES in step S803), in step S804, the controller 100b causes the conveyance roller pairs 10 and 11 to stop conveying the sheet P. It can be ascertained, based on a pulse signal output from a rotary encoder of a motor that drives the conveyance roller pairs 10 and 11, that the first liquid application position B1 on the sheet P has faced the liquid application head 146.

In step S805, the controller 100b causes the liquid application unit 140 to execute the process of applying liquid to the first liquid application position B1 on the sheet P. More specifically, the controller 100b rotates the application-head movement motor 151 in the first direction to bring the liquid application head 146 into contact with the first liquid application position B1 on the sheet P. The controller 100b changes the pressing force of the liquid application head 146 (i.e., the amount of rotation of the application-head movement motor 151) depending on the amount of liquid to be applied to the sheet P.

The amount of liquid that is applied to the sheet P may be the same for all the sheets P of the sheet bundle Pb or may be different for each sheet P. For example, the controller 100b may decrease the amount of liquid applied to a sheet P conveyed later. The amount of rotation of the application-head movement motor 151 can be ascertained based on a pulse signal output from a rotary encoder of the application-head movement motor 151.

In step S806, the controller 100b drives the conveyance roller pairs 10, 11, 14, and 15 to place a sheet P on the internal tray 22. In step S806, the controller 100b also moves the side fences 24L and 24R in the main scanning direction to align the position of the sheet P or the sheet stack Pb placed on the internal tray 22 in the main scanning direction. In short, the controller 100b performs so-called jogging.

In step S807, the controller 100b determines whether the number of sheets P placed on the internal tray 22 has reached the given number of sheets Np indicated by the post-processing command. When the controller 100b determines that the number of sheets P placed on the internal tray 22 has not reached the given number of sheets Np (NO in step S807), the controller 100b executes the operations of steps S802 to S807 again until the number of sheets P placed on the internal tray 22 reaches the given number of sheets Np (YES in step S807).

By contrast, when the controller 100b determines that the number of sheets P that are placed on the internal tray 22 has reached the given number of sheets Np (YES in step S807), in step S808, the controller 100b causes the crimper 32′ to crimp the binding position B1 (corresponding to the first liquid application position B1) on the sheet stack Pb to which the liquid has been applied by the liquid application unit 140. In step S808, the controller 100b also rotates the conveyance roller pair 15 to eject the crimped sheet stack Pb to the second ejection tray 26.

In step S809, the controller 100b determines whether the number of sheet stacks Pb thus ejected to the second ejection tray 26 has reached the requested number of copies Mp indicated by the post-processing command. When the controller 100b determines that the number of the sheet stacks Pb ejected to the second ejection tray 26 has not reached the requested number of copies Mp (NO in step S809), the controller 100b repeats the processing of steps S802 to S809 until the number of the sheet stacks Pb ejected to the second ejection tray 26 reaches the requested number of copies Mp (YES in step S809).

When the controller 100b determines that the number of sheet stacks Pb ejected to the second ejection tray 26 reaches the requested number of copies Mp (YES in step S809), in step S810, the controller 100b drives the liquid-applier movement motor 137 to move the liquid application unit 140 to the standby position HP1 (see FIGS. 40B) and drives the crimper movement motor 238 to move the crimper 32′ to the standby position HP2 (see FIG. 38A). When the posture that is instructed by the post-processing command is the “oblique binding posture,” the controller 100b drives the application-head pivot motor 150 and the crimper pivot motor 239 to rotate the liquid application unit 140 and crimper 32′ and the parallel binding posture (standby angle) into the parallel binding posture (step S810). By contrast, when the posture that is instructed by the post-processing command is the “parallel binding posture,” the controller 100b skips the aforementioned operation of rotating the liquid application unit 140 and the crimper 32′ to the parallel binding posture (standby angle). In steps S801 and S810, the execution order of the movement in the main scanning direction and the rotation in the forward and reverse directions of the liquid application unit 140 and the crimper 32′ is not limited to the aforementioned order and may be reversed.

The present disclosure can be applied to not only the edge binder 25 that executes edge binding but also to the saddle binder 28 that executes saddle stitching.

The configuration in which the controller 100b of the post-processing apparatus 3A according to the second embodiment illustrated in FIG. 37 is provided separately from the controller 100a of the image forming apparatus 2 similarly with FIG. 1 has been described, but it is not limited to such a configuration. For example, as illustrated in FIG. 46A, the controller 100b of the post-processing apparatus 3 may be disposed in the image forming apparatus 2. Further, as in the configuration of FIG. 46B, the controller 100b of the post-processing apparatus 3A may be integrated with the controller 100a of the image forming apparatus 2.

Similarly with FIG. 47A, the controller 100b of the post-processing apparatus 3A may be divided into a controller 100b1 (e.g., a driver system (such as a motor)) and a controller 100b2 (a detector system (such as a sensor)) according to the function, and the controller 100b2 of the post-processing apparatus 3A may be disposed in the image forming apparatus 2. Further, similarly with FIG. 47B, the controller 100b2 of the post-processing apparatus 3A disposed in the image forming apparatus 2 may be integrated with the controller 100a of the image forming apparatus 2.

As described above, the control method by the controller 100b described above is implemented by cooperation between hardware resources of a computer and a program as computer software. In other words, the control method may be executed by causing an arithmetic device, a storage device, an input device, an output device, and a control device to operate in cooperation with each other based on a program. The program may be written in, for example, a storage device or a storage medium and distributed with the storage device or the storage medium, or may be distributed through, for example, an electric communication line.

In the related art, generally, when liquid is replenished to a water supply tank of a water-added crimp binding apparatus, the water supply tank needs to be removed. However, a configuration related to an attachment-and-detachment mechanism that facilitates attachment and detachment of the water supply tank included in a medium processing apparatus has not been clearly proposed. In other words, there has been a disadvantage in enhancing the convenience of the user in such an attachment-and-detachment mechanism of the water supply tank disposed in the medium processing apparatus.

As described above, according to one or more embodiments of the present disclosure, in a medium processing apparatus that performs a binding process with application of liquid to a medium, the convenience of a user in an operation of attaching and detaching a liquid storage tank can be enhanced.

Embodiments of the present disclosure are not limited to the above-described embodiments, and numerous additional modifications and variations are possible in light of the teachings within the technical scope of the appended claims. It is therefore to be understood that the above-described embodiments of the present disclosure may be practiced otherwise by those skilled in the art than as specifically described herein. Such modifications are included in the technical scope described in the scope of claims.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

Aspects of the present disclosure are, for example, as follows.

### First Aspect

A medium processing apparatus includes a liquid applier to perform liquid application to a part of at least one medium, a first liquid storage to store liquid used for the liquid application of the liquid applier, a second liquid storage to store the liquid to be supplied to the first liquid storage, and a liquid supplier to perform a liquid supply operation to supply the liquid from the second liquid storage to the first liquid storage. The second liquid storage includes a liquid storage tray coupled to the liquid supplier, a liquid storage tank to store the liquid and is attachable to and detachable from the liquid storage tray, and a locking mechanism to restrict a position of the liquid storage tank attached to the liquid storage tray.

### Second Aspect

In the medium processing apparatus according to the first aspect, the locking mechanism includes an engaging portion to engage with an engaged portion of an apparatus housing, an engagement releaser to release an engagement state between the engaged portion and the engaging portion, and a biasing member to bias the engaging portion toward the engaged portion. The engagement releaser moves the engaging portion in a direction against biasing of the biasing member to release the engagement state between the engaging portion and the engaged portion.

### Third Aspect

In the medium processing apparatus according to the second aspect, the engaging portion has a shape including a horizontal surface along the direction and a shape including an inclined surface continuous with the horizontal surface, or a shape having an inclination with respect to the direction.

### Fourth Aspect

In the medium processing apparatus according to any one of the first to third aspects, the liquid storage tray includes a guide mechanism to guide an attachment or detachment direction of the liquid storage tank when the liquid storage tank is attached or detached. The guide mechanism includes a wall having a height that is substantially equal to or greater than half a height dimension of the liquid storage tank. The guide mechanism is at a position lower than the locking mechanism.

### Fifth Aspect

In the medium processing apparatus according to the fourth aspect, the wall includes a visual recognition portion that enables the liquid storage tank attached to the liquid storage tray to be visually recognized.

### Sixth Aspect

In the medium processing apparatus according to the first aspect, the locking mechanism includes an engaging portion on the liquid storage tray, an engaged portion on the liquid storage tank to be engaged with the engaging portion, and a biasing member to bias the engaging portion toward the engaged portion. When the liquid storage tank is attached to the liquid storage tray, the engaging portion is engaged with the engaged portion by the biasing member to restrict the position of the liquid storage tank.

### Seventh Aspect

In the medium processing apparatus according to the first aspect, the locking mechanism includes a convex portion of the liquid storage tank and a convex portion of the liquid storage tray. When the liquid storage tank is attached to the liquid storage tray, the convex portions contact each other, at least one of the liquid storage tank and the liquid storage tray is elastically deformed, and the convex portions pass each other to engage the convex portions with each other, so that the position of the liquid storage tank is restricted.

### Eighth Aspect

In the medium processing apparatus according to the first aspect, the locking mechanism includes at least two engaging protrusions disposed on an outer periphery of the liquid storage tank and at least two engaged protrusions disposed on the liquid storage tray. When the liquid storage tank is rotated after the liquid storage tank is inserted into the liquid storage tray, the engaging protrusions engage with the engaged protrusions to restrict the position of the liquid storage tank.

### Ninth Aspect

In the medium processing apparatus according to any one of the first to eighth aspects, the liquid storage tray has a liquid supply port connected to the liquid supplier and is provided with a filter disposed upstream from the liquid supply port to filter the liquid.

### Tenth Aspect

In the medium processing apparatus according to any one of the first to ninth aspects, the liquid storage tray includes a liquid sensor to detect the liquid stored in the liquid storage tray.

### Eleventh Aspect

An image forming system includes an image forming apparatus to form an image on a plurality of media and the medium processing apparatus according to any one of the first to tenth aspects, to crimp and bind the plurality of media, on which the images have been formed by the image forming apparatus.

1. A medium processing apparatus, comprising:
a liquid applier to apply liquid to a part of a medium to perform liquid application;
a first liquid storage to store the liquid used for the liquid application of the liquid applier;
a second liquid storage to store the liquid to be supplied to the first liquid storage; and
a liquid supplier to perform a liquid supply operation to supply the liquid from the second liquid storage to the first liquid storage,
wherein the second liquid storage includes
a liquid storage tray connected to the liquid supplier,
a liquid storage tank to store the liquid and is attachable to and detachable from the liquid storage tray, and
a locking mechanism to restrict a position of the liquid storage tank attached to the liquid storage tray.

2. The medium processing apparatus according to claim 1,
wherein the locking mechanism includes
an engaging portion to engage with an engaged portion of an apparatus housing of the medium processing apparatus,
an engagement releaser to release engagement between the engaging portion and the engaged portion, and
a biasing member to bias the engaging portion toward the engaged portion, and
wherein the engagement releaser moves the engaging portion in a direction against biasing of the biasing member to release the engagement between the engaging portion and the engaged portion.

3. The medium processing apparatus according to claim 2,
wherein the engaging portion has a shape including a horizontal surface along the direction against biasing of the biasing member and an inclined surface continuous with the horizontal surface, or has a shape having an inclination with respect to the direction against biasing of the biasing member.

4. The medium processing apparatus according to claim 1,
wherein the liquid storage tray includes a guide mechanism to guide an attachment or detachment direction of the liquid storage tank when the liquid storage tank is attached or detached, and
wherein the guide mechanism includes a wall having a height dimension that is substantially equal to or greater than half a height dimension of the liquid storage tank, and
the guide mechanism is at a position lower than the locking mechanism.

5. The medium processing apparatus according to claim 4,
wherein the wall includes a visual recognition portion that enables the liquid storage tank attached to the liquid storage tray to be visually recognized.

6. The medium processing apparatus according to claim 1,
wherein the locking mechanism includes
an engaging portion of the liquid storage tray,
an engaged portion of the liquid storage tank to be engaged with the engaging portion, and
a biasing member to bias the engaging portion toward the engaged portion, and
wherein when the liquid storage tank is attached to the liquid storage tray, the engaging portion is engaged with the engaged portion by the biasing member to restrict the position of the liquid storage tank.

7. The medium processing apparatus according to claim 1,
wherein the locking mechanism includes a convex portion of the liquid storage tank and a convex portion of the liquid storage tray, and
wherein when the liquid storage tank is attached to the liquid storage tray, the convex portion of the liquid storage tank contacts the convex portion of the liquid storage tray, at least one of the liquid storage tank and the liquid storage tray is elastically deformed, and the convex portion of the liquid storage tank and the convex portion of the liquid storage tray pass each other and engage with each other to restrict the position of the liquid storage tank.

8. The medium processing apparatus according to claim 1,
wherein the locking mechanism includes
at least two engaging protrusions on an outer periphery of the liquid storage tank, and
at least two engaged protrusions of the liquid storage tray, and
wherein when the liquid storage tank is rotated after insertion of the liquid storage tank into the liquid storage tray, the at least two engaging protrusions engage with the at least two engaged protrusions to restrict the position of the liquid storage tank.

9. The medium processing apparatus according to claim 1,
wherein the liquid storage tray has a liquid supply port connected to the liquid supplier and is provided with a filter to filter the liquid, and
the filter is disposed upstream from the liquid supply port in a direction in which the liquid supplier supplies the liquid from the second liquid storage to the first liquid storage.

10. The medium processing apparatus according to claim 1,
wherein the liquid storage tray includes a liquid sensor to detect the liquid stored in the liquid storage tray.

11. An image forming system, comprising:
an image forming apparatus to form an image on a plurality of media; and
the medium processing apparatus according to claim 1 to press and deform the plurality of media, on which the image is formed by the image forming apparatus, to bind the plurality of media.
